(19) United States
(12) Patent Application Publication
(10) Pub. No.: US 2008/0287320 A1
(43) Pub. Date: Nov. 20, 2008

(54) Libraries and their design and assembly

(75) Inventors: Brian M. Baynes, Cambridge, MA (US); Dasa Lipovsek, Cambridge, MA (US); Subhayu Basu, Framingham, MA (US)

Correspondence Address: WOLF GREENFIELD & SACKS, P.C., 600 ATLANTIC AVENUE, BOSTON, MA, 02210-2206, US

(73) Assignee: Codon Devices, Cambridge, MA (US)

(21) Appl. No.: 11/973,316

(22) Filed: Oct. 4, 2007

Related U.S. Application Data
(60) Provisional application No. 60/849,558, filed on Oct. 4, 2006.
(60) Provisional application No. 60/876,641, filed on Dec. 21, 2006.
(60) Provisional application No. 60/878,331, filed on Dec. 31, 2006.

(51) Int. Cl. C40B 40/08; C40B 50/00

(52) U.S. Cl. 506/17; 506/23

(57) ABSTRACT

Aspects of the invention relate to the design and synthesis of nucleic acid libraries containing non-random mutations or variants. Aspects of the invention provide methods for assembling libraries containing high densities of predetermined variant sequences. Certain embodiments relate to the design and synthesis of nucleic acid libraries that express a predetermined polypeptide from a library of nucleic acids having silent sequence variants. Certain embodiments relate to the design and synthesis of nucleic acid libraries that express predetermined RNA variants that encode the same polypeptide sequence.

### RELATED APPLICATIONS

This application claims the benefit under 35 U.S.C. § 119(e) of U.S. provisional patent applications, Ser. No. 60/849,558, filed Oct. 4, 2006, Ser. No. 60/876,641, filed Dec. 21, 2006 and Ser. No. 60/878,331, filed Dec. 31, 2006, the contents of which are incorporated herein by reference in their entirety.

### FIELD OF THE INVENTION

Aspects of the application relate to nucleic acid compositions and assembly methods. In particular, the invention relates to the design and assembly of nucleic acid libraries.

### BACKGROUND

Nucleic acid libraries containing large numbers of random nucleic acid variants have been used to study the functional properties of a variety of translated or non-translated nucleic acid sequences. Smaller nucleic acid libraries that express proteins with variant amino acid sequences have been used to analyze the structure-function relationships of certain amino acids at specific positions in target proteins. Variant libraries also have been used to select or screen for certain nucleic acids or polypeptides that have one or more desired properties. For example, variant expression libraries have been screened to identify candidate polypeptides that have one or more therapeutic properties of interest.

### SUMMARY OF THE INVENTION

Aspects of the invention provide methods for designing and/or assembling nucleic acid libraries that represent large numbers of non-random specified sequences of interest (e.g., libraries of silent mutations). In some embodiments, high-density nucleic acid libraries are provided that exclude non-specified sequences and include only or at least a high-density of non-random specified sequences (e.g., sequence variants) of interest. In contrast, libraries assembled from degenerate nucleic acids may include large numbers of random sequences in addition to sequences of interest.

Assembly strategies of the invention can be used to generate very large libraries representative of many different nucleic acid sequences of interest (e.g., libraries of silent mutations). In contrast, current methods for assembling small numbers of variant nucleic acids cannot be scaled up in a cost-effective manner to generate large numbers of specified variants.

Aspects of the invention involve combining and assembling two or more (e.g., 2, 3, 4, 5, 6, 7, 8, 9, 10, or more) pools of nucleic acid variants, wherein each pool corresponds to a different variable region of a target library. Each pool contains nucleic acids having variant sequences that were selected for the corresponding variable region. By combining the pools, the number of different variants amongst the assembled nucleic acids is the product of the number of variants in each pool, provided that variants from the first pool are independently assembled with variants from the second pool. By choosing appropriate numbers of variable regions, each represented by a different pool of specified variant nucleic acids, libraries containing large numbers of predetermined sequences may be assembled.

Accordingly, aspects of the invention are particularly useful to produce libraries that contain large numbers of specified sequence variants (e.g., libraries of silent mutations). Libraries of the invention can be used to selectively screen or analyze large numbers of different predetermined nucleic acids and/or different peptides encoded by the nucleic acids.

Aspects of the invention relate to the design and assembly of libraries that contain variant nucleic acids having specific predetermined sequences. Aspects of the invention are useful to prepare libraries that contain subsets of all possible sequences at particular positions in a nucleic acid or libraries that contain all possible silent sequence variants at one or more protein-encoding positions in a gene of interest. In some embodiments, the invention provides methods for analyzing specific sequences of interest and designing strategies for preparing libraries that are representative of these sequences. Aspects of the invention involve optimizing an assembly strategy to generate a library that only represents predetermined nucleic acid variants of interest. In some aspects, an optimized assembly strategy is one that excludes non-specified sequence variants. For example, a library of the invention may be assembled to include only certain predetermined sequence variants at positions of interest and to exclude other sequence variants that would have been present if the library were assembled to include degenerate sequences at the positions of interest. By focusing on specified variants, a library can be designed and assembled to maximize the number of sequence variants of interest that are represented. In contrast, if a library is designed to be degenerate at all positions of interest in a nucleic acid, then the number of constructs or clones required for the library to be representative will be significantly higher than the actual number of variants of interest. This number quickly becomes impractical when variants at a plurality of sites are contemplated.

Accordingly, one aspect of the invention relates to the design of assembly strategies for preparing precise high-density nucleic acid libraries. Another aspect of the invention relates to assembling precise high-density nucleic acid libraries. Aspects of the invention also provide precise high-density nucleic acid libraries. A high-density nucleic acid library may include more than 100 different sequence variants (e.g., about 10² to 10³; about 10³ to 10⁴; about 10⁴ to 10⁵; about 10⁵ to 10⁶; about 10⁶ to 10⁷; about 10⁷ to 10⁸; about 10⁸ to 10⁹; about 10⁹ to 10¹⁰; about 10¹⁰ to 10¹¹; about 10¹¹ to 10¹²; about 10¹² to 10¹³; about 10¹³ to 10¹⁴; about 10¹⁴ to 10¹⁵; or more different sequences) wherein a high percentage of the different sequences are specified sequences as opposed to random sequences (e.g., more than about 50%, more than about 60%, more than about 70%, more than about 75%, more than about 80%, more than about 85%, more than about 90%, about 91%, about 92%, about 93%, about 94%, about 95%, about 96%, about 97%, about 98%, about 99%, or more of the sequences are predetermined sequences of interest). In some embodiments, a library may contain only non-random variants at a plurality of positions. For example, 10 or more positions may include fewer than all four possible nucleotides (e.g., 3, 2, or 1 nucleotides).

In some embodiments, an assembly strategy involves identifying variable and constant regions that will be assembled to generate a precise high-density nucleic acid library. The sequences of the variant nucleic acids that will be used to assemble the variable regions may be designed as illustrated in FIGS. 1 and 2. An assembly strategy also may include identifying or selecting constant sequences that will be used to connect variant nucleic acids. It should be appreciated that variable region boundaries may be assigned differently depending on the level of resolution that is used to analyze library sequences, as explained in more detail below for FIG. 2. In some embodiments, library sequences may be subdivided into different numbers of variable and constant regions depending on the size (e.g., number of consecutive nucleotides) that is used to define each region. For example, at one level of analysis, a stretch of 10 nucleotides (positions 1-10) for which two or more variants are present at each of positions 1-5 and 7-10 may be considered as a single variable region of 10 nucleotides. However, at a higher resolution, this region may be separated into two variable regions (positions 1-5 and 7-10) separated by a constant region (position 6 that is constant in the library). An assembly strategy may include determining how to subdivide a library sequence into variable and constant regions (e.g., how many different regions and where to delineate the boundaries between different regions).

In some embodiments, all the nucleic acid variants in a pool corresponding to a predetermined variable region are independently synthesized (e.g., as different oligonucleotides), and each variant nucleic acid in a pool spans the length of the variable region to which it corresponds. Two or more pools of independently synthesized nucleic acids then may be combined and assembled (with or without separate intervening constant nucleic acids) to generate a larger pool (e.g., a library) of longer predetermined sequence variants. The number of variants in this larger pool is expected to be the product of the number of variants in each pool that is used for assembly. This approach allows an exponential reduction in the number of construction oligonucleotides to be synthesized, as compared to more conventional approaches, in which each variant is individually synthesized. Aspects of the invention involve the use of nucleic acid modifying enzymes such as restriction enzymes (e.g., Type IIS restriction enzymes) and ligase enzymes (e.g., T4 ligase) to prepare and combine pluralities of nucleic acid pools, each pool corresponding to predetermined variants of a variable region.

It should be appreciated that the number of sequence variants in each pool, the size of the sequence variants in each pool, and the combined number of variants after assembly all may be determined by the selection of sequence boundaries for each variable region stretch that is going to be represented by a separate pool of variant nucleic acids. Accordingly, assembly strategies may be optimized to obtain a high density library that is representative of a large number of different sequence variants by mixing and assembling relatively small numbers of different nucleic acid variants. In some embodiments, the variant nucleic acid pools may be assembled in a hierarchical series of assembly reactions with each assembly reaction involving a few (e.g., 2, 3, 4, or 5) variant pools corresponding to adjacent variable regions. However, in some embodiments, more variant pools (e.g., 5-10, or more) may be mixed and assembled in a single reaction. In some embodiments, an entire variant library may be assembled in a single reaction.

In some embodiments, an assembly strategy may involve one or more intermediate sequencing steps to determine and/or confirm the representativeness of the final library. This strategy can be used to determine/confirm that i) the different variant sequences of interest are represented and/or ii) non-specified variant sequences are rare (e.g., not represented or only present at a low frequency, for example, less than about 30%, less than about 25%, less than about 20%, less than about 15%, less than about 10%, less than about 5%, less than about 1%, etc.) in the final library.

In some embodiments, an assembly strategy may involve one or more error-removal steps to exclude variant nucleic acids that were not specified (e.g., one or more error-containing synthetic oligonucleotides). In some embodiments, the same pool of constant region nucleic acids may be reused and combined with one or more different pools of variant nucleic acids to assemble a plurality of library variants. In some embodiments, one or more nucleic acids representing constant regions may be assembled and/or isolated as perfect fragments (e.g., isolated with the correct predetermined sequence having no errors, for example, by sequencing one or more candidates to identify a construct having a correct sequence). These perfect fragments may be used in one or more assembly reactions in combination with pools of variant nucleic acids. The pools of variant nucleic acids may be perfect (e.g., they contain only specified variants), but in some embodiments they may contain a fraction of non-specified variant nucleic acids (e.g., less than about 30%, less than about 25%, less than about 20%, less than about 15%, less than about 10%, less than about 5%, less than about 1%, etc.). However, the overall percentage of unspecified variants in the final library may be kept low by using the perfect constant region sequences.

In some embodiments, libraries (e.g., libraries of silent mutations) can be used to evaluate, screen, or select different polypeptides of interest. In some embodiments, the invention relates to expression libraries that can be used to screen or select for polypeptides having one or more functional and/or structural properties (e.g., one or more predetermined catalytic, enzymatic, receptor-binding, therapeutic, or other properties). Aspects of the invention provide expression libraries (e.g., nucleic-acid/polypeptide libraries) that are enriched for candidate polypeptides lacking one or more unwanted characteristics. For example, a library that expresses many different polypeptide variants may be designed to exclude polypeptides that have poor in vivo solubility, high immunogenicity, low stability, etc., or any combination thereof. Accordingly, aspects of the invention provide methods of generating filtered expression libraries that are enriched for candidate molecules having physiologically compatible or desirable characteristics. In some embodiments, a filtered expression library may be screened and/or exposed to selection conditions to identify one or more polypeptides having a function or structure of interest.

Aspects of the invention relate to therapeutic compositions. In some aspects, a therapeutic nucleic acid may include one or more silent mutations. In some embodiments, a therapeutic polypeptide may be expressed from a nucleic acid construct that includes one or more silent mutations.

Aspects of the invention relate to diagnostic methods, compositions, and applications related to detecting one or more silent mutations in a biological sample. A silent mutation in a coding sequence is a nucleotide sequence change in a codon that does not alter the identity of the encoded amino acid due to the degeneracy of the genetic code. For example, an amino acid may be encoded by one to six different codons (depending on the amino acid). A silent mutation is a sequence change that changes a codon from a first codon (e.g., a wild type codon, a naturally occurring polymorphism, a scaffold codon, a consensus codon, or any other starting codon) that encodes an amino acid to a second different codon that encodes the same amino acid. In some embodiments, a silent mutation may be a single nucleotide change. In some embodiments, a silent mutation may involve two or three nucleotide changes within the codon.

One or more silent mutations may be screened for in a protein-coding portion of a gene associated with a disease (e.g., cancer, a degenerative disease, a neurodegenerative disease, an inherited disease, or other disease), a predisposition to a disease (e.g., cancer, a degenerative disease, a neurodegenerative disease, an inherited disease, an infectious disease, or other disease), a responsiveness to a drug or a class of drugs, a susceptibility to an adverse drug reaction, a locus associated with a beneficial trait (e.g., in a crop or other agricultural or industrial organism).

Aspects of the invention relate to identifying one or more silent mutations that can be used for subsequent diagnostic screening and/or therapeutic applications. Silent mutations associated with a trait of interest may be identified by analyzing known silent mutations in genes associated with the trait and determining whether one or more of the silent mutations is associated with (e.g., causative of) the trait. An analysis may involve population genetics and statistical analysis. An analysis may involve preparing one or more nucleic acids having one or more of the silent mutations and determining if the encoded polypeptide(s) have different functional and/or structural properties and determining whether any differences in properties may be associated with the trait of interest (e.g., the disease, condition, etc.). A library of silent mutations from a population of individuals (e.g., identified in a population of individuals having one or more phenotypes of interest, for example, patients having a disease or a predisposition to a disease) may be assembled and the encoded polypeptides may be analyzed (e.g., screened or selected) for one or more functional and/or structural properties of interest. Libraries may be assembled from and/or screened against pooled samples.

In some embodiments, a library of silent mutations in one or more genes that encode proteins associated with drug processing (e.g., drug pumps, such as MDR1, MRP, LRP, drug metabolizing enzymes and other drug processing enzymes) may be assembled. Such a library may be screened and/or selected to identify silent mutations that increase or decrease drug processing (e.g., pumping) and that may be associated increased or decreased responsiveness to one or more therapeutic compounds (e.g., drug resistance or drug ineffectiveness, etc.). Similarly, libraries of silent mutations in genes encoding proteins associated with adverse responses to drugs and/or toxicity may be assembled and screened or selected to identify variants that may be associated with increased or decreased adverse response and/or toxicity. Similarly, silent mutations associated with other traits of interest may be identified by assembling libraries of silent mutations in genes known to be associated with the trait. As discussed herein, the silent mutation libraries may include one or more silent mutations in each gene (e.g., 1, 2, 3, 4, 5, 6, 7, 8, 9, 10, or more silent mutations may be present in each gene or about 1%, about 10%, about 25%, about 50%, about 75%, about 80%, about 90%, about 95%, or about all of the possible silent mutations may be represented in a library for a predetermined protein-encoding gene).

Once identified, silent mutations associated with any condition of interest (e.g., disease, drug responsiveness, etc.) may be used for diagnostic and/or therapeutic purposes. In diagnostic applications, a patient or population of patients may be screened for the presence of one or more silent mutations associated with a trait of interest. Any suitable biological sample may be screened or assayed for the presence of one or more silent mutations. A sample may be analyzed for a silent mutation using any suitable technique. For example, sequencing, primer extension, hybridization, or any other suitable technique, or any combination thereof may be used.

Accordingly, aspects of the invention relate to primers that are designed to interrogate a nucleic acid sample for the presence of one or more silent mutations. For example, a primer may be designed for a single base extension reaction to detect a silent mutation. Such a primer may hybridize to a nucleic acid immediately adjacent to a position at which a silent mutation may be present such that a single base extension product can determine whether a silent mutation is present. A biological sample may be a patient sample (e.g., a human or other patient such as a pet, an agricultural animal, a vertebrate, a mammal, etc.). A biological sample may be a tissue sample (e.g., a tissue biopsy), a fluid sample (e.g., blood, plasma, saliva, urine, etc.), or other biological sample (e.g., stool, etc.). The nucleic acid in a sample may be enriched, amplified, or selected (e.g., by binding to an immobilization probe, for example, on a column, in a microfluidic channel, on a bead, or any other suitable solid support), etc., or any combination thereof. The presence of one or more silent mutations in a patient may be indicative of a risk of a disease or condition as described herein.

A human patient treatment recommendation may be based on a silent mutation in a patient sample. In therapeutic applications, a nucleic acid encoding a therapeutic protein and having one or more silent mutations of interest may be introduced into a patient or cell (and for example, the cell may be introduced into a patient. Alternatively, or in addition, a polypeptide product expressed from a gene having a silent mutation of interest may be isolated and administered to a patient (e.g., orally, intravenously, intraperitoneally, or otherwise injected).

Accordingly, aspects of the invention relate to genes having one or more silent mutations. Aspects of the invention relate to polypeptides (e.g., isolated polypeptides) expressed from genes having one or more silent mutations. Aspects of the invention relate to diagnostic tools (e.g., primers, kits, enzymes, etc.) for detecting one or more silent mutations.

Accordingly, aspects of the invention may be used to screen or select libraries (e.g., filtered libraries, silent mutation libraries, or other predetermined libraries) for target RNAs or polypeptides of interest that also have desirable in vivo traits.

It should be appreciated that selection methods using un-filtered libraries may yield proteins with required binding or catalytic properties, they generally do not select for other desirable properties. For example, proteins selected using un-filtered libraries frequently are found to have unacceptably low stability or solubility when purified and characterized. In the case of proteins designed for therapeutic applications, such as antibodies, antibody fragments, non-antibody target-binding proteins, and modified hormones or receptors, a common problem is that proteins selected from un-filtered libraries often evoke an immune response when introduced into patients, causing either inactivation of the putative therapeutic or adverse side effects.

In some embodiments, filtering techniques of the invention can be used to identify nucleic acid sequences to be included in a polypeptide expression library. In some embodiments, filtering techniques of the invention can be used to identify nucleic acid sequences to be excluded from a polypeptide expression library. In some embodiments, methods of the invention are useful for screening nucleic acid sequences that are candidates for inclusion in an expression library and identifying those sequences that encode polypeptides with one or more undesirable properties (e.g., poor solubility, high immunogenicity, low stability, etc.). Accordingly, aspects of the invention may be used to design and assemble a library of nucleic acids that encode a plurality of polypeptides having one or more biophysical or biological properties that are known or predicted to be within a predetermined acceptable or desirable range of values.

In some embodiments, libraries can be used to evaluate, screen, and/or select different nucleic acid sequences that encode the same amino acid sequence. In some embodiments, the invention relates to expression libraries that can be used to screen or select for different expression levels of polypeptides that have the same amino acid sequence, but that are expressed from different nucleic acid sequences. In some embodiments, the invention relates to expression libraries that can be used to screen or select for one or more functional and/or structural properties (e.g., one or more predetermined catalytic, enzymatic, receptor-binding, therapeutic, or other properties) of polypeptides that have the same amino acid sequence, but that are expressed from different nucleic acid sequences. According to the invention, different nucleic acid sequences encoding the same polypeptide sequence may be translated at different rates (e.g., due to the presence of one or more rare codons). Different translation rates may result in different polypeptide expression levels and/or polypeptides that are folded into different three-dimensional configurations (and therefore may have different functional and/or structural properties).

In some embodiments, libraries can be used to evaluate, screen, and/or select different nucleic acid sequences that do not encode polypeptides. In some embodiments, the nucleic acids in a library may encode putative functional RNAs (e.g., ribozymes, RNA aptamers, RNAi molecules, antisense RNAs, etc.) and the library may be used to identify one or more expressed RNAs having function(s) of interest. In some embodiments, the nucleic acids in a library may be non-coding (e.g., neither RNA nor polypeptide encoding), and the library may be used to identify one or more nucleic acids with one or more regulatory and/or structural properties of interest (e.g., one or more promoter, enhancer, response, silencer, binding, conformational, or other property of interest, or any combination thereof).

Accordingly, aspects of the invention relate to assembling libraries that are representative of a plurality of predetermined nucleic acid and/or polypeptide sequences of interest. A library assembly reaction may include a polymerase and/or a ligase mediated reaction. In some embodiments the assembly reaction involves two or more cycles of denaturing, annealing, and extension conditions. In some embodiments, assembled library nucleic acids may be amplified, sequenced or cloned. In some embodiments, a host cell may be transformed with the assembled library nucleic acids. Library nucleic acids may be integrated into the genome of the host cell. In some embodiments, the library nucleic acids may be expressed, for example, under the control of a promoter (e.g., an inducible promoter). Individual variant clones may be isolated from a library. Nucleic acids and/or polypeptides of interest may be isolated or purified. A cell preparation transformed with a nucleic acid library, or an isolated nucleic acid of interest, may be stored, shipped, and/or propagated (e.g., grown in culture).

In another aspect, the invention provides methods of obtaining nucleic acid libraries by sending sequence information and delivery information to a remote site. The sequence information may be analyzed at the remote site. Starting nucleic acids may be designed and/or produced at the remote site. The starting nucleic acids may be assembled in a process that generates the desired sequence variation at the remote site. In some embodiments, the starting nucleic acids, an intermediate product in the assembly reaction, and/or the assembled nucleic acid library may be shipped to the delivery address that was provided.

Other aspects of the invention provide systems for designing starting nucleic acids and/or for assembling the starting nucleic acids to make a target library. Other aspects of the invention relate to methods and devices for automating a multiplex oligonucleotide assembly reaction (e.g., using a microfluidic device, a robotic liquid handling device, or a combination thereof) to generate a library of interest. Further aspects of the invention relate to business methods of marketing one or more strategies, protocols, systems, and/or automated procedures that are associated with a high-density nucleic acid library assembly. Yet further aspects of the invention relate to business methods of marketing one or more libraries.

Other features and advantages of the invention will be apparent from the following detailed description, and from the claims. The claims provided below are hereby incorporated into this section by reference.

### BRIEF DESCRIPTION OF THE FIGURES

FIG. 1 illustrates a non-limiting embodiment of a strategy for designing and assembling a precise high-density nucleic acid library;

FIG. 2 illustrates a non-limiting embodiment of a method for designing assembly nucleic acids and an assembly strategy for a precise high-density nucleic acid library;

FIG. 3 illustrates non-limiting embodiments of assembly techniques in panels A-D;

FIG. 4 illustrates a non-limiting embodiment of an assembly technique for producing a pool of predetermined nucleic acid sequence variants;

FIG. 5 illustrates non-limiting embodiments of hairpin oligonucleotide designs in panels A-D;

FIG. 6 illustrates non-limiting embodiments dumbbell oligonucleotide designs in panels A-B;

FIG. 7 illustrates non-limiting embodiments of hairpin oligonucleotide designs in panels A-D;

FIG. 8 illustrates non-limiting embodiments of assembly techniques in panel A-B;

FIG. 9 illustrates a non-limiting embodiment of a silent mutation scanning strategy; and,

FIG. 10 illustrates a non-limiting embodiment of a method for selecting protein sequences for a library.

### DETAILED DESCRIPTION OF THE INVENTION

Aspects of the invention relate to strategies and methods for constructing non-random nucleic acid libraries comprising pluralities of substantially predetermined (e.g., pre-selected) variant nucleic acid sequences. A “non-random” library means that the target species in the library are substantially predetermined or pre-selected prior to assembly, as opposed to being substantially degenerate or randomly derived. Generally, predetermined (or non-random) species are specified or selected from all possible species. Thus, unlike randomly derived variants or mutations, predetermined species represent a subset of all possible species. Nonetheless, aspects of the invention relate to methods and compositions involving a high number of predetermined sequence variants. For example, a non-random library may comprise ˜10², 10³, 10⁴, 10⁵, 10⁶, 10⁷, 10⁸, 10⁹, 10¹⁰ or more predetermined variants (e.g., different nucleic acid species). However, the high number of variants may represent only a specified subset of all possible variants at the positions being varied. In some embodiments, a library may represent a subset of all possible nucleic acid sequence variants at a plurality of nucleic acid positions being varied. In certain embodiments, a library may represent a subset of all possible amino acid coding sequences at a plurality of codons (nucleic acid triplets) being varied. As described in more detail herein, a subset of codons at a given position in a nucleic acid may represent a subset of different codons encoding a specified amino acid (e.g., in a silent mutation library) or a subset of codons encoding two or more different amino acids (e.g., between 2 and 20 different amino acids) or a combination thereof. Accordingly, since a library may contain only a subset of possible sequence variants a positions being varied (e.g., at single nucleotide positions being varied or at codon positions being varied) a library of the invention may be characterized by the presence of non-random assortments of different sequence variants between the variable positions (the positions being varied in the library). For example, a library of the invention may be identified or characterized statistically as a library of correlated mutations at positions being varied.

The variants of a variable region may have unrelated sequences. However, in many embodiments, variants are related in that they represent different single or multiple sequence variants based on a reference sequence (e.g., a natural sequence, a consensus sequence, a scaffold sequence, or other reference sequence). In addition, according to the invention, the rate of occurrence (e.g., incorporation) of variants at individual locus may be controlled. That is, the degree of representation of certain variants at a given site or region may be selectively biased by controlling the ratio of variant populations represented in an assembly mixture.

Aspects of the invention also relate to methods and compositions comprising libraries of predetermined sequence variants that are free (or relatively free) of unwanted sequence errors (e.g., less than 10%, less than 5%, less than 1%, less than 0.1%, less than 0.01%, or less than 0.001% of library members contain a sequence error). Accordingly, in some embodiments, a library of the invention may be identified or characterized statistically as a library that contains a low percentage of random sequence changes at positions that are not correlated with other predetermined sequence changes. For example, a random sequence error may occur in the context of a particular nucleic acid containing specific variations at one or more positions of interest. However, that random sequence error may not be present in the context of other sequence variants a the one or more positions of interest. In contrast, in a library that is designed to sample different combinations of predetermined sequence variants at positions of interest will include a predetermined sequence variant at a first position of interest in the context of a plurality of different combinations of sequence variants at other positions of interest. In some embodiments, a library of variant nucleic acid constructs that are expected to be the same size may contain no (or relatively few) unwanted nucleic constructs that are longer or shorter than expected (e.g., due to one or more base inserts or deletions resulting from error containing construction nucleic acids or from errors introduced during assembly). For example, a library may contain less than 10%, less than 5%, less than 1%, less than 0.1%, or less than 0.01% of constructs that are smaller or larger than a predetermined expected size.

Aspects of the invention relate to nucleic acid libraries comprising a plurality of nucleic acid sequence variants that represent silent mutations of a polypeptide-encoding sequence. A silent mutation in a coding sequence is a nucleotide sequence change in a codon that does not alter the identity of the encoded amino acid due to the degeneracy of the genetic code. In some embodiments, a library may be designed to contain a plurality of different nucleic acids each having one or more different silent mutations or combinations thereof. According to aspects of the invention, a library of silent mutations may be screened to identify nucleic acid variants that have one or more properties of interest. For example, certain nucleic acid variants containing one or more silent mutations may express an encoded polypeptide at a different level or in a different folded configuration relative to a reference nucleic acid. In some embodiments, one or more mutations in a silent mutation library may introduce “rare” codon sequences (that encode the same amino acid) that are recognized by tRNA molecules that are present at low levels in a host organism that is used to harbor and propagate the library. The presence of one or more rare codon sequences in an mRNA may alter (e.g., delay or slow) RNA translation and alter the expression and/or folding of the encoded polypeptide. In some embodiments, a delay in translation may actually increase certain polypeptide expression levels and/or alter the folding of an expressed polypeptide. Alternatively, an increased translation efficiency may alter folding and/or expression levels (e.g., decrease or increase them). Accordingly, one or more rare codons in a gene of interest may be replaced with one or more equivalent codons (that encode the same amino acid) that are efficiently translated (recognized by tRNA molecules that are present at intermediate or high levels in the host organism). It should be appreciated that a library may include constructs in which one or more rare codons are introduced, constructs in which one or more rare codons are removed, and/or constructs in which one or more rare codons are introduced and one or more other rare codons are removed. Aspects of the invention also relate to methods of preparing and using silent mutations libraries to identify functional protein variants that have the same amino acid sequence but that are encoded by different nucleic acid sequences.

Other aspects of the invention relate to nucleic acid libraries comprising a plurality of nucleic acids that encode different predetermined polypeptides having one or more biological or biophysical properties of interest (e.g., low immunogenicity, high solubility, high stability, low toxicity, etc., or any combination thereof). Polypeptide encoding sequences may be pre-screened (e.g., “in silico”) using one or more algorithms (e.g., a computer-implemented algorithm) to exclude certain sequences that are predicted to encode polypeptides with one or more undesirable biological or biophysical properties.

It should be appreciated that silent mutation libraries, pre-screened expression libraries, or combinations thereof, may be assembled using any appropriate technique. However, in some embodiments, such libraries may be designed and/or assembled to include primarily (or only) predetermined sequences of interest. Accordingly, such libraries may be designed and/or assembled using one or more methods described herein.

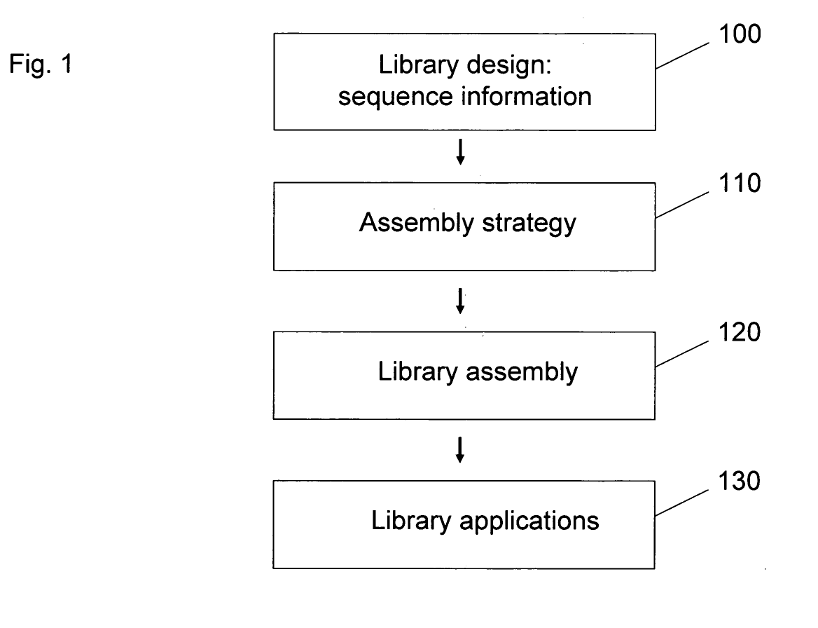

Methods for designing, generating, and using nucleic acid libraries are illustrated, for example, in FIG. 1. In act 100, a library is designed. In act 110, an assembly strategy is selected. In act 120, a library is assembled. In act 130, a library is used, for example, to screen or select for one or more nucleic acids with one or more properties of interest (e.g., predetermined expression levels, predetermined functions or activity levels of an encoded polypeptide, etc., or any combination thereof). It should be appreciated that preferred methods of assembling a nucleic acid library are methods that can be used to effectively assemble a large number of defined sequence variants at predetermined positions of interest while specifically excluding other sequence variants at those positions. FIG. 1 illustrates an embodiment of a library assembly process of the invention that may be used to design and/or assemble a library of predetermined variants. In act 100, sequence information is obtained defining the sequences that are to be included in the library. In act 110, an assembly strategy is formulated. In act 120 the library is assembled. In act 130, the library is used. In some embodiments, the library may be used to screen or select for polypeptides having one or more properties of interest. In some embodiments, the library may be sent or shipped to a customer. In some embodiments, the library may be stored and/or used to generate a polypeptide library that contains a plurality of predetermined sequence variants. It should be appreciated that one or more of these acts may be omitted in certain embodiments of the invention. It should be appreciated that one or more of these acts may be automated (e.g., computer-implemented).

Initially, in act 100, information defining the specific nucleic acid sequences to be included in the library may be obtained from any source. In some embodiments, nucleic acid sequence variants to be included in a library may contain one or more silent mutations. In some embodiments, nucleic acid sequence variants to be included in a library may be those that encode polypeptide sequences that were identified (e.g., using a filtering process of the invention). In some embodiments, a list of different polypeptide variants to be encoded by a library may be designed or obtained (e.g., in the form of a customer order or request). The different nucleic acid sequences to be assembled may be determined based on the identity of the polypeptide sequences to be included in a library. It should be appreciated that different nucleic acid sequences may encode the same polypeptide due to the degeneracy of the genetic code. In some embodiments, the sequence of a nucleic acid selected to code for a defined polypeptide variant may be determined based on any suitable parameter, including, for example, the codon bias in the host organism used for the library, the synthesis strategy, the relative ease of assembling certain sequences (e.g., sequences may be selected to avoid direct or inverted sequence repeats, sequences that stabilize one or more secondary structures, sequences with high GC or AT content, etc.), or any combination thereof. For example, when choosing codons for each amino acid, consideration may be given to one or more of the following factors: i) the codon bias in the organism in which the target nucleic acid may be expressed, ii) avoiding excessively high or low GC or AT contents in the target nucleic acid (for example, above 60% or below 40%; e.g., greater than 65%, 70%, 75%, 80%, 85%, or 90%; or less than 35%, 30%, 25%, 20%, 15%, or 10%), iii) avoiding sequence features that may interfere with the assembly procedure (e.g., the presence of repeat sequences or stem loop structures), and iv) using codons for each amino acid such that the expression levels of some or all of the proteins in the library are normalized, for example if some desired sequences are anticipated to express less than others, it may be desirable to purposely decrease the expression level of the others, so expression bias does not affect the assay result. However, these factors may be ignored in some embodiments as the invention is not limited in this respect. For example, in certain silent mutation libraries a pool of different sequence variants for one or more codons of interest may be represented regardless of other codon optimization parameters. In some embodiments, a customer order may include a specific list of defined nucleic acid sequences to be included in a library (e.g., for a library of defined DNA sequences, a library designed to express defined RNA sequences, etc.). A polypeptide or nucleic sequence order from a customer may be received in any suitable form (e.g., electronically, on a paper copy, etc.).

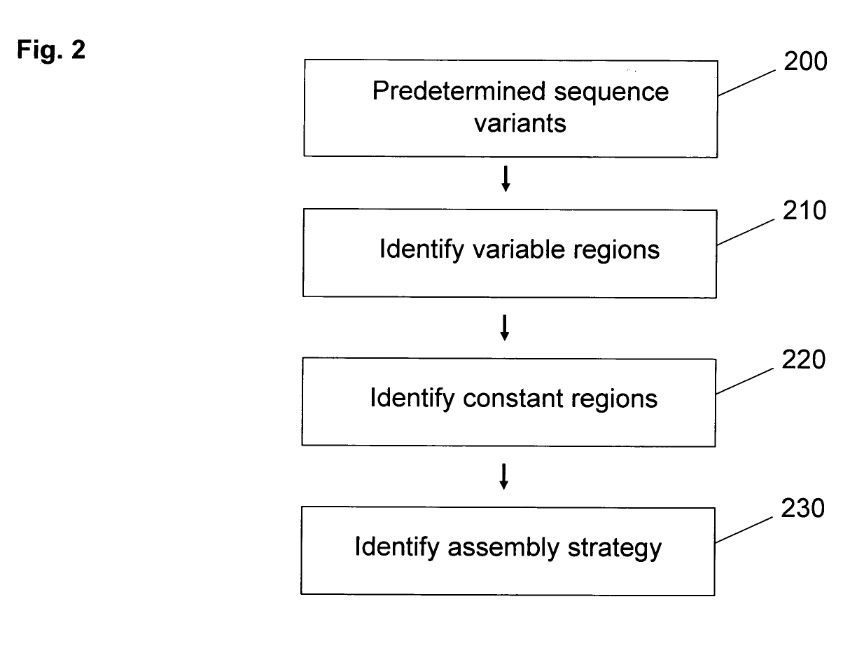

In act 110, the sequence information may be analyzed to determine an assembly strategy. This may involve determining whether the library may be assembled in a single reaction or if several intermediate fragments may be assembled separately and then combined in one or more additional rounds of assembly to generate the target nucleic acid library. Methods for designing an assembly strategy for a precise high-density nucleic acid library are described in more detail herein (e.g., with reference to FIG. 2). Once the overall assembly strategy has been determined, input nucleic acids (e.g., oligonucleotides) for assembling the one or more nucleic acid fragments may be designed. The sizes and numbers of the input nucleic acids may be based in part on the type of assembly reaction (e.g., the type of polymerase-based assembly, ligase-based assembly, chemical assembly, or combination thereof) that is being used for each fragment. The input nucleic acids also may be designed to avoid 5′ and/or 3′ regions that may cross-react incorrectly and be assembled to produce undesired nucleic acid fragments. Other structural and/or sequence factors also may be considered when designing the input nucleic acids. In certain embodiments, some of the input nucleic acids may be designed to incorporate one or more specific sequences (e.g., primer binding sequences, restriction enzyme sites, etc.) at one or both ends of the assembled nucleic acid fragment. In other embodiments these specific sequences may be at positions within the nucleic acid fragment.

In some embodiments, information developed during the design phase may be used to determine an appropriate synthesis strategy for certain variants. For example, it may be apparent from the sequence analysis and the assembly design that certain sequences may be poorly assembled and therefore under-represented in an assembled library. In some embodiments, these sequences may be assembled separately. In some embodiments, certain sequences may be identified for a user (e.g., a customer) as likely to be under-represented in a library or absent from the library.

In some embodiments, certain input nucleic acids may include one or more variant regions that encode one of several different predetermined amino acid sequences that are part of the library. In some embodiments, an input nucleic acid may be designed to restrict the variant sequences to a central region of the nucleic acid that does not overlap with adjacent 5′ and 3′ regions (e.g., a central region that is designed not to overlap with the 5′ or 3′ regions of adjacent nucleic acids that are used in a multiplex assembly reaction).

In act 120, an assembly reaction may be performed to produce a library based on the nucleic acids designed in act 110. The assembly or construction nucleic acids may be synthetic oligonucleotides that are synthesized on-site or obtained from a different site (e.g., from a commercial supplier). In some embodiments, one or more input nucleic acids may be amplification products (e.g., PCR products), restriction fragments, or other suitable nucleic acid molecules. Synthetic oligonucleotides may be synthesized using any appropriate technique as described in more detail herein. It should be appreciated that synthetic oligonucleotides often have sequence errors. Accordingly, oligonucleotide preparations may be selected or screened to remove error-containing molecules as described in more detail herein. In one embodiment oligonucleotides will be synthesized as mixtures by using random nucleotide incorporation. The oligonucleotides can later be screened for the correct sequence.

In one embodiment the sequence variability designed for a library is encoded within the size of a single assembly oligonucleotide.

If sequence variability is desired in several different regions of the polypeptide, variant regions may be required in several of the different assembled oligonucleotides. In some embodiments several parallel assembly reactions may be performed to create different subsets of the desired sequences. In some embodiments the oligonucleotides may be pre-screened prior to assembly (e.g., to remove error-containing nucleic acids).

For each fragment, the input nucleic acids may be assembled using any appropriate assembly technique (e.g., a polymerase-based assembly, a ligase-based assembly, a chemical assembly, or any other multiplex nucleic acid assembly technique, or any combination thereof). An assembly reaction may result in the assembly of a number of different nucleic acid products in addition to the predetermined nucleic acid fragment. Accordingly, in some embodiments, an assembly reaction may be processed to remove incorrectly assembled nucleic acids (e.g., by size fractionation) and/or to enrich correctly assembled nucleic acids (e.g., by amplification, optionally followed by size fractionation). In some embodiments, correctly assembled nucleic acids may be amplified (e.g., in a PCR reaction) using primers that bind to the ends of the predetermined nucleic acid fragment. It should be appreciated that certain assembly steps may be repeated one or more times. For example, in a first round of assembly a first plurality of input nucleic acids (e.g., oligonucleotides) may be assembled to generate a first nucleic acid fragment. In a second round of assembly, the first nucleic acid fragment may be combined with one or more additional nucleic acid fragments and used as starting material for the assembly of a larger nucleic acid fragment. In a third round of assembly, this larger fragment may be combined with yet further nucleic acids and used as starting material for the assembly of yet a larger nucleic acid. This procedure may be repeated as many times as needed for the synthesis of a target nucleic acid. Accordingly, progressively larger nucleic acids may be assembled. At each stage, nucleic acids of different sizes may be combined. At each stage, the nucleic acids being combined may have been previously assembled in a multiplex assembly reaction. However, at each stage, one or more nucleic acids being combined may have been obtained from different sources (e.g., PCR amplification of genomic DNA or cDNA, restriction digestion of a plasmid or genomic DNA, or any other suitable source).

In some embodiments, the concentration of one or more of the components in an assembly procedure may be dynamically calibrated or adjusted (e.g., normalized) before, during or after any one of the steps of the assembly procedure in response to changes or differences in the level of one or more reaction components measured at one or more stages in the assembly procedure. In some embodiments, the adjustment may be automated. Dynamic adjustment may include monitoring reaction products at one or more steps during assembly (e.g., after one or more of the following steps: oligonucleotide synthesis, amplification, purification, assembly by extension, assembly by ligation, error removal—for example by MutS, cloning, or any combination thereof) and re-adjusting (e.g., re-normalizing) the concentrations of the intermediate products from one or more steps prior to combining them for a subsequent step. This is particularly useful in a hierarchical assembly procedure where multiple parallel reactions are being processed towards a final product and the products from one set of parallel reactions are combined in a subsequent step comprising a smaller number of parallel reactions etc., until a final product is reached. This aspect of dynamic adjustment can be automated. In some embodiments, dynamic adjustment is implemented on a microfluidic device. In some embodiments dynamic adjustment is automated on a microfluidic device.

In some embodiments, the concentration of each nucleic acid (e.g., starting nucleic acid or intermediate nucleic acid) that is combined in an assembly reaction is adjusted (e.g., normalized) to improve the assembly reaction. For example, certain oligonucleotides may be synthesized and/or amplified and/or isolated less efficiently than others. Similarly, certain intermediates may be assembled less efficiently than others in a first round of assembly. Accordingly, the concentration of each nucleic acid (or pool of nucleic acids if a pool of variant nucleic acids is synthesized to be assembled into a library) may be adjusted to approximately the same level when they are combined for an initial or subsequent round of assembly. However, in some embodiments, the concentration of different starting or intermediate nucleic acids may be set at different levels. For example, certain nucleic acids may be provided at higher concentrations than others if it is helpful for an assembly or other reaction. In some embodiments, the concentrations of one or more substrates or intermediates may be adjusted dynamically during an assembly process. For example, concentrations of different nucleic acids may be monitored continuously throughout the assembly procedure or after one or more predetermined assembly steps. The relative concentrations of different nucleic acids may be adjusted (e.g., normalized) at any stage during the assembly procedure resulting in a dynamic adjustment of different nucleic acid concentrations in response to measurements of nucleic acid levels during the assembly procedure. For example, dynamic adjustment (e.g., normalization) may include monitoring reaction products after one or more steps of the assembly process and re-adjusting (e.g., re-normalizing) the concentrations of one or more of the intermediate products from one or more steps prior to combining them for a subsequent step (e.g., by increasing or reducing the amount more of one or more nucleic acid samples that is added to a subsequent step and/or by increasing or reducing nucleic acid sample or reaction volumes). Dynamic adjustments may be automated.

It should be appreciated that nucleic acids generated in each cycle of assembly may contain sequence errors if they incorporated one or more input nucleic acids with sequence error(s). At one or more stages during the library assembly process, fidelity optimization can be performed. Error correction for variable regions is described in more detail below.

In certain embodiments, constant portions of a target sequence may be synthesized and error-corrected. In some embodiments, certain constant regions may be re-used. For example, a constant region may be assembled and used for a plurality of different assembly reactions that require to same constant region. In contrast, variable positions may be assembled without error correction. In some embodiments, the presence of a background of additional sequence variants may not interfere with the library as a whole if the number of unwanted sequence errors is low relative to the number of predetermined sequence variants in the library. However, in some embodiments the presence of errors within the constant regions of the target sequence may be undesirable if these sequence errors have a negative impact on the function of the predetermined sequence variants that they are associated with.

In some embodiments, assembly reactions may be performed using assembly nucleic acids that have not been amplified (e.g., assembly oligonucleotides that were synthesized and released from an array without an amplification step). In some embodiments, a plurality of non-amplified overlapping nucleic acids may be assembled to generate one variant sequence for a library. This variant fragment may be amplified. In some embodiments, this variant fragment may be amplified using one or more universal primers if the flanking assembly nucleic acids have sequences (e.g., sequences that may need to be removed) that are complementary to the universal primers.

FIG. 2 illustrates an embodiment of an assembly strategy for a precise, non-random library (e.g., for a library that is predetermined, for example, by identifying or specifying a subset of all possible variants that are to be assembled). A non-random library may be assembled by combining two or more pools of predetermined nucleic acid variants (e.g., predetermined oligonucleotide variants), wherein each pool represents variants of a fragment of a reference sequence (e.g., of a starting sequence, for example a scaffold sequence or a natural sequence of which variants are being made). The resulting variants then may be assembled into longer fragments (e.g., intermediate fragments and/or a final full length library). In some embodiments, these steps are discrete, separate and sequential. In other embodiments, at least some of the reactions take place in a single reaction mixture. FIG. 2 illustrates a non-limiting embodiment of such an assembly strategy of the invention. In act 200, predetermined sequence variants for a target nucleic acid are selected or obtained as described herein. Sequence variants may be variants of a single naturally-occurring protein encoding sequence. However, in some embodiments, sequence variants may be variants of a plurality of different protein-encoding sequences. In certain embodiments, the different protein-encoding sequences may be related (e.g., they code for similar or related proteins, proteins having similar or related functions, similar or related proteins from different species, or any combination thereof). In certain embodiments, library variants may be variants of a core scaffold sequence. The core scaffold sequence may be determined based on sequence comparisons (e.g., the scaffold sequence may be a consensus of sequences coding for similar or related proteins, proteins having similar or related functions, similar or related proteins from different species, or any combination thereof). In act 210, one or more variable regions are identified in a target nucleic acid. In some embodiments, a target nucleic acid is subdivided into a plurality of variable regions. In some embodiment, the entire length of the target nucleic acid is subdivided into consecutive variable regions. It should be appreciated that the length and number of variable regions selected may be related to the total number of variants to be made. For example, each variable region may be between about 10 and about 1,000 nucleotides long (e.g., about 50, about 100, about 200, about 500). However, shorter or longer variable regions may be selected. Each variable region may include between about 5 and about 10,000 different variants (e.g., about 10, about 50, about 100, about 1,000 or more). However, fewer or more variants may be included in a variable region. According to the invention, the theoretical final number of variants will be the product of the number of variants in each variable region that are combined together to form the final library. By assembling a plurality of relatively short variable regions each with relatively few variants, a relatively large number of final variants may be generated. Starting nucleic acids corresponding to each variant of a variable region may be independently synthesized (e.g., on separate columns, on surfaces such as chips, etc.) resulting in a precise synthesis of predetermined sequences (as opposed to a degenerate oligonucleotide that represents a plurality of predetermined sequences of interest in addition to a plurality of unwanted sequences). Accordingly, by combining precisely synthesized variable regions together, a high number of predetermined variants may be assembled precisely from a relatively low number of uniquely identified starting nucleic acids. In act 220, constant regions may be identified or selected. In some embodiments, no constant regions may be selected. However, in other embodiments one or more constant regions may be identified or selected (e.g., between variable regions). A constant region may be independently assembled and combined with one or more variable regions to produce a final library. Constant region(s) may be error-corrected, regardless of whether the variable region(s) are error-corrected. In some embodiments, each variable region is separated by a constant region. In some embodiments, each variable region has an invariant sequence at each end to be used for assembly with neighboring variable and/or constant regions. Accordingly, a variable region may be designed to include at least one invariant nucleotide at each end. In some embodiments, 2, 3, 4, 5, 6, 7, 8, 9, 10, or more invariant nucleotides may be included at one or both ends of a variable region. The invariant nucleotides can be used (e.g., in combination with appropriate restriction enzymes such as Type IIS restriction enzymes) to generate complementary overhangs that can be used for ligating adjacent regions during assembly. In act 230, an assembly strategy is designed to determine the order in which the variable and constant regions are to be assembled and which regions and/or assembled fragments are to be error corrected.

Accordingly, a library may be designed and assembled to include all or substantially all of a large number of predetermined sequences of interest (e.g., at least 100; at least 1,000; at least 10,000; at least 100,000; at least 10⁶; at least 10⁷; at least 10⁸; at least 10⁹; at least 10¹⁰ or more different nucleic acid variants). However, it should be appreciated that in some embodiments not all predetermined nucleic acids will be present in any given library. For example, between 50% and 100% (e.g., at least 60%, at least 65%, at least 70%, at least 75%, at least 80%, at least 85%, at least 90%, at least 95%, or at least 99%) of predetermined sequences may be present. It also should be appreciated that a library assembled according to methods of the invention may include some errors that may result from sequence errors introduced during the synthesis of the assembly nucleic acids and/or from assembly errors during the assembly reaction. Error removal may be performed at one or more stages during assembly as described herein. In some embodiments, error removal may involve removing single base errors in the starting assembly nucleic acids or after one or more assembly stages (e.g., using a mismatch binding protein, sequencing, or other suitable techniques). In certain embodiments, error removal may involve size analysis or size selection of the starting assembly nucleic acids or after one or more assembly stages to remove assembled nucleic acids of unexpected sizes. However, unwanted nucleic acids may be present in some embodiments. For example, between 0% and 50% (e.g., less than 45%, less than 40%, less than 35%, less than 30%, less than 25%, less than 20%, less than 15%, less than 10%, less than 5% or less than 1%) of the sequences in a library may be unwanted sequences.

Accordingly, different libraries with different types of variants (e.g., substitutions, deletions, insertions, etc., including silent mutations) or combinations thereof may be designed and/or assembled. Different libraries may have different levels of representativeness and/or density.

Variant Library

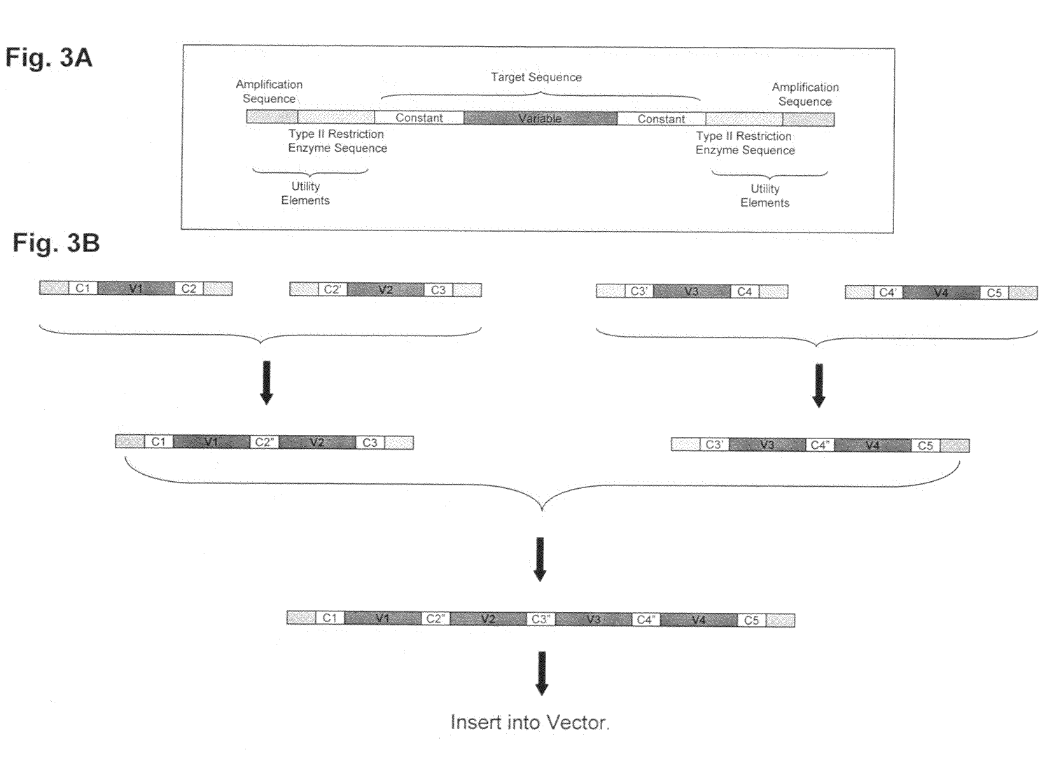

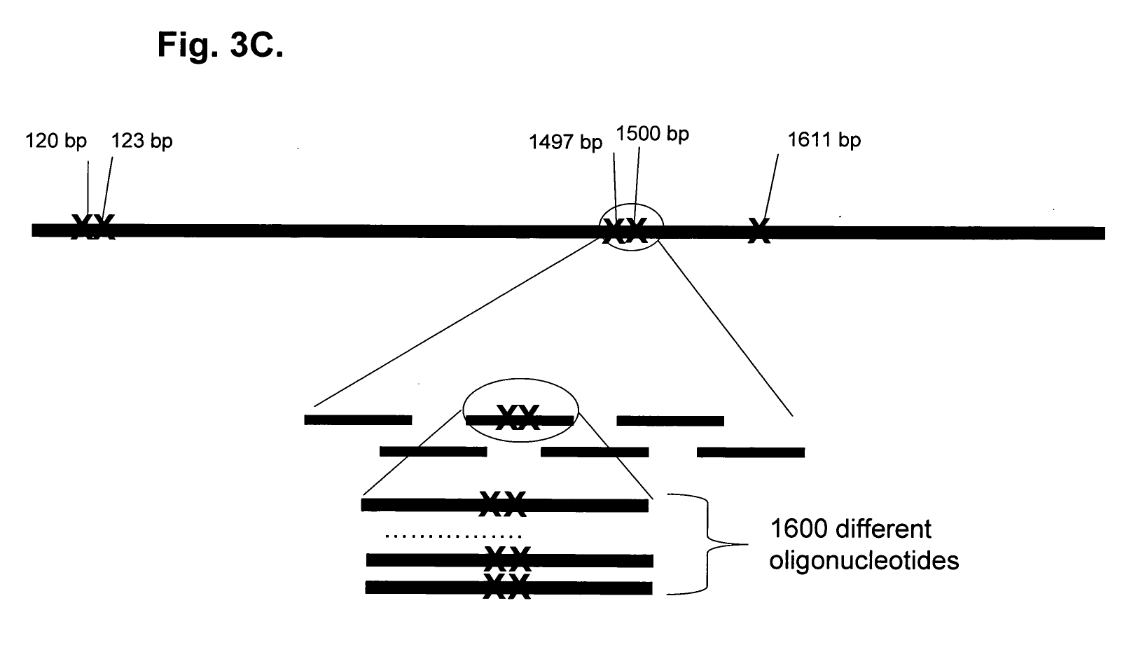

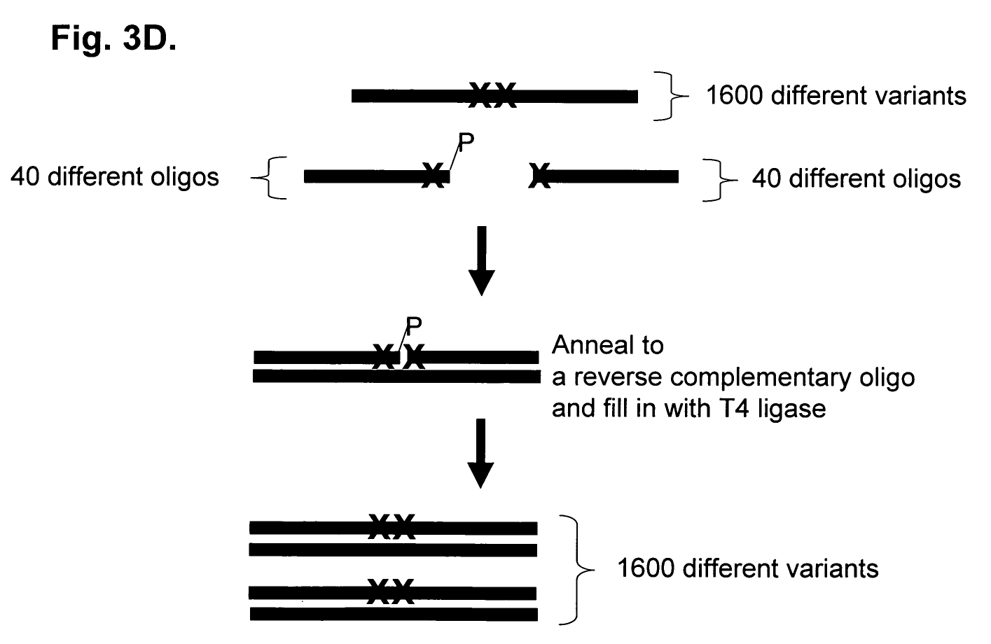

The invention further provides methods of designing nucleic acids (e.g., oligonucleotides) that are useful for constructing a library of desired (predetermined) variants. FIG. 3A schematically illustrates a design of an oligonucleotide useful for methods of the invention. It should be appreciated that each oligonucleotide fragment can be of any length, but is typically 40-200 bases long. In some embodiments, each oligonucleotide fragment includes two primary elements: target and utility elements. In some embodiments, a target element may include a variable region and a constant region on at least one end of the variable region. In some embodiments, a variable region is a segment of sequences that encode a peptide, within which one or more residues are selectively varied. In the diagram of FIG. 3A, a variable region is indicated in dark gray, flanked by constant regions shown in light gray. Additional sequences present on either end of the target sequence are collectively referred to as “utility elements”. The utility elements are designed to enable or facilitate various processes involved in the construction of a library, and may include sequences useful for selection, assembly and amplification and/or other processes. It is appreciated by one of ordinary skill in the art that the presence or the exact orientation or location of each of these utility elements may vary depending on the strategy of library construction as well as other factors, and it is not intended to be limiting. For example, in some embodiments, multiple amplification sequences may be present on one oligonucleotide. In some circumstances, an oligonucleotide is designed to include a universal amplification sequence. As used herein, the term “universal amplification sequence” means that a sequence used to amplify the oligonucleotide is common to a pool of mixed oligonucleotides such that all such oligonucleotides can be amplified using a single set of universal primers. In other circumstances, an oligonucleotide contains a unique amplification sequence. As used herein, the term “unique amplification sequence” refers to a set of primer recognition sequences that selectively amplifies a subset of oligonucleotides from a pool of oligonucleotides. In yet other circumstances, an oligonucleotide contains both universal and unique amplification sequences, which can optionally be used sequentially. In each case, amplification sequences may be designed so that once a desired set of oligonucleotides is amplified to a sufficient amount, it can then be cleaved by the use of an appropriate type IIS restriction enzyme that recognizes an internal type IIS restriction enzyme sequence of the oligonucleotide.

Utility elements of oligonucleotides may optionally include one or more spacer sequences. A “spacer sequence” is a sequence of any length, but typically 1-5 bases long, that can be inserted within the utility sequence to provide a means of adjusting the reading frame or the size (length) of the oligonucleotide itself. This is useful for, for example, size-based purification, or error removal. For example, a spacer sequence can be constructed between the amplification sequence and the type IIS restriction enzyme sequence. In some embodiments, where a subset of target variants includes a deletion or addition, resulting in a shortened or lengthened target sequence, the use of a spacer sequence may be desirable to compensate for the change in the total size (i.e., length). Size-based selection or purification of the oligonucleotides may be used.

FIG. 3A illustrates an embodiment of a configuration of oligonucleotides with utility sequences that include a pair of Type IIS restriction enzyme recognition sequences flanking an internal target sequence, and a pair of amplification sequence present on the 5′ end and the 3′ end of the oligonucleotides. The amplification sequences allow the use of complementary primers for amplifying the oligonucleotide containing the same amplification sequences. This is useful in a situation where a set of oligonucleotides are desired to be selectively amplified from a pool of mixed species of oligonucleotides. This is particularly useful when oligonucleotides are synthesized de novo using any chemical synthesis method such as on a surface (e.g., a microchip). Once so amplified, Type IIS restriction enzymes can be used to create a desirable overhang of the oligonucleotides so as to allow subsequent assembly of oligonucleotide fragments. Type IIS restriction enzymes cleave outside of their recognition site (typically 4-7 bp long). The distance between the recognition sequence and the proximal cut site varies from 1 to 20 bases, with a distance of 1 to 5 bases between staggered cuts, thus producing 1-5 bases single stranded cohesive ends, with 5′ or 3′ termini. Usually, the distance from the recognition site to the cut site is quite precise for a given type IIS enzyme. All exhibit at least partially asymmetric recognition. “Asymmetric” recognition means that 5′→3′ recognition sequences are different for each strand of the target DNA. To date, more than 80 type IIS restriction enzymes have been described.

In FIG. 3B, three generic type IIS restriction enzymes are depicted in an embodiment where they are used in a two-step construction of a library of variants derived from four fragments (e.g., pools) of oligonucleotides. The exact strategy for constructing a library may depend on a number of factors such as the complexity of target sequence and the number of variants to be included. Therefore, in some circumstances, construction may involve a single step, or two, three, four, five, or more steps.

The figure illustrates a non-limiting example of four oligonucleotide variant fragments to be assembled into a final product derived from four starting sequences. It should be noted that the number of fragments to be assembled (in this example, four) may be determined by multiple factors, such as the number of general areas that contain bases (residues) to be varied, and whether or not intervening constant regions exist between these variable regions, as well as the size of such segments. Each fragment represent a pool of variants containing one or more varied bases within the variable region and sequences that are common (identical) among the variants within the pool of fragments. For example, a variable region (e.g., V1) may encode a peptide that corresponds to a defined motif of a protein, where a set of residues are selected to be varied for altered function, stability and/or structure, etc. The adjacent constant regions represent sequences that are identical among the variants of the particular pool of oligonucleotides. Therefore, a constant region is at least one base, but preferably more (e.g., 2, 3, 4, 5, 6, 7, 8, 9, 10, 10-100, 100-1,000, or more than 1,000). As will be clear to those skilled in the art, the number of fragments to be assembled into a final target sequence depends on multiple factors, such as the total length and complexity of the target. In some embodiments, a large number of relatively short fragments are assembled to generate target variants. In other embodiments, fewer fragments with relatively long or complex oligonucleotide are assembled to generate target variants. Yet other embodiments combine the two strategies to generate target variants.

Each of the four starting fragments contain a variable region, indicated as V1, V2, V3 and V4, respectively, as well as at least partially overlapping constant regions flanking the variable region. For the first fragment containing V1, constant regions shown as C1 and C2 flank the internal variable region, having the configuration: C1-V1-C2. The second fragment containing the variable region shown as V2 has the configuration C2′-V2-C3, where C2′ represents a partially overlapping sequence complementary to the C2 region of the first fragment. The two fragment variants also may contain a common type IIS restriction enzyme sequence, on the 3′ end of the first fragment and on the 5′ end of the second fragment. Accordingly, digestion of the two fragment variants with the appropriate type II restriction enzyme creates a complementary overhang on the fragments to be adjoined, yielding C″ as shown in FIG. 3B. Accordingly, using techniques well known in the art, the two fragments can be assembled to form C1-V1-C2″-V2-C3 as shown. Using a similar strategy, the other two fragments containing V3 and V4, respectively, are assembled in a separate reaction to form a second intermediate oligonucleotide, C3′-V3-C4″-V4-C5 as shown in FIG. 3B. In some embodiments, such reactions may be combined, provided that the overhang termini on different fragments created by type IIS restriction enzyme digestions are sufficiently specific from one another. Therefore, when the constant regions (for example C2 and C4 in this example) are sufficiently diverse, these reactions may take place simultaneously. In contrast, when the constant regions share homology, separate reactions may be preferred. The two intermediate oligonucleotides are then assembled in a similar fashion to generate the target oligonucleotide, C1-V1-C2″-V2-C3″-V3-C4″-V4-C5, as shown in the diagram. The remaining utility sequences on the 5′terminus and 3′ terminus of the oligonucleotide may be used for inserting the product into a desired vector. The utility sequence may correspond to a type IIS restriction enzyme recognition sequence, or other restriction enzyme recognition sequence that is compatible to a vector of interest. In some embodiments, an adapter sequence corresponding to a type IIS restriction enzyme sequence present on the 5′- and 3-ends of a target oligonucleotide is added to a vector as to render compatibility with the oligonucleotide to be inserted. It should be appreciated that this description is not limiting and a similar procedure may be used for fewer or more variable regions separated by constant regions. It also should be appreciated that each variable region described herein represents a plurality of variants (e.g., predetermined or specified variants) with than region. Accordingly, the assembly procedure described herein in the context of a variable region represents an assembly where a plurality of molecules having different sequence variants within the variable region are assembled (and wherein each variant molecule has the same constant region sequence within each different constant region described herein).

In some embodiments, variant positions in a target nucleic acid reside next to each other such that there is little intervening “constant” sequence between the two positions that are sought to be varied. In some embodiments, adjacent variant positions can be included in a variable region and different combinations of sequence variants can be individually synthesized for the variable region (e.g., within a region covered by a single oligonucleotide). However, in some embodiments, adjacent variant positions may be provided on separate nucleic acids (e.g., in separate nucleic acid pools) that are combined and assembled to provide further variation. According to aspects of the invention, adjacent variant positions on separate nucleic acids may be combined by ligation by using a complementary nucleic acid that overlaps at least the adjacent 5′ and 3′ regions. The complementary nucleic acid may be used to hybridize to the adjacent nucleic acids and provides a substrate for ligation. One or both of the adjacent nucleic acids may need to be phosphorylated (at the 3′ end or at the 5′ end) or otherwise modified to provide a substrate for a ligase enzyme. Any suitable ligase enzyme may be used (e.g., T4 ligase or any other suitable ligase). However, chemical ligation also may be used and one or both ends of the adjacent nucleic acids may need to be modified appropriately to provide a substrate for a chemical ligation reaction. According to aspects of the invention, the complementary nucleic acid should have sufficiently long 5′ and 3′ complementary regions (e.g., at least 5, 5-10, at least 10, 10-15, at least 15, 15-20, at least 20, 20-30, at least 30, 30-50, or more nucleotides independently for each of the 5′ and 3′ complementary regions) so that sequence variants at the adjacent positions of interest do not differentially destabilize the hybridized ligation substrate. In some embodiments, the complementary nucleic acid may be complementary to most or all of the length of each of the adjacent nucleic acids (excluding non-complementary nucleotides at the one or few variant positions in the adjacent nucleic acids). It should be appreciated that if the 5′ and 3′ complementary regions are not sufficiently long, certain variants may hybridize less efficiently and therefore may be under-represented in an assembled library. In some embodiments, the complementary nucleic acid may be designed so that it is not complementary to any of the predetermined variants at the variant position, thereby to avoid preferential ligation of any of the different variants. Accordingly, the complementary nucleic acid may be designed to be complementary only to non-variant positions in at least the 3′ and 5′ regions of the adjacent nucleic acids to be assembled. However, in some embodiments, the complementary nucleic acid may be perfectly complementary to one of the variants. In some embodiments, the presence of one or two non-complementary nucleotides in some of the variants does not prevent them from being assembled into a library, particularly if the complementary regions are stabilized by a sufficient number of complementary non-variant positions. It should be appreciated that a complementary overlapping nucleic acid may be hybridized to two adjacent nucleic acids (e.g., oligonucleotides) and provide a substrate for ligation according to aspects of the invention even if the variable positions in the adjacent nucleic acids are not immediately adjacent but separated by one or more intervening constant positions.

FIG. 3C illustrates a non-limiting example where two variant positions are adjacent to each other along a sequence. Because of the configuration lacking a constant position between the two variant positions, a strategy such as that illustrated in the previous figure requiring constant nucleotides between variant positions is not applicable. In this non-limiting example, assuming that there are 40 different variants at each of the two variable positions (adjacent variable codons) within an oligonucleotide, it would be necessary to generate 40×40=1,600 combinations of oligonucleotide variants using a conventional approach. To reduce the number of constructs necessary to generate all the combinations of variants, the instant invention discloses a faster, more economical approach of variant library construction, in which two variable sites are closely positioned along a sequence. According to the invention, a stretch of sequence containing two variable positions adjacent to each other is constructed as two short oligonucleotides separating the variable positions into two sets of oligonucleotides (see FIG. 3D). Accordingly, each of the short segments now contains a single variable position near one end of the segment. Again, assuming that there are 40 variants for each of the variable positions, these 40 oligonucleotides are synthesized for each of the segments. The end of the first segment is appropriately phosphorylated to promote the following reaction step (shown as P). A combination of the 40 variants from the first segment and the 40 variants from the second segment would yield all 1,600 possible combinations (40×40=1,600). To this end, a complement (a reverse complement) of the segment of nucleic acid construct that spans both of the short oligonucleotide segments is synthesized and annealed with pools of both of the short segments containing predetermined variant bases. Subsequently, the nick is filled in with a ligase (e.g., a T4 DNA ligase). It has been show that T4 ligase can catalyze this reaction even in the presence of mismatches at the end of the two segments (Cherepanov et al., J. Biochem. 129:61-68). As a result, all 1,600 combinations of oligonucleotides containing two adjacent variables may be generated.

As used herein, T4 ligase refers to a DNA- or RNA-modifying enzyme that possesses the activity to fill in a nick in a double-stranded nucleic acid. T4 ligase catalyzes the formation of a phosphodiester bond between juxtaposed 5′ phosphate and 3′ hydroxyl termini in duplex DNA or RNA, using ATP as a cofactor. This enzyme will join blunt end and cohesive end termini as well as repair single stranded nicks in duplex DNA, RNA or DNA/RNA hybrids. T4 ligases are commercially available from, for example, New England Biolab (Beverley, Mass., U.S.A.). However, other suitable DNA or RNA ligases also may be used.

The library construction approach, as described herein, using T4 ligase-based nick filling in generating oligonucleotide variants, presents obvious advantage as compared to a conventional method discussed above in reducing the total number of oligonucleotides required. In the instant example, using this method, 81 (40+40+1=81) oligonucleotides—40 variants for each of the two segments plus a complementary oligonucleotide that spans the two segments—would suffice to generate the 1,600 combinations. In comparison, each of the 1,600 variants would have to be separately synthesized by a conventional method. Accordingly, when m and n are the number of variants at each position and there are two variable positions in a single oligonucleotide, the total number of variant oligonucleotides needed to make all combination is (m×n) using existing library construction strategies. If the length of nucleic acid to be assembled is 60 nucleotides, the total number of nucleotides required to be synthesized would be (m×n)×60. In contrast, using methods of the invention, only (m+n+1) oligonucleotides are required. Accordingly, the total number of nucleotides required to be synthesized is significantly less: (m+n)×30+(1×60). Aspects of the invention may be used to assemble variants where m and n independently represent different numbers of variants in adjacent regions of a nucleic acid being assembled. As discussed herein, the number of variants within a given region may represent variants at adjacent codons. Accordingly, each of N can be between 1 and 61 different amino acid encoding codons (and/or one or more of the three stop codons). It should be appreciated that this assembly technique may be used to prepare a subset of variants within a region that are then assembled with other variants to form a library of longer variant sequences. Accordingly, this assembly technique may be used to assemble pools of adjacent variants at two or more distinct locations within a construct that forms the basis of a library of sequence variants.

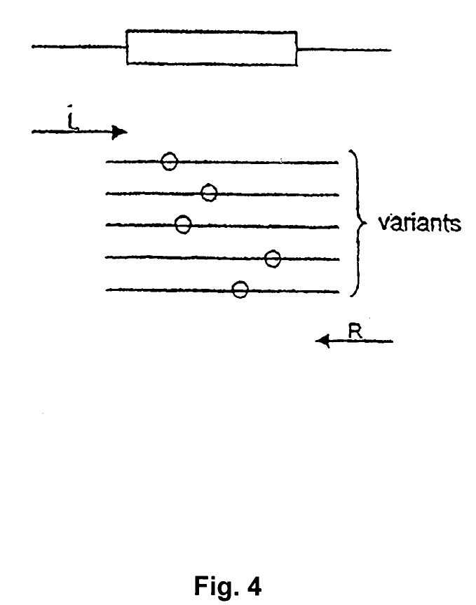

FIG. 4 illustrates an embodiment where the variant region is approximately the size of an assembly nucleic acid (e.g., an assembly oligonucleotide). In some embodiments, assembly nucleic acids designed to correspond to the same region of a target nucleic acid are designed to contain sequence variants only within their central region. These variant encoding assembly nucleic acids can be amplified by using one or more primers that bind to the non-variant 5′ and 3′ regions. Accordingly, a plurality of assembly nucleic acids (e.g., a plurality of different assembly oligonucleotides synthesized on an array), each encoding a different variant sequence, can be amplified using the same 5′ and 3′ primers (e.g., shown as L and R in FIG. 4). Accordingly, in some embodiments, these variant-encoding assembly nucleic acids are synthesized without any flanking 3′ and/or 5′ amplification sequences (e.g., without any sequences that correspond to universal primer sequences). These assembly nucleic acids can be amplified and used for assembly without removing flanking amplification regions. However, in some embodiments these variant-encoding assembly nucleic acids are not amplified and are used directly in an assembly reaction (e.g., after release from a solid support such a synthesis array). Accordingly, L and R in FIG. 4 may be adjacent assembly nucleic acids such as adjacent oligonucleotides in the assembly reaction. It should be appreciated that these adjacent oligonucleotides also may be used prior to amplification. In some embodiments, the variant-encoding assembly nucleic acids shown in FIG. 4 are designed to span a region between a 5′ fragment of a gene and a 3′ fragment of the same gene. The 5′ and 3′ fragments may be prepared using any suitable technique (e.g., by amplification, restriction enzyme cloning, etc.). Accordingly, L and R in FIG. 4 may be the 5′ and 3′ gene fragments in some embodiments. The 5′ and 3′ fragments and the variant-encoding assembly nucleic acids may be designed to include a first region of sequence overlap between the 3′ end of the 5′ fragment and the 5′ end of the assembly nucleic acids and a second region of sequence overlap between the 3′ end of the assembly nucleic acids and the 5′ end of the 3′ fragment (as illustrated in FIG. 4). Accordingly, the variant-encoding assembly nucleic acids (e.g., non-amplified) may be mixed with the 5′ and 3′ gene fragments and assembled in a polymerase-based or a ligase-based extension reaction.

Libraries the invention can be used in any method for in-vitro protein evolution, screening, or selection.

Error Correction

In some embodiments, error correction may be performed on assembly nucleic acids and/or assembled nucleic acids corresponding to one or more constant regions. Error correction may be performed using any suitable method (e.g., using mismatch repair proteins for example, MutS filtration-, mispair nucleases, size selection, sequencing, other mismatch recognition molecules, etc., or any combination thereof). The removal of errors from one or more constant regions may be useful to increase the overall precision of a nucleic acid library even if error correction or removal is not performed on the variable regions.

However, in some embodiments, error correction may be performed on one or more variable region nucleic acids in addition to or instead of error correction/removal for constant region nucleic acids.

Methods such as MutS filtration and mispair nucleases that rely on hybridization of strands within a mixture may be more difficult to apply to certain types of pooled library constructions. In particular, if a pool containing multiple sequences is constructed, and if two different duplexes in the mixture are homologous enough that they will anneal, melting and annealing of these duplexes as is done in mismatch/nuclease methods will produce a significant fraction of heteroduplexes between the correct versions of both of these sequences, and these heteroduplexes would be “incorrectly” removed from the pool. When all the constructs in the pool are homologous, the problem is amplified significantly. Losses of this type can be significant enough to make MutS/nuclease error filtration strategies impractical on pools.

One way to avoid or reduce this problem is to form nucleic acid heteroduplexes prior to mixing. When starting from individual constructs (e.g., IDT oligos), a strategy is to mix pairs of complementary single strands (oligos or longer constructs) in separate pools, thus preventing hybridization to homologous constructs. In some embodiments, these duplexed strands can be filtered individually to remove errors. In some embodiments, these duplexed strands can be mixed with other duplexed strands, and a multiplexed error filtration can be performed.

Another way to avoid or reduce this problem is to design a set of nucleic acid duplexes that all have about the same melting temperature. The nucleic acids can then be melted and annealed slowly to their common melting temperature, holding the temperature around the melting temperature before performing an error filtration reaction (e.g., a MutS filtration). According to this aspect of the invention, the annealing can be driven toward proper homoduplex formation and avoid problems caused by snap annealing when a pool of nucleic acids is melted and annealed to room temperature. In some embodiments, it may not be necessary to have the nucleic acids designed to have a tight range of melting temperature. In some embodiments, this technique may be used when the duplexes are fairly short (e.g., oligonucleotides of about 20 to about 100 nucleotides long) and when they do not have very high GC content.

However, in cases where libraries differ for example by a single nucleotide, some fraction of the duplexes may cross hybridize. Even if no library member contains a sequence error, some of the library members may be bound to, for example, a mismatch repair protein. Some of the library member may be filtered out because they are being compared to another member of the library and not to themselves. This technique may cause the yield of homoduplexes after, for example, a MutS filtration process to decrease as the sequence homology in the library increases.

Error Correction of a Variant Library

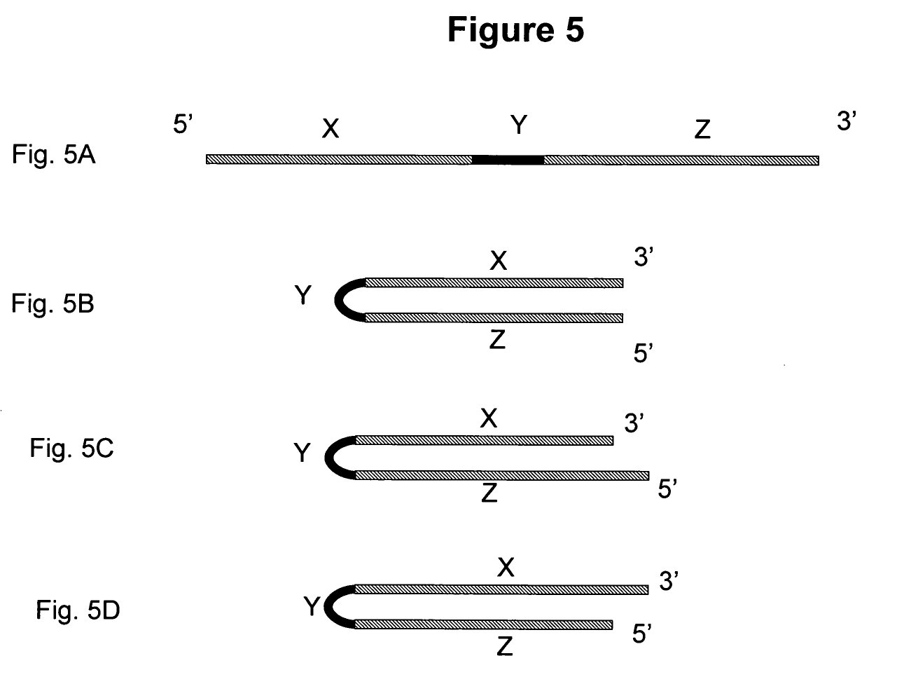

One challenge in particular with regard to error removal in the context of a variant library is that methods such as MutS filtration and mispair nucleases (or other mismatch recognition processes) that rely on hybridization of strands within a mixture may be more difficult to apply. In particular, because a mixture of variants contains highly homologous sequences, the process of melting and annealing to generate heteroduplexes containing sequence errors will likely also result in hybridization of duplexes that contain mismatch(es) (e.g., heteroduplexes) at the loci of variations/mutations. As a consequence, mismatch/nuclease methods will inadvertently recognize and remove variants of otherwise correct sequences from the pool in addition to sequence errors. To prevent such loss of heteroduplexes that contain correct sequences but have annealed to unintended partners by being “incorrectly” removed from the pool, the invention further provides nucleic acid (e.g., oligonucleotide) configurations referred to a “stem and loop” configurations and methods of using them to specifically remove unwanted sequence errors from starting nucleic acids. As will become clear to those skilled in the art, the “stem and loop” structure is useful for error correction. In general, a nucleic acid of this context contains a target sequence, and one or more complementary sequences attached to the target sequence via one or more linking segments. Accordingly, the nucleic acid can form a “stem and loop” structure with the complementary region forming the stem(s) and the linking segments forming the loop(s). FIGS. 5-8 illustrate non-limiting examples of these structures and related assembly techniques.

One of ordinary skill in the art will recognize that, generally, a nucleic acid having a stem and loop structure is useful for: 1) error removal using a mismatch-recognition agent, wherein error(s) are introduced during the synthesis of an oligonucleotide; and 2) preventing unwanted removal of correct oligonucleotides from a library, particularly those having wanted variant sequences. In some embodiments, the invention involves combining two or more pools of “stem and loop” oligonucleotides for assembly, wherein each pool corresponds to a different region (e.g., Variants of a different region) of the target nucleic acid to be assembled.

“Stem and Loop” Oligonucleotides

Aspects of the invention relate to nucleic acid variant libraries and methods of designing nucleic acids (e.g., oligonucleotides) that are useful for constructing a library containing large numbers of specified sequence variants. In one aspect, the invention provides methods for designing oligonucleotides having predetermined sequences to be assembled to form a desired target nucleic acid sequence. The “stem and loop” configuration described in the instant invention is useful for a number of applications. For example, the invention may be used in conjunction with MutS-based error correction. More specifically, oligonucleotides having the stem and loop configuration may be used to prevent unwanted hybridization between variants by providing intramolecular masking of sequences by complementary pairing thereby minimizing mistaken error recognition by a mismatch-recognizing agent. Examples of mismatch-recognition agents include proteins and fragments thereof that specifically recognize and bind to the site of a mismatched nucleic acid duplex. Non-limiting examples of mismatch-recognition proteins include MutS.

As used herein the term “stem and loop” refers to a composition comprising a nucleic acid (e.g., an oligonucleotide or polynucleotide) that contains one or more segments of nucleic acid (“stem”) capable of forming double-stranded nucleic acid via intramolecular Watson-Crick pairing (e.g., complementary sequences) and at least one “loop” segment that separates the stem segments. As described in more detail below, a segment of an oligonucleotide that corresponds to a target sequence can interact with a complementary sequence present within the oligonucleotide molecule, which can then “fold over” to form a double-stranded nucleic acid, while a loop segment forms a single-stranded protrusion at one end of the stem. The complementary segment that forms a double-stranded stem with the target sequence acts as a protective mask, for example, in the context of generating a library of variants. Variants of a nucleic acid having considerable sequence similarities may, even under relatively stringent conditions, likely hybridize to other species of variants, resulting in double-stranded nucleic acids containing mismatched pair(s), e.g., at the variable loci. This presents a technical challenge for removing error-containing nucleic acids using mismatch-recognizing proteins, such as MutS because MutS cannot discriminate between correct variant nucleic acids and nucleic acids containing an actual error. Thus, by providing a masking means described herein, e.g., the stem-and-loop configuration, which can prevent variant nucleic acids from hybridizing to highly similar but unintended partner molecules, MutS-based error removal may be performed with minimal loss to variant nucleic acids having correct sequences. It should be appreciated that in the context of a pool of sequence variants, each variant is designed and synthesized to contain the variant sequence within the one strand of the target region and a complement of the same variant sequence within the complementary region of the stem. Accordingly, each variant contains a different target sequence and a corresponding different complementary sequence. If the variant is assembled without any sequence errors, the hybridized stem structure does not contain any mismatches that are recognized by a mismatch recognition molecule (e.g., a protein such as MutS). However, if a sequence error is introduced during synthesis, the stem structure will contain a mismatch at the site of the error (unless a complementary error is introduced at the corresponding position on both complementary strands, which is highly unlikely). Accordingly, an error-containing nucleic acid can be removed (e.g., using a MutS-based mismatch removal procedure). It should be appreciated that methods involving this configuration will remove nucleic acids that are synthesized with an error on either strand of the target region that forms a stem.

It should be recognized that the stem and loop configuration is also useful generally for removing errors that are, for example, introduced during the synthesis of oligonucleotides (e.g., containing incorrect sequences) regardless of whether they are part of a pool of variants.

The loop segment in some embodiments may be a stretch of nucleotides that does not interfere with the complementary pairing of nucleic acid of the stem segments. In general, a loop is a relatively short segment that links complementary stem sequences discussed above. In some embodiments, a loop segment is a stretch of nucleic acid. For example, a loop segment may be a single-stranded stretch of nucleic acid having, for example, 3, 4, 5, 6, 7, 8, 9 or 10 nucleotides. However, it should be appreciated that in other embodiments a loop may comprise a linking component other than nucleic acid. When a segment of an oligonucleotide forms a double-stranded “stem” with a complementary segment of the same oligonucleotide, a loop segment that separates the complementary sequences protrudes, or “loops out.” In some embodiments, a loop segment may comprise a modified base, a nucleotide analog, or may be a backbone that is abasic (lacking a base). In some cases, a loop segment may comprise a chemical linker. However, it should be appreciated that the loop should be sufficiently large to not be recognized by the mismatch recognition molecule that is being used for error removal or correction.

After error removal or correction (e.g., after isolating the nucleic acids that do not contain mismatches), the loop may be removed prior to further assembly of a target nucleic acid sequence, as discussed in more detail herein.

Many embodiments of stem-and-loop nucleic acids are contemplated. For example, in some embodiments, the stem-and-loop nucleic acid forms a single hairpin structure. In other embodiments, the stem-and-loop nucleic acid forms a dumbbell structure.

A hairpin oligonucleotide as used herein refers to an oligonucleotide that contains a double-stranded stem segment and one single-stranded loop segment wherein the first strand and the second strand that form the double-stranded stem segment are linked and separated by a loop segment (e.g., a single-stranded oligonucleotide segment that forms the loop) and wherein the first strand is complementary to the second strand. A dumbbell oligonucleotide as used herein refers to an oligonucleotide comprising one first strand and two portions (a first and a second portion) of a second strand wherein the first strand is separated from each of the two portions of the second strand by two loop segments (e.g., two single-stranded oligonucleotide segments forming two loops). The first strand can be either the sense strand or the antisense strand of the stem. Thus, when the first strand is the sense strand, the second strand is the antisense strand. In the dumbbell structure, the first and the second portions of the second strand can be any size portion of the second strand that is complementary to the first strand. In some embodiments, the first and the second portion of the second strand are approximately equal halves of the second strand. In a preferred embodiment, the first and the second portions of the second strand are exactly equal halves of the second strand. The sense strand and the antisense strand can comprise the same number of nucleotides or substantially the same number of nucleotides. The stem and loop segments can be prepared by any method known in the art. In a preferred embodiment, a hairpin or dumbbell oligonucleotide is synthesized as a single oligonucleotide. Alternatively, each segment (first strand, second strand, portion of the second strand, first loop, second loop, etc.) may be synthesized separately and may be coupled together as a stem and loop nucleic acid by conjugation with a separately prepared linker.

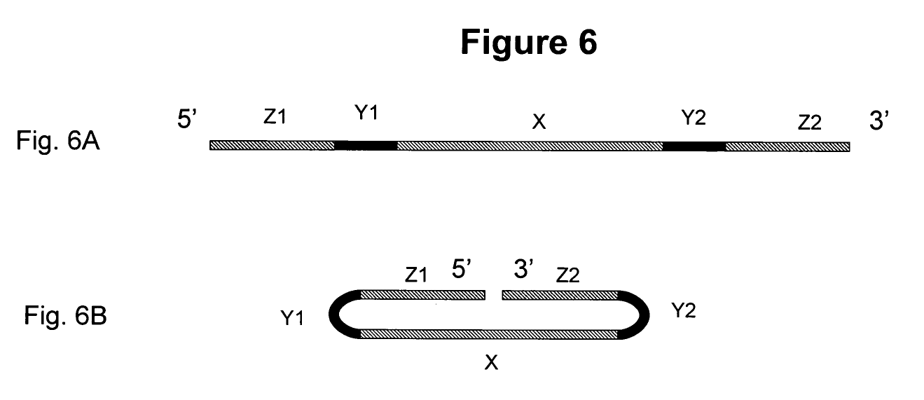

In one aspect of the invention, a library of stem and loop oligonucleotides having sequence variations is produced. An oligonucleotide can be of any length, but is typically 40-200 bases long. In one embodiment, each oligonucleotide forms a hairpin structure comprising 3 elements: a sense strand (element X) a loop structure (element Y) and antisense strand (element Z) forming a self-complementary stem and loop structure wherein elements X and Z are self complementary and element Y is a single stranded loop segment. FIG. 5A illustrates an embodiment of a configuration of oligonucleotides with elements X, Y, and Z. In another embodiment, each oligonucleotide forms a dumbbell structure comprising five elements described from 5′ to 3′: a first partial antisense strand (element Z1), a first loop structure (element Y1), a sense strand (element X), a second loop structure (element Y2) and a second partial antisense strand (element Z2) wherein elements X and Z1, and, X and Z2 are self complementary and elements Y1 and Y2 are single stranded loops (see FIG. 6). In some embodiments, the 5′ and the 3′ end of the dumbbell oligonucleotides are ligated by a DNA ligase. In some other embodiments, after self annealing of the first and the second portion of the second strand to the first strand, a possible gap is filled by a DNA polymerase.

Accordingly, one aspect of the invention provides libraries of oligonucleotide variants wherein each member of the library is designed to have a stem and loop structure with a first strand and a second strand wherein the first strand is complementary to the second strand and wherein the first strand is linked to the second strand or portion of the second strand by one or two loops. One skilled in the art would appreciate that by biasing each member of the library to self-anneal and to form a closed or semi-closed conformation such as a stem and loop structure, only the stem and loop oligonucleotides comprising a mismatch will bind the mismatch repair proteins and will be removed from the pool of oligonucleotide variants.

Stem and loop oligonucleotides of the invention may anneal together forming dimers with one or two bubble structures (corresponding to the loop(s)) or the sense sequence of one oligonucleotide may anneal to the antisense and the entire oligonucleotide will form a stem and loop structure. It should be appreciated that under selected conditions such as concentration of the oligonucleotides, ionic strength or stringency of the buffer, temperature, Tm, etc., intramolecular hybridization of the nucleic acid strands may be favored over intermolecular hybridization between two oligonucleotides. Any suitable condition(s) promoting intramolecular interaction (i.e., self annealing) can be used in methods of the invention. For example, depending on the concentration of each oligonucleotide in the library pools, complementary oligonucleotides having sequence homology can hybridize to each other. In some embodiments, the concentration of oligonucleotides is low enough so as to trigger stem and loop formation compared to homoduplex (between identical oligonucleotides) or heteroduplex (between distinct oligonucleotides) formation. One should appreciate that in some aspects of the invention, synthetic oligonucleotides synthesized in parallel are not amplified prior to assembly. These oligonucleotides can be synthesized without a 5′ and/or a 3′ amplification sequence. Such oligonucleotides may be released from an array in pools with a concentration of about 0.1 μM, about 0.5 μM, about 1 μM, or any other concentration. In certain embodiments, oligonucleotides are not amplified before assembly and are used at a concentration below 1 μM, below 0.5 μM or below 0.1 μM oligonucleotides to favor a stem and loop structure.

In some embodiments, prior to self annealing, oligonucleotides are denatured under appropriate conditions. Any suitable denaturing conditions can be used in methods of the present invention. Denaturing conditions may include high temperatures (for example 95° C.), reduced ionic concentrations, and/or the presence of disruptive chemical agents such as formamide or DMSO. In one embodiment, the oligonucleotides are denatured at temperatures of about 95° C. for several minutes (e.g., 5-10 minutes). For the self annealing step, temperature conditions may be chosen in regards to the melting temperature (Tm) of the oligonucleotides. As used herein, “Tm” and “melting temperature” are interchangeable terms which are the temperature at which 50% of a population of double-stranded polynucleotide molecules becomes dissociated into single strands. Equations for estimating the Tm of polynucleotides are well known in the art. For example, the Tm may be estimated by the following equation: Tm=69.3+0.41 X (G+C) %−650/L, wherein L is the length of the probe in nucleotides. Other more sophisticated computations exist in the art, which take structural as well as sequence characteristics into account for the calculation of Tm. One should appreciate that the Tm of the stem and loop structure is influenced by the length of the stem portion and by the sequence composition of the stem portion (e.g., the GC content). In some embodiments, the stem elements may be of the same length or may differ in length. For example, the stem element may be about 20, about 30, about 40, about 50, about 60, about 70, about 80, about 90, about 100 or more nucleotides long. In some embodiments, the stem elements are about 40 to about 100 nucleotides long. As an example, the Tm of an oligonucleotide having a sequence including 30 consecutive As is about 55.5° C. whereas the Tm of an oligonucleotide having a sequence including 30 consecutive Cs is about 90° C. One should appreciate that the Tm of each oligonucleotide in a pool of variant may be different. Melting temperatures of oligonucleotides or oligonucleotide variants may differ by less than 0.1° C., less than 1° C., less than 10° C., less than 20° C., less than 30° C., less than 40° C., less than 50° C., etc. For example, the Tm difference between two oligonucleotide variants differing by one substitution may be less than 0.1° C. Accordingly, in order for the oligonucleotide to adopt a stem and loop conformation and to maintain the stem and loop conformation, it is preferable to choose an annealing temperature corresponding to or below the lowest Tm of the oligonucleotides in a pool. The oligonucleotides may be melted and annealed slowly to the lowest melting temperature. In some embodiments, the oligonucleotides are denatured and chilled rapidly to a temperature below the lowest Tm to favor intramolecular structure formation. In some embodiments, when assembling two pools of oligonucleotides, the melting temperatures of each oligonucleotide in a first pool of oligonucleotides may be different from the melting temperatures of each oligonucleotide in the second pool. Accordingly, it is preferable to choose an annealing temperature corresponding to or lower than the lowest Tm to ensure that all oligonucleotides in the first and second pool are forming hairpin structures. However, in some embodiments, oligonucleotides from a first pool are denatured and allowed to anneal independently from the oligonucleotides from a second pool. Two pools of hairpin oligonucleotides may then be combined and assembled. In some embodiments, the Tm is modified through the introduction of modified nucleotides or nucleotides analogs such as locked nucleic acids. A “nucleotide analog”, as used herein, refers to a nucleotide in which the pentose sugar and/or one or more of the phosphate esters are replaced with their respective analogs. Exemplary pentose sugar analogs are those previously described in conjunction with nucleoside analogs. Exemplary phosphate ester analogs include, but are not limited to, alkylphosphonates, methylphosphonates, phosphoramidates, phosphotriesters, phosphorothioates, phosphorodithioates, phosphoroselenoates, phosphorodiselenoates, phosphoroanilothioates, phosphoroanilidates, phosphoroamidates, boronophosphates, etc., including any associated counterions, if present. Also included within the definition of “nucleotide analog” are nucleobase monomers which can be polymerized into polynucleotide analogs in which the DNA/RNA phosphate ester and/or sugar phosphate ester backbone is replaced with a different type of linkage. A nucleotide analog can also be a locked nucleic acid (LNA) or a peptide nucleic acid (PNA).

In some embodiments, each oligonucleotide is designed to have a stem-and-loop structure as shown in FIG. 5B, 5C or 5D and FIG. 6. The first and second strands (elements X and Z in the hairpin structure or elements X, Z1 and Z2) forming the stem structure can each comprise a utility sequence and a subsequence to be assembled. In some embodiments, the first and second strands each comprise a utility sequence and a variable sequence wherein each variable sequence includes one or more nucleotides that are selectively varied. The variable sequence can be of any length, but is typically 30 to 200 bases long. In some embodiments, the first and second strands (e.g., element X and element Z) located within the double-stranded segment are a perfect match. As used herein, two perfectly matched nucleotide sequences refers to nucleic acid sequences that match according to the Watson and Crick base pair principle, i.e., A-T and G-C pairs in DNA and A-U, and G-C pairs in RNA or DNA-RNA duplex, and there is no deletion or addition in each of the two matching nucleic acid elements. One should therefore appreciate that if there is one variation in element X, a complementary variation is found in element Z. For example, if T is substituted to G in element X, A is substituted to C in element Z. The utility sequences may be located at the 3′ end of element X (element x) and 5′ end of element Z (element z) and are complementary to each other (see FIG. 6). The utility sequences can be at least 10, at least 15, at least 20 bases long, or any other suitable length. In some embodiments, the utility sequences are identical for a pool of oligonucleotides whereas in other embodiments the utility sequences are different for each oligonucleotide or for subsets of oligonucleotides. In some embodiments, the utility sequence includes a restriction enzyme recognition sequence. In some embodiments, the flanking sequences include primer sites. In some embodiments, the oligonucleotides to be assembled have different restriction enzyme recognition sequences. The restriction enzyme recognition sequence can be a type IIS restriction enzyme recognition sequence. Type IIS restriction enzymes can be used to create desirable overhangs of the nucleic acid fragment so as to allow subcloning into vectors or subsequent assembly of nucleic acid fragments. Type IIS restriction enzymes cleave outside their recognition site (typically 4-7 bp long). The distance between the recognition sequence and the proximal cut varies from 1 to 20 bases, with a distance of 1 to 5 bases between staggered cuts, thus producing 1-5 bases single stranded cohesive ends, with 5′ or 3′ termini. Usually, the distance from the recognition site to the cut site is quite precise for a given type IIS enzyme. All exhibit at least partially asymmetric recognition. “Asymmetric” recognition means that 5′→3′ recognition sequences are different for each strand of the target DNA. To date, more than 80 type IIS restriction enzymes have been described. In some other embodiments, the cleavage site may be within the single stranded loop or adjacent to the single stranded loop. The cleavage site can include any cleavable entity. For example, the cleavage site can include a pair of Uracil ribonucleic acids. Uracil ribonucleic acids are cleavable using Uracil glycosylase followed by heating or using a biologically active variant of the enzyme or a fragment thereof.

In some embodiments, a single stranded loop of the hairpin oligonucleotide must contain at least 2 nucleotides. In certain embodiments, the loop portion is at least 5, at least 8, at least 10 or more nucleotides long. Preferably, the loop is 6 to 8 nucleotides long. It is appreciated by one skilled in the art that the loop sequence has a unique sequence that is not complementary to the stem sequence and not complementary to itself. The loop sequence may be unique to each oligonucleotide. In some embodiments, the loop sequence is unique to a pool of oligonucleotides such as oligonucleotide variants. In some embodiments, the loop structure(s) comprise one or more primer sites.

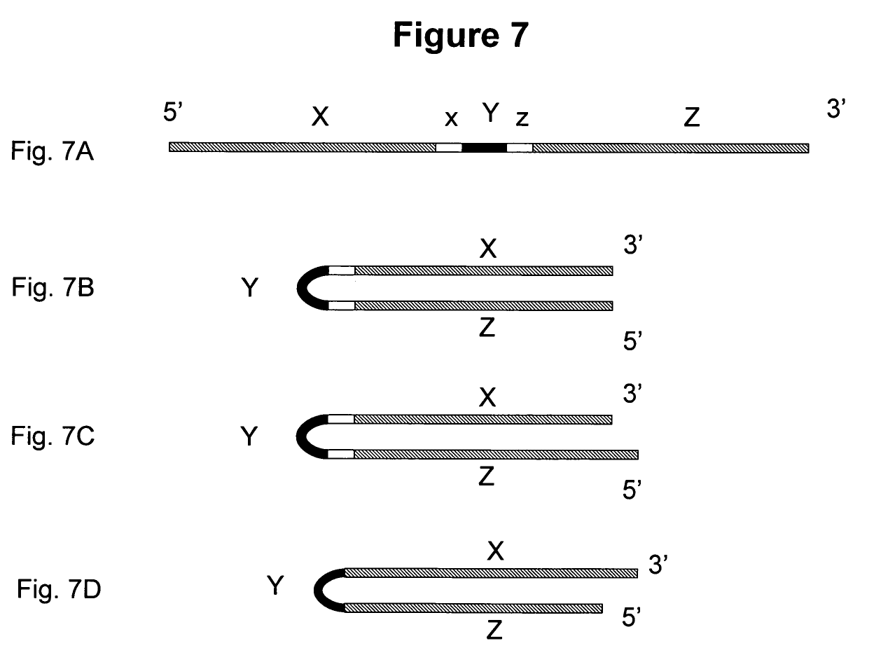

In some embodiments, the hairpin structure further comprises 3′ and/or 5′ single stranded regions(s) extending from the double-stranded stem segment. For example, in some embodiments the hairpin structure comprises 1, 2, 3 or more nucleotides extending at the 3′ (FIGS. 5D and 7D) or the 5′ end (FIGS. 5C and 7C). However, in some embodiments, element X and element Z of the hairpin oligonucleotide have exactly the same length (e.g., a blunt end hairpin oligonucleotide).

In some embodiments, the invention relates to high density stem and loop (e.g., hairpin or dumbbell) oligonucleotide libraries spanning the length of a variable region of a predetermined target nucleic acid. Two or more pools of independently synthesized stem and loop (e.g., hairpin or dumbbell) oligonucleotides may be combined and assembled to generate a larger pool of longer predetermined sequence nucleic acid (e.g., an intermediate fragments and/or final full length library). The number of assembled nucleic acids is expected to be the product of the number of initial oligonucleotides in each pool that is used for assembly. Accordingly, a high-density stem and loop (e.g., hairpin or dumbbell) oligonucleotide library may include more that 100 different sequence variants (e.g., about 10² to 10³; about 10³ to 10⁴; about 10⁴ to 10⁵; about 10⁵ to 10⁶; about 10⁶ to 10⁷; about 10⁷ to 10⁸; about 10⁸ to 10⁹; about 10⁹ to 10¹⁰; about 10¹⁰ to 10¹¹; about 10¹¹ to 10¹²; or more different sequences).

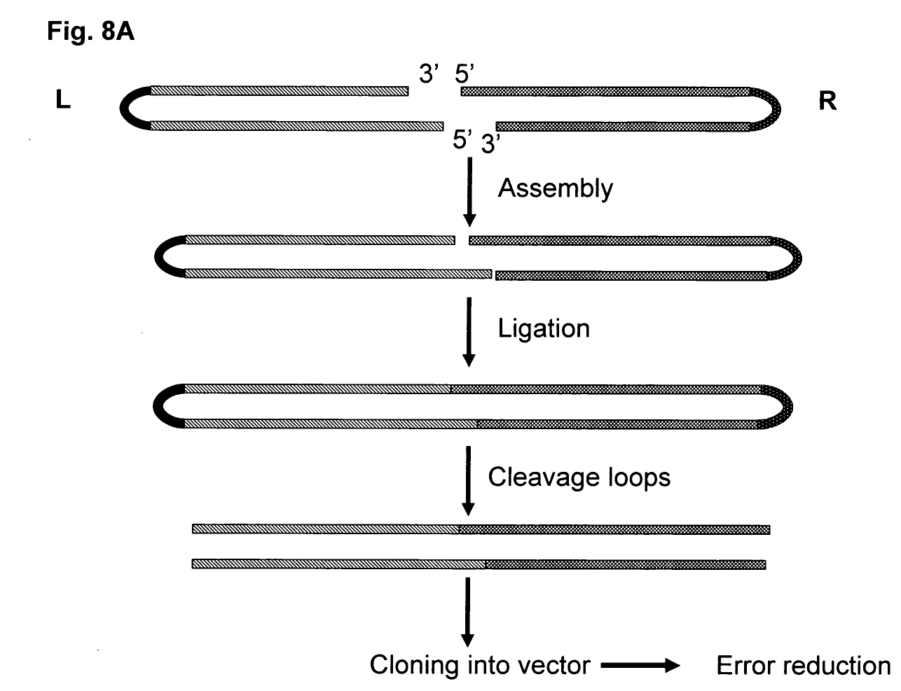

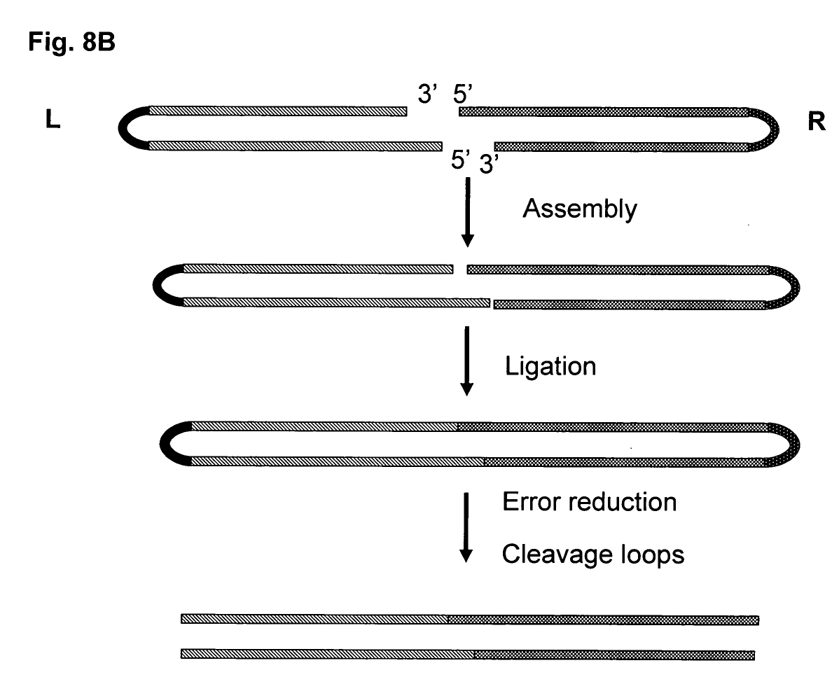

The present invention provides for libraries of stem and loop oligonucleotides useful for assembly. In another aspect, the invention provides for libraries of longer polynucleotides and methods for making such libraries. One aspect of the invention relates to assembling precise high density nucleic acid libraries. FIG. 8 illustrates a non-limiting example of two oligonucleotides to be assembled through their 5′ extension or overhanging ends. In a preferred embodiment, each oligonucleotide represents a pool of variants containing one or more varied bases within the target sequence. A first oligonucleotide having a hairpin structure (for example, left hairpin L in FIG. 8A or 8B) comprises a 5′ overhanging end that is complementary to the 5′ overhanging end of a second oligonucleotide having a hairpin structure (right hairpin, R, for example). Alternatively, a first oligonucleotide having a hairpin structure comprises a 3′ overhanging end that is complementary to the 3′overhanging end of a second oligonucleotide having a hairpin structure. In some embodiments, the overhanging end of a first hairpin oligonucleotide perfectly matches the overhanging end of a second oligonucleotide. In certain embodiments, the overhanging end of the left hairpin oligonucleotide partially matches the overhanging end of the right hairpin oligonucleotide. One skilled in the art will appreciate that the ligation of overhanging ends favors a seamless assembly of the oligonucleotide pool. When the two sets of oligonucleotides are mixed, base pairing between the two overhanging ends results in the annealing of the oligonucleotides. In some embodiments, the nucleic acid lacking the phosphate at their 5′ end is first phosphorylated in presence of a kinase. For example, the nucleic acid 5′ end can be phosphorylated with T4 polynucleotide kinase. The transient base pairing can be stabilized in the presence of a ligase, for example, the T4 DNA ligase. Other thermostable or non-thermostable ligases may be used. As used herein, T4 ligase refers to a DNA- or RNA-modifying enzyme that possesses the activity to fill in a nick in a double-stranded nucleic acid. T4 ligase catalyzes the formation of a phosphodiester bond between juxtaposed 5′ phosphate and 3′ hydroxyl termini in duplex DNA or RNA, using ATP as a cofactor. This enzyme will join blunt end and cohesive end termini as well as repair single stranded nicks in duplex DNA, RNA or DNA/RNA hybrids. T4 ligases are commercially available from, for example, New England Biolab (Beverley, Mass., U.S.A.). However, other suitable DNA or RNA ligases also may be used. Also, chemical ligation may be used in some embodiments. The overlap between the overhanging ends can be from about 1 nucleotides long to about 10 nucleotides long. A preferred length for the overlap is between 2 or 4 nucleotides long. One should appreciate that if the two overhanging ends perfectly match each other, there will be no additional diversity in the predefined sequence to be assembled. In some instances, however, it may be useful to be able to add a degree of variation in the overhanging sequence. This can be done by varying the overhanging sequence, e.g., by including mismatches in the overhanging ends. The number of mismatches can be variable for example one out of three nucleotides or two out of three nucleotides can have a mismatch in their sequence. In some instances, it may be preferable to be able to have sequence variation on the entire length of the predefined nucleic acid sequence to be assembled. Therefore, in some embodiments, blunt end hairpins oligonucleotides are assembled by ligation using a ligase, such as the T4 ligase (or other enzymatic or chemical ligation techniques). In some embodiments, the ligated products can be purified to remove impurities, unwanted reaction products (e.g., to remove ligase, remove ATP, etc.).

FIGS. 8A and 8B illustrate two non-limiting embodiments of assembly procedures in which error correction is performed at different stages. However, it should be appreciated that error correction may be performed at one or more different stages in an assembly procedure. For example, in some embodiments, error correction may be performed on the stem and loop oligonucleotides prior to any assembly, after the formation of initial assembly products (e.g., after the formation of double hairpins), after assembly of a plurality of oligonucleotides to form intermediate nucleic acid assembly products (e.g., 400 to 800 nucleotide long intermediate products), or any combination thereof.

In certain embodiments, assembly of oligonucleotides is performed before cleavage of the loop structure (e.g., linearization). In this case, two hairpin oligonucleotides are assembled and form a dual hairpin structure. Yet in other embodiments, the assembly is performed after linearization of the double stranded oligonucleotide (e.g., hairpin oligonucleotide, dumbbell oligonucleotide) by cleavage of the loop structure(s). Linearized double stranded oligonucleotides can then be combined and assembled.

In some embodiments, pools of stem and loop oligonucleotides are subjected to error reduction before assembly. In some other embodiments, pools of oligonucleotides are subjected to error reduction methods after cleavage of the loop structure but before assembly. Yet in another embodiment, the error reduction step takes place after assembly of the hairpin oligonucleotides. The error reduction step can be performed before and after linearization of the dual hairpins (e.g., on the assembled linearized double stranded nucleic acids).

Accordingly, mismatch binding proteins can be used to bind to synthetic oligonucleotides or polynucleotides which have errors. Double-stranded oligonucleotides or polynucleotides that are error free may then be separated form double stranded oligonucleotides or polynucleotides bound to mismatch binding proteins. Thus, error-free oligonucleotides or polynucleotides can effectively be separated from sequences that contain errors. In a preferred embodiment, MutS or MutS homologs are used to enrich a sample for error free stem and loop (e.g., hairpin or dumbbell) oligonucleotides. As used herein, the term “MutS” refers to a DNA mismatch binding protein that recognizes and binds to a variety of mispaired bases and small single stranded loops (1-5 bases). The term is meant to encompass prokaryotic MutS proteins as well as homologs, orthologs, parlogs, variants or fragments thereof. The term encompasses also homo and hetero-dimers and multimers of various MutS proteins. In some embodiments of the invention, a sliding clamp technique may be used for enriching error-free double stranded oligonucleotides (e.g., hairpin oligonucleotides or dumbbell oligonucleotides comprising a loop of more than 5 bases or linearized oligonucleotides) before or after assembly, provided that the ends are “blocked” to inhibit dissociation of the clamped form of MutS from any heteroduplexes that are present. Ends may be blocked by cloning the assembled nucleic acid into a vector, circularizing the nucleic acids, etc., or any combination thereof. In some embodiments, certain conditions that promote the formation of a sliding clamp form of MutS or a MutS homolog may be used (see U.S. patent application Ser. No. 11/394,708 incorporated herein by reference in its entirety). In the presence of ADP, MutS specifically binds to a mismatched site of a heteroduplex polynucleotide. A subsequent addition of ATP promotes dissociation of MutS from the mismatched site. However, MutS remains tightly associated with the polynucleotide in the form of a sliding clamp that can diffuse along the polynucleotide (Gradia et al, 1999, Mol Cell, 3:255-61). For example, the double-stranded nucleic acids are circularized before being contacted with a clamped mismatch binding proteins (e.g., the sliding form of MutS or MutS homolog). In some embodiments, the double-stranded nucleic acids are circularized by cloning into a vector. In some embodiments, double-stranded nucleic acids are circularized. In some embodiments, dumbbell and/or pairs of ligated hairpin oligonucleotides may be subjected to error reduction using a sliding clamped form of MutS or MutS homolog. In some embodiments, the loops at both ends of these structures prevent a clamped form of MutS from falling of a stem structure.

In certain embodiments, an assembled polynucleotide may be introduced into a vector and transfected into a host cell, for example, a eukaryotic (e.g., yeast, avian, insect or mammalian) or prokaryotic (e.g., bacterial) cell or cell line. Ligating the polynucleotide in a vector and transforming or transfecting host cells are standard procedures. The assembled polynucleotide may be amplified by cloning or by PCR.

As a result of the design for an oligonucleotide library, and optionally for an error reduction step, assembled nucleic acids may have a lower error frequency (e.g., with an error rate of less than 1/50, less than 1/100, less than 1/200, less than 1/300, less than 1/400, less than 1/500, less than 1/1,000, less than 1/2,000 or less than 1/10,000 errors per base). In a preferred embodiment, the error rate is less than 1/1,000, less than 1/5,000 or less than 1/10,000 per base.

Accordingly, aspects of the invention relate to compositions and methods for assembling high purity libraries (e.g., libraries with few or no sequence errors). In some embodiments, libraries contain a plurality of predetermined variants of a starting nucleic acid. The starting nucleic acid may be a gene or a non-coding sequence. The starting nucleic acid may be a wild-type sequence, a nucleic acid containing one or more naturally occurring polymorphisms, a scaffold sequence, a consensus sequence or any other suitable sequence. The predetermined sequence variants may be in coding or non-coding regions. Variants in coding regions may be silent mutations or mutations that change an encoded amino acid, or combinations thereof. A library of predetermined sequence variants may be characterized or identified by the fact that it contains only a subset of all possible degenerate variants (e.g., random variants) at the variable positions of interest (positions at which variants are made). Accordingly, a library of the invention may have fewer than all four nucleotide variants (e.g., only 2 or 3 variants) at each of a plurality of variable positions (e.g., 5-10, 10-50, 50-100, 100-500, 500-1,000, or more different variable positions). In some embodiments, a library may be designed to sample variants at only one or a few (e.g., 2, 3, 4, 5, 6, 7, 8, 9, or 10) variable positions on each variant nucleic acid within the library. In some embodiments, such libraries may include a significant proportion of non-variant nucleic acids (e.g., nucleic acids having the starting sequence). The proportion of non-variant nucleic acids may be 10% or higher (e.g., about 20%, about 30%, about 40%, about 50%, about 60%, about 70%, about 80%, about 90%, or higher). However, some libraries may be designed and assembled to include only variant sequences or to include the non-variant sequence at a percentage that is consistent with other sequence in the library. Libraries that contain nucleic acids with variants at two or more variable positions of interest may be identified or characterized by the fact the variants are correlated (e.g., non random). Accordingly, an analysis of sequence variants present in a library of the invention would show that certain variant combinations are present in a non-random pattern relative to the pattern of variants that would be expected if the variants were degenerate at each position. For example, if a number of positions n were varied randomly (e.g., each with all 4 possible nucleotide variants being allowed independently of each other) the expected number of variants in a library would be 4ⁿ. Accordingly, a library of the invention having non-random variants may be identified as having fewer than 4ⁿ variants if n positions of non-random variants are present in members of the library. In some embodiments, a library of preselected non-random variants may include one of a subset of three different possible nucleotides at the variable positions (it may be the same subset of three at each different position, or different subsets of three at different positions). In some embodiments, a library of preselected non-random variants may include one of a subset of two different possible nucleotides at the variable positions. In some embodiments, a library of preselected non-random variants may include one of only a subset of three different possible nucleotides at some positions and one of only two at other positions. Accordingly, a library of non-random variants of the invention may include less than 3ⁿ variants and more than 2ⁿ variants if n positions of non-random variants are present in the members of the library. However, it should be appreciated that the size of the library (e.g., the number of individual nucleic acids contained within any particular library) will impact the number of possible variants that are identified. Accordingly, a library of the invention may contain a number of different variants that is statistically significantly lower than the number of variants expected based on the number of positions being varied in each molecule, the number of different variants allowed at each position, and the size of the library. In some embodiments, patterns of variants also may be characteristic of (e.g., useful to identify) non-random libraries. By comparing the patterns of variant nucleotides at two or more variable positions, non-random patterns may be identified as patterns of correlation between the identity of the nucleotides at two or more variable positions (e.g., at 2, 3, 4, 5, 6, 7, 8, 9, 10, 10-50, 50-100, or more variable positions). Correlation may be identified if it is statistically significantly higher than expected based on random distributions of all four possible different nucleotide variants at the variable positions. Statistical analyses may be performed using analytical and/or computer based techniques known in the art.

It should be appreciated that different types of libraries may be prepared. In some embodiments, non-random variants differ from each other by the presence of a variant nucleic acid at one of a plurality of positions of interest, but are otherwise identical in sequence over large regions. In some embodiments, different members of a library may contain variants of different starting sequences. In some embodiments, each variant in a library may have on average about one mutated nucleotide or one mutated codon (this could include several nucleotide mutations). For example, each variant at each position being varied in a coding region of a gene may be represented in an individual clone in a library. In some libraries, all possible amino acid variants may be represented for each position being varied. However, in some libraries, 2-5, 5-10, 10-15, or 15-20 different amino acid variants may be expressed for each variable position. Different subsets of amino acids may be used at different positions (e.g., polar, non-polar, hydrophobic, positively charged, negatively charged, bulky, small, neutral, etc., or any combination thereof). In some embodiments, individual clones in a library may contain variant sequences at two or more positions being varied (e.g., at 3, 4, 5, 6, 7, 8, 9, 10, 10-50, 50-100, 100-500, 500-1,000, or more). In some embodiments, libraries (e.g., scanning libraries) may include different amino acid combinations at neighboring positions (e.g., at 2, 3, 4, 5, 6, 7, 8, 9, 10, consecutive adjacent positions). A library may be made to include overlapping combinations of variants at neighboring positions. It should be appreciated that in some embodiments, libraries of the invention include only one of all possible codons for a particular amino acid being varied (accordingly, all 20 amino acids could be represented by only 20 different codons rather than using all 61). However, in some embodiments, different codons for an amino acid may be used in different variants (see, for example, the silent mutant libraries described herein).

In some embodiments, libraries may contain different truncation variants (e.g., truncation variants covering different regions of interest or different splice variants of interest). However, in some embodiments, all of the different variants have the same size.

Libraries may contain assembled nucleic acids of any size of interest (e.g., about 50-500; 500-1,000; 1,000-10,000; 10,000-50,000 or more nucleotides long).

In some embodiments, a library has high purity and has been error corrected to remove unwanted sequence errors. Accordingly, a library of the invention may include a mixture of more than 100 nucleic acid molecules, wherein a majority of the molecules are longer than 50 nucleotides, and wherein more than 95% of the molecules present are the same length (based on the fact that at a deletion rate of about 1/1000, one would expect 5% of 50 nucleotide length oligonucleotides to contain at least one deletion). In some embodiments, a library contains a mixture of more than 100 nucleic acid molecules longer than 50 nucleotides that does not contain pairs of unique molecules related by single insertion of a nucleotide or codon that are present at a concentration ratio of between 1 and 500 (based on the fact that for any particular sequence made by standard synthesis, all possible errors—deletions, substitutions, etc.—may be present at some probability).

It should be appreciated that aspects of the invention also relate to libraries of stem and loop oligonucleotides (e.g., hairpin and/or dumbbells) in different configurations as described herein.

In some embodiments, libraries of assembled nucleic acids or unassembled nucleic acids may be prepared free of contaminating proteins such as ligases, polymerases, restriction enzymes, mismatch binding proteins, etc., or any combination thereof. However, in some embodiments, a library, or an assembly intermediate of a library, may be provided along with one or more contaminating proteins such as ligases, polymerases, restriction enzymes, mismatch binding proteins, etc., or any combination thereof (e.g., in trace amounts).

Silent Mutation Libraries

Further aspects of the invention relate to generating libraries of silent mutations. In some embodiments, a library of silent mutations may be assembled to test the effect of translational pauses on protein expression and/or function.

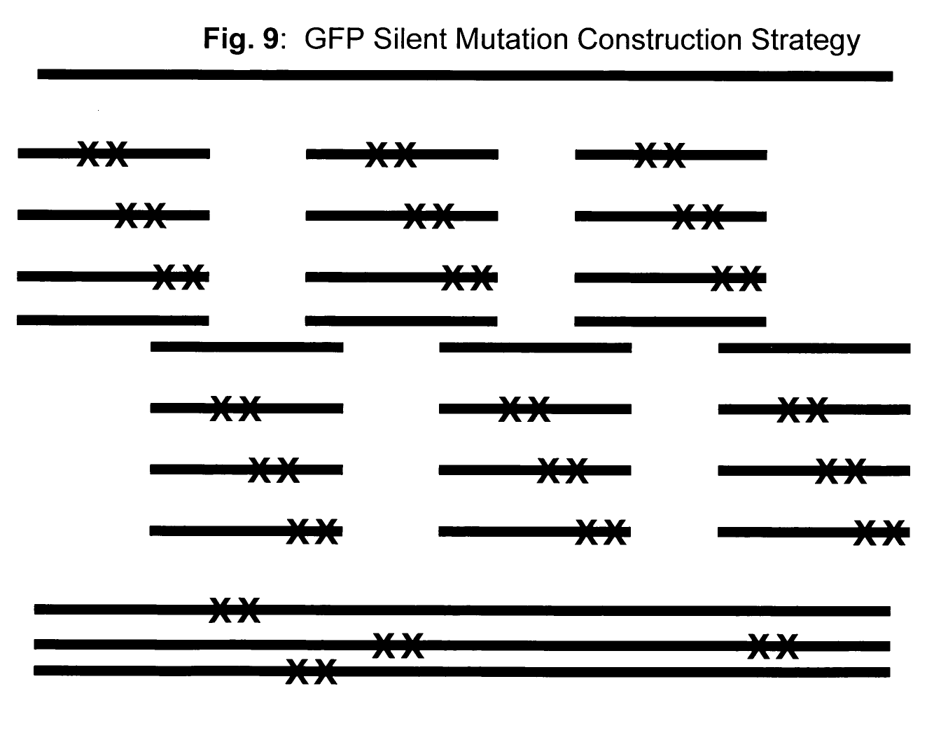

It should be noted that codon-optimization using a strategy such as silent mutation as used herein focuses on the functionality of a protein. In contrast, conventional “codon optimization” approaches used previously has seen limited success in actually optimizing the functionality of a protein. That is, “codon optimization” in prior art typically emphasized on the expression of a transcript or protein. For example, codon optimization generally entails one or more of the following: higher yield of a recombinant protein in a particular host organism, typically using a computational approach; replacement of rare codons with preferred codons for a particular host strain; removal of repeats; adjustment of GC content with respect to a host organism; removal of unfavorable mRNA secondary structures; and avoidance of cryptic splice sites and regulatory elements. It has been reported that in many cases so-called codon optimized genes often expressed lower functional protein than wild-type gene. Thus, the present invention describes a novel codon-optimization approach, e.g., silent mutations in particular, that can produce higher functional yield. For example, using a technique illustrated in FIG. 9, and described in more detail herein, clones expressing greater levels of functional protein can be selected using a silent mutation scanning technique. A library of different silent mutations may be made and screened. In some embodiments, single silent mutations at different coding/positions (e.g., at all different coding positions) may be represented individually in a library. In some embodiments, combinations of adjacent silent mutations (e.g., in two or more adjacent codons, for example, in 3, 4, 5, 6, 7, 8, 9, 10 or more, consecutive adjacent codons) may be synthesized and evaluated. In some embodiments, a library may contain overlapping series of adjacent silent mutation pairs, triplets, quadruplets, etc., that may scan the entire coding region of a protein or a portion of interest. FIG. 9 illustrates an example where a series of dicodon variants were made and tested. Based on the analysis of single or multiple codon scanning experiments, regions of sensitivity (e.g., regions where higher or lower protein function is observed in the presence of one or more silent mutations) may be evaluated using one or more subsequent libraries. Subsequent libraries may be made to provide further combinations of silent mutations (e.g., a higher number of different silent mutations or different combinations of silent mutations) around one or more sensitive positions or combinations of sensitive positions that were identified in an initial scanning analysis. It should be appreciated that this technique is useful for identifying gene variants that encoding proteins for which there is a functional assay. In some embodiments, a functional assay may yield different levels of a detectable marker that can be assayed in any suitable configuration (e.g., by cell sorting, for example based on fluorescence or other levels of detectable markers). However, in some embodiments, a surrogate functional assay may be based on correct folding of a protein (e.g., using any technique know in the art).

In some embodiments, a library (e.g., a silent mutation library) can be used to transfect or transform one or more hosts, such as bacterial, yeast, or plant hosts. The effects of silent mutations can be determined by assaying for a the reporter gene expression. If desired, screening may be carried out sequentially. For example, a first screening identifies a set of clones that exhibit differential expression due to a mutation. Based on this information, a second round of screening may be carried out in which significant changes identified in the first round can be expanded upon in a subsequent library design, which may focus on all possible combinations of the significant changes.

In some embodiments, without wishing to be bound by theory, the effect of silent mutations on protein function may relate to their effect on protein expression. If single codons can affect translation speed, in any organism with disfavored (single) codons, it should be possible to introduce translational pauses without any consideration of codon pairs. This can be accomplished simply by inserting a rare codon at the location where a pause is desired. Some potentially useful pause sites include the boundaries between domains such as linkers, loops, helices, and inteins. A stronger effect can be obtained by choosing multiple rare codons near the domain boundary.

Some aspects of the invention are based on the notion that certain silent mutations can alter the efficacy of protein translation by changing the rate, probability and or stability of tRNA recognition to the corresponding triplet to which the mutation occurred, thereby affecting the action of the ribosome and/or folding of a nascent peptide. According to the invention, the presence of rare codons may have an effect on local folding of a nascent peptide that takes form co-translationally. Indeed, rare codons often occur at the junction between two secondary structures, such as an alpha helix and a beta sheet. Evidence suggests that the presence of such codons causes a pause in the translation machinery (i.e. the ribosome and nascent peptide), and may facilitate correct folding of a local domain of the peptide. The outcome of such effects may include changes in overall protein structure, expression, stability, and function. Thus, the instant invention contemplates a library of nucleic acids that encode a peptide of interest, comprising a series of silent mutations at various positions along the length of the peptide. Such a library is useful for screening for codon-optimized species of nucleic acid sequences in a given expression system.

In some embodiments, a library may be designed and/or assembled to contain all combinations of possible codons that encode a predetermined polypeptide. Such a library may provide large amounts of information. However, in many embodiments, the number of possible variants may be too high to practically assemble and/or screen a complete library. Accordingly, in certain embodiments a library may be designed to include only a subset of all possible codons or codon combinations. According to the invention, the effect of a silent mutation is sufficiently “local” to identify significant effects by analyzing variants that have changes at only one or a few positions relative to a reference nucleic acid. For example, in some embodiments a library may include only variants that have a silent codon change at a single position. Such a library may include variants representing one or more changes at each position in a polypeptide encoding sequence. In some embodiments, all codons for each amino acid are provided by themselves (i.e., no combinations of different codons for different amino acids are provided). In certain embodiments, a library may be designed and/or assembled to include all combinations of nearest neighbors (e.g., in 2-10 amino acid stretches). In some embodiments, such “local environment” considerations are analyzed using a two step-approach. For example, significant changes in expression and or function identified in an initial library (step one) may then be analyzed in more detail by designing and/or assembling a further library containing a larger number of silent mutations and/or combinations of different silent mutations in a region identified as important for expression or function (step two). FIG. 9 illustrates the initial step of such analysis. In this example, a silent mutation library of degenerate dicodon pairs was generated, wherein “local effects” of a mutation on function of a protein (in this case GFP) can be assessed, for example, two residues at a time (See Example 5).

In some embodiments, silent mutations are provided for predetermined positions in a polypeptide-encoding sequence (e.g., at the beginning or end of certain independent secondary structures: loops, fold, etc.). In certain embodiments, all combinations of all possible codons at a selection of positions in a protein are provided in a library and may be assayed for effects on expression and/or function.

In some embodiments, only one or two different rare codons are provided for each amino acid position in different variant nucleic acids in a library. In some embodiments, a reference sequence is designed to include the most prevalent codon at each position in a polypeptide-encoding sequence. A library may be designed and/or assembled to include variants that represent single changes for all of the codon positions in the polypeptide-encoding sequence. Such a library may be used for a “rare codon scan” analysis to identify positions at which a rare codon significantly alters protein expression and/or function.

Accordingly, aspects of the invention can be used for the design of libraries of proteins with desired functions. Silent mutations can be introduced in the gene encoding a protein functionality, a specific protein, or a library of protein functionalities or a library of proteins. In some embodiments a common codon is changed into a rare codon. In some embodiments a rare codon is changed into a common codon. The library can subsequently be screened for novel or improved functionalities. The methods of screening are routine and will be known to a person of ordinary skill in the art. For instance, if the desired property is a more thermo-stable protein, the library of proteins can be screened by monitoring protein unfolding upon an increase in temperature. If the desired property is a specific structural motif, the library can be screened by antibodies that specifically bind to that structural motif. If the desired property is an activity, like polymerization, ligation, dissociation, DNA nicking, or other enzymatic process (e.g., an enzymatic process associated with a therapeutic benefit) then the desired property can be screened for by a functional assay. Non limiting examples of protein functionalities that are encoded by silent mutation libraries are protein stability including thermo-stability and environmental stability (e.g., stability towards a change in pH, solvent composition, concentration of chaotropics), oligomerization, structural properties (e.g., alpha-helicity, beta-sheet and/or other secondary structure motifs), expressibility (e.g., the amount and/or rate of protein synthesis), specificity (e.g., antibody specificity and/or related structural changes), DNA polymerization, RNA polymerization, ligation, nicking, topoisomerase activity, unwinding of DNA, dissociating of DNA, binding to DNA, binding to RNA, enzymatic properties like phosphatese, kinase, processivity, hydrolase, acetylase, protease, glycosylase, heperase, transferase, dehydrogenase, reductase, nuclease, antigen presentation, ion transport, enzymatic properties associated with therapeutic benefits, etc., or any combination of two or more thereof.

The protein libraries can be based on proteins of any species. For example, silent mutation libraries of human protein-encoding genes are included in certain aspects of the invention.

Embodiments of libraries of silent mutations encode proteins such as therapeutic proteins, pharmaceutical proteins, agricultural proteins, environmental proteins, industrial proteins, or any combination thereof. For example a library of silent mutations encoding any one of the following therapeutic proteins may be assembled and screened or selected for one or more properties of interest: calcitonin, insulin, insulinotropin, insulin-like growth factors, parathyroid hormone, nerve growth factors, TGF-β, tumor necrosis factor, glucagon, bone growth factor-2, bone growth factor-7, TSH-β, interleukin 1, interleukin 2, interleukin 3, interleukin 6, interleukin 11, interleukin 12, CSF-macrophage, immunoglobulins, catalytic antibodies, protein kinase C, superoxide dismutase, tissue plasminogen activator, urokinase, antithrombin III, DNase, tyrosine hydroxylase, blood clotting factor V, blood clotting factor VII, blood clotting factor VIII, blood clotting factor X, blood clotting factor XIII, apolipoprotein E, apolipoprotein A-I, globins, low density lipoprotein receptor, IL-2 receptor, IL-2 receptor antagonists, alpha-1 antitrypsin, immune response modifiers, α-galactosidase, glucocerebrosidase, erythropoietin, and soluble CD4, etc., including human and recombinant forms of any of these or other therapeutic proteins.

In some embodiments, a gene encoding a protein of interest (e.g., a therapeutic protein) may be analyzed and a library may be assembled including constructs each having one or more different silent mutations. The nucleic acid library may be transformed into a suitable host cell preparation (e.g., bacterial, yeast, human, insect, etc.) and the proteins expressed in different cells may be analyzed (e.g., screened or selected) for one or more desirable properties as described herein (e.g., improved functional and/or structural properties, reduced toxicity, improved bioavailability, etc.). One or more constructs that express proteins with improved properties may be assayed clinically. Cell lines may be established including constructs having one or more silent mutations and expressing one or more polypeptides (e.g., therapeutic polypeptides) of interest. Non-limiting examples of bacterial hosts include E. coli and B. subtilis. Non-limiting examples of yeast hosts include S. cerevisiae and P. pastoris. Non-limiting examples of mammalian hosts include CHO cells. These hosts may be used for any library of the invention described herein including, for example, silent mutation libraries and/or other types of libraries.

Accordingly, non-limiting examples of protein functionalities that are encoded by silent mutation protein libraries are bio-availability, clearing properties, resistance towards proteases, lower toxicity, increased toxicity. Libraries of proteins involved in drug metabolism and drug clearance are also embraced by the invention, including but not limited to, proton pumps, drug pumps, drug transport proteins and drug metabolizing proteins.

It should be appreciated that different host organisms have different distributions of tRNAs and tRNA synthetases. The frequency of a particular codon triplet utilized in a genome is at least in part species-specific. For example in baker's yeast, Saccharomyces cerevisiae, a triplet may appear as frequently as 45.6 times per thousand (in case of “gaa”) and as seldom as less than 1 time per thousand (0.5 for “uag” and 0.7 for “uga”). Because translation efficiency, local peptide folding and overall expression efficacy may be affected by the availability of particular tRNAs in a host, selection of optimal codons may also be host-dependent.

Accordingly, a silent rare codon library and/or analysis may be host specific. In some embodiments, a single library of different silent codon variants may be tested in different host species with different natural codon biases to ascertain the relative importance of protein-specific rules (e.g. secondary structure) and host-specific rules (like tRNA availability). Information about rare codon distributions in different species is known in the art and may be found for example at http://www.kazusa.or.jp/codon/readme_codon.html and in Nakamura, Y., Gojobori, T. and Ikemura, T. (2000) Nucl. Acids Res. 28, 292.

Aspects of the invention relate to identifying patients or groups of patients (e.g., patient cohorts) that have one or more silent mutations associated with a condition. A condition may be a disease, a predisposition to a disease, an adverse reaction to a drug or group of related drugs, a responsiveness to a drug or a group of drugs. Accordingly, aspects of the invention relate to assaying a patient (e.g., a patient sample) for the presence of one or more silent mutations of interest and recommending or determining a therapeutic course of action based on the presence of the one or more silent mutations. A course of action may be based on the predicted progression of the disease or the predicted responsiveness of the patient based on the silent mutation. The course of action may be a surgical recommendation (e.g., to have surgery or delay surgery, etc.). The course of action may be a drug recommendation, and/or a recommendation for drug dosage and/or frequency and/or mode of administration (e.g., based on a predicted responsiveness or predicted adverse reaction). Accordingly, aspects of the invention relate to human diagnostic (e.g., human cohort diagnostics) and human therapeutics (e.g., human cohort therapeutics). Aspects of the invention also relate to identifying silent mutations that are associated with one or more conditions of interest and that may be used in diagnostic or therapeutic applications of the invention. In some embodiments, a library of silent variant may be tested for a protein of interest and those silent variants that are associated with a phenotype of interest may be used as markers in the screening of patients. If a patient has one or more of the identified silent variants, the patient may be identified as having or being at risk of a condition. In some embodiments, a library may be assembled to represent silent mutations that are identified in a patient population, and a correlation between patient risk profiles (and/or drug responsiveness and/or drug toxicity profiles) and functional and or structural differences between the polypeptides expressed from the different silent mutation variants may be established and used for subsequent diagnostic and/or therapeutic purposes.

In Silico Filtering

Aspects of the invention relate to methods for designing and assembling nucleic acid libraries containing a plurality of predetermined nucleic acid sequences. In some embodiments, the invention provides methods for designing and assembling libraries that express a plurality of polypeptides containing predetermined amino acid sequence variants. Aspects of the invention include methods for designing and assembling polypeptide expression libraries that are enriched for polypeptide sequence variants having one or more desirable traits. Aspects of the invention provide methods for filtering nucleic acid sequences to exclude those that express polypeptides having one or more unwanted traits (e.g., poor solubility, immunogenicity, instability, etc., or any combination thereof).

Aspects of the invention also provide methods for assembling an expression library that is representative of predetermined sequences of interest. Accordingly, aspects of the invention also provide expression libraries (e.g., filtered expression libraries), methods of using expression libraries to identify polypeptides having functional or structural properties of interest, and isolated polypeptides and nucleic acids encoding them.

Aspects of the invention are useful for generating pools of different polypeptides containing predetermined amino acid sequence variations. Certain aspects of the invention are useful for generating pools of candidate polypeptides that exclude variants having unwanted biophysical and biological traits. By excluding unwanted traits, a library of the invention may include a higher proportion of potentially useful polypeptide variants. As a result, a candidate polypeptide identified in a screen or selection may be more likely to have appropriate in vivo traits in addition to a functional or structural property of interest.

According to aspects of the invention, a relatively smaller expression library may be generated when unwanted polypeptide variants are excluded. For example, the number of clones required to represent all variants in a library will be smaller if the library is designed to exclude a subset of possible variants that are predicted to have unwanted traits. As a result, a relatively smaller library may be used to screen or select for a function or structure of interest when a subset of sequences is excluded from the library. Alternatively, a library of a predetermined size may be used to represent a higher number of potentially interesting polypeptide variants when unwanted variants are excluded. Accordingly, by excluding amino acid sequences that are predicted to have one or more unwanted traits, aspects of the invention may be useful to generate libraries that represent i) a higher number of potentially useful amino acid substitutions at a predetermined number of positions, or ii) potentially useful amino acid substitutions at more positions, or a combination thereof, relative to libraries that are not filtered.

Accordingly, aspects of the invention may involve imposing certain biophysical and/or biological constraints on the identity of the polypeptides that are expressed by a library. This approach can save time and cost in a screen or selection when compared to a typical approach that involves selecting a population of proteins for a required function (e.g., binding or catalytic activity) and subsequently evaluating each selected protein for stability, solubility, and/or ease of production. When a therapeutic protein is developed, immunogenicity often is evaluated last, and often after a large investment of resources in a candidate protein. In contrast, aspects of the invention may involve pre-filtering libraries for stability, solubility, and/or lack of immunogenicity in the early stages of therapeutic development (e.g., during a library design stage). As a consequence, libraries entering selection may be enriched for stable, soluble, and/or non-immunogenic sequences, leading to a lower incidence of selected proteins having properties that are unacceptable for production, storage, and/or therapeutic administration to a patient.

In some embodiments, the invention may include methods of analyzing and/or filtering sequences that are predicted or known to confer one or more unwanted traits. In some embodiments, the invention may include methods of designing and/or assembling a library of nucleic acids having predetermined sequence differences (e.g., that encode a predetermined pool of polypeptides having predetermined amino acid changes at predetermined positions). In some embodiments, the identity of different polypeptides that are expressed by a library may be predetermined by analyzing possible amino acid sequence variants and excluding those that are predicted or known to confer one or more unwanted traits.

According to aspects of the invention, a library containing a large number of different nucleic acids having defined sequences may be assembled using any suitable in vitro and/or in vivo nucleic acid assembly procedure that allows a plurality of specific sequences to be assembled while excluding other specific sequences. According to aspects of the invention, a library may be assembled in a process that involves assembling a plurality of nucleic acids (e.g., polynucleotides, oligonucleotides, etc.) to form a longer nucleic acid product. A library may contain nucleic acids that include identical (non-variant) regions and regions of sequence variation. Accordingly, certain nucleic acids being assembled may correspond to the non-variant sequence regions. Other nucleic acids being assembled may correspond to one of several predetermined sequence variants in a predetermined region of sequence variation.

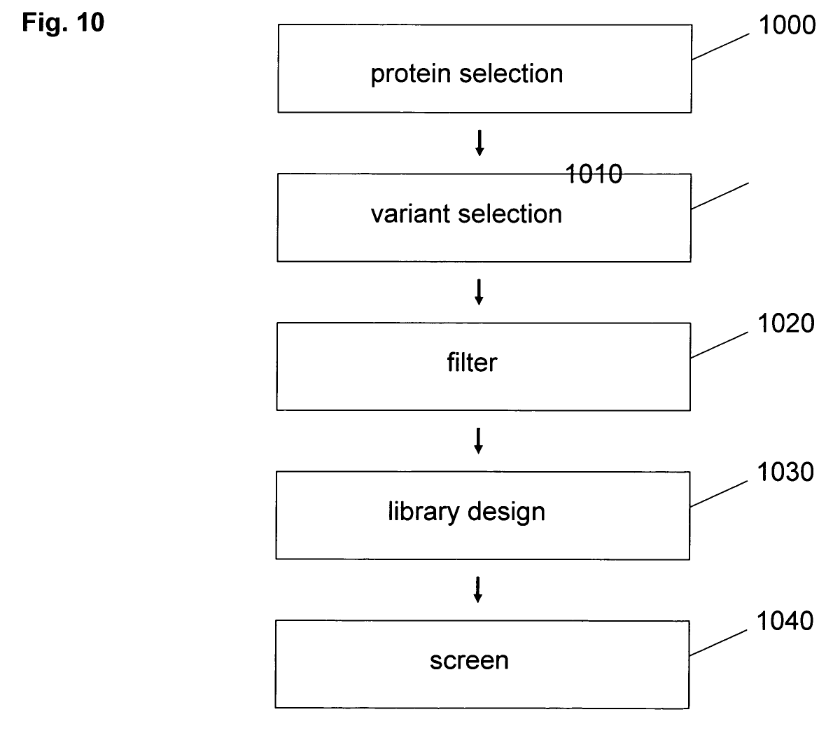

FIG. 10 illustrates one aspect of a process of designing a library that expresses polypeptide variants having predetermined thresholds for one or more biophysical and/or biological traits. Initially, in act 1000, a protein that may be used as a scaffold for the library is selected. In act 1010, positions at which amino acids may be changed are determined. In some embodiments, a corresponding list of all potential amino acid sequence variants may be identified. This list may be referred to as a theoretical library of polypeptide sequences that can be analyzed and filtered to exclude unwanted sequences in act 1020. In act 1030, a library is designed and assembled to express all of the filtered polypeptide sequence variants or a fraction thereof. In act 1040, a screen, selection, or other analysis is performed to identify one or more polypeptides in the library that have one or more structural or functional properties of interest. It should be appreciated that one or more of these acts may be omitted in certain embodiments of the invention. It also should be appreciated that one or more of these acts may be automated (e.g., computer-implemented).

In act 1000, a polypeptide scaffold is selected. A library may be designed to express any type of polypeptide (e.g., linear polypeptides, constrained polypeptides, and variants thereof). A polypeptide scaffold may be based on, but is not limited to, one of the following peptides: cysteine-rich small proteins (e.g., toxins, extracellular domains of receptor proteins, A-domains, etc.), Zinc fingers, immunoglobulin-like domains (including, for example, the tenth human fibronectin type III domain and other fibronectin type III domains), lipocalins, lectin domains (including, for example, C-type lectin domain), ankyrins, human serum proteins (including, for example, human serum albumin), antibodies and antibody fragments (including, for example, single-chain antibodies, Fab fragments, single-domain (VH or VL) antibodies, camel antibody domains, humanized camel antibody domains), enzymes (including, for example, glucose isomerase, cellulase, hemicellulase, glucoamylase, alpha amylase, subtilisin, lipases, dehydrogenases, etc.), DNA-binding proteins (including, for example, the lac repressor, trp repressor, tet repressor, CAP activator, etc.), cytokines (including, for example, IL-1, IL-4, IL-8, etc.), hormones (including, for example, insulin, growth hormone, etc.), other suitable proteins, or combinations thereof.

General features that are useful for a scaffold polypeptide to have may include one or more of the following non-limiting features: a known structure; high stability and solubility; low immunogenicity; ease of expression in microbial system and ease of purification; a combination of residues that provide a well-defined, stable folded structure, and residues that can be mutated or randomized without destroying the overall fold (such ‘randomizable’ residues may be solvent-exposed or may not be involved in secondary structure or may not pack against other residues in the structure—when comparing sequences of homologous proteins, there is more variation between residues between residues in ‘randomizable’ positions than between residues critical for structure); positions/residues that are known to be associated with a particular structural motif, these could be conserved residues or residues that have been identified by structural analysis or mutagenesis to be important for preserving a structural scaffold; a scaffold of a protein that performs a function related to the desired function; independently folded domains of multi-domain proteins; and/or a monomeric state (associates with no other proteins, or only minimal number of other proteins that will either not be present during application or that are important for the function that is being engineered).

However, in some embodiments, a library may be designed to express random polypeptides that are not based on any defined structural scaffold.

In act 1010, residues that may be changed in the library may be identified.

General features that may be used for selecting one or more residues to be varied in the library may include one or more of the following non-limiting features: residues in a binding domain (for example a receptor binding domain, a ligand binding domain or a substrate binding domain), in particular residues in contact with, or adjacent to a bound ligand; residues in a catalytic domain, in particular residues in, or immediately adjacent to, an active site; adjacent residues, for example residues that on the surface of a protein that may be modified to make an artificial antibody; surface residues; buried residues, for example proteins can be stabilized by re-engineering their core; residues that are thought to, or known to, tolerate changes without affecting the structure of the scaffold; residues that vary between homologous proteins; and/or residues that have been shown to affect function.

If there is a long list of residues that can be changed, a hierarchy to select the preferred subset to be altered may be established. The hierarchy depends on the application. One potential hierarchy is the following:

1) avoid destabilization of the protein;

2) for therapeutic proteins, minimize the number of residues to be randomized in order to minimize the risk of immunogenicity;

3) provide a large enough variability in the shape of a possible target-binding surface or in the chemistry of a catalytic active site to maximize the chance of selecting a variant with new function;

4) limit the number of randomized positions to positions that may affect each other; aim to sample every possible permutation of residue on those positions; and

5) limit the number and nature of replacements at each position based on their predicted effect on the function.

Once positions to be varied are identified, a theoretical library may be determined that includes all combinations of possible amino acid variants at those positions. In some embodiments, all natural amino acid variants are considered (e.g., the 20 amino acids that are present in most natural proteins or polypeptides). In some embodiments, non-natural amino acids also may be considered.

In act 1020, the theoretical library may be filtered to identify and/or exclude sequence variants that are known or expected to confer one or more unwanted traits. One or more filtering steps may be implemented to identify and/or exclude one or more different traits that may be unwanted. Filtering may be based on predicted properties of amino acid sequences, known properties of amino acid sequences, or combinations thereof. It should be appreciated that the trait(s) selected to be excluded may depend on the application that is being screened for. For example different types of predictions may be relevant to different applications. In some embodiments, library filtering based on predicted immunogenicity would be irrelevant if the library is to be screened for better industrial enzymes. In some embodiments, the largest number of filters that are relevant for a particular application may be incorporated in filtering act 1020.

Filter parameters that may be useful to select sequence variants that are known or expected to confer one or more unwanted traits may include one or more of the following non-limiting parameters: a) immunogenicity (T-cell epitopes may be removed—algorithms for predicting T-cell epitopes may be used—other known or predicted epitopes also may be removed—non-limiting examples for reducing the immunogenicity of a protein are reported in US Patent Publications US20060025573 and US20040082039, the disclosures of which are hereby incorporated by reference); b) other immunogenicity-related properties, including aggregation, binding to receptors on antigen-presenting cells, proteosome cleavage, transport of cleavage product by TAP, the transporter associated with antigen processing; c) other factors that determine immunogenicity including factors reported in US Patent Publications US20040203100, US20060073563, US 20060014248, US20050079183 and US20050214857; U.S. Pat. No. 6,929,939 and WO2003104803, the disclosures of which are hereby incorporated by reference; d) solubility; for instance including calculating the predicted pI of a sequence and excluding the sequence if the pI is within 0.5 pH units, within 1 pH unit, within 2 pH units, within 3 pH units, within 4 pH units, or within 5 pH units, of the pH at which the polypeptide may be expressed, purified, stored and/or used; e) stability; for instance including structure based methods, molecular modeling methods and other computer based methods (see e.g. US Patent Publications US20060073563 and US20060014248); f) the presence of sequences that are undesirable, for instance including protease sensitive sequences, toxic sequences and sequences that are known to interact with unwanted targets; g) the exclusion of Cys residues that are not close enough to form disulfide bonds in a folded structure based on the known structure of the scaffold; h) the exclusion of excessive numbers of Trp residues, in some embodiments 2, 3, 4, or more Trp residues can be excluded; and i) the exclusion of chemically active sequences of amino acids, for instance asparagine and glutamine deamidate more readily when followed by a glycine.

Accordingly, a final library of filtered peptide products to be synthesized may be determined. It should be appreciated that different filtering parameters may be varied in order to increase or decrease the stringency of the filtering process.

In some embodiments, a filtering process may proceed according to the following steps. First, a list of more than 1000 related protein sequences may be generated based on available information of a scaffold structure and function. Second, each sequence may be subjected to an automatic calculation to evaluate the property of choice; sequences with values below the cutoff will be eliminated from the list. This step may be repeated for each property under examination. Third, selected protein sequences may be reverse-transcribed into DNA sequences. Each DNA sequence may be optimized for codon usage, secondary structure formation, presence of restriction sites, etc., without changing the protein sequence. Optimized DNA sequences on the list then may be assembled using any appropriate assembly method.

To validate the improvement of properties due to a pre-filtering strategy, parallel DNA libraries may be generated initially with and without the theoretical pre-filtering step. Randomly selected members of pre-filtered and unfiltered libraries may then be translated into protein and tested for the property under investigation. In addition, in-vitro selections may be performed under identical conditions for pre-filtered and unfiltered libraries, and the properties of the selected proteins from each may be compared.

In some embodiments, libraries may be filtered for high solubility. For example, a simple method of predicting protein solubility based on its sequence is through the calculation of its isoelectric point (pI), the pH where the protein has no net charge. Numerous well-established algorithms are available for calculating the pH of a given sequence (e.g., http://www.scripps.edu/˜cdputnam/protcalc.html, http://www.embl-heidelberg.de/cgi/pi-wrapper.pl). In some embodiments, a protein is predicted to be soluble if its pH is significantly higher or lower than the pH (e.g., by 0.5 pH units or more) of the buffer employed to purify and/or use the protein.

Other possible measures of solubility include overall hydrophobicity of the protein, which can be either the proportion of amino-acid residues in the protein that are apolar, or the proportion of residues predicted to be accessible to the solvent that are apolar. Alternatively, only the number of tryptophan residues can be limited, or cysteine residues can be prohibited from randomized positions.

In some embodiments, representative members of libraries and selected proteins can be evaluated for solubility by comparing their expression level, the concentration beyond which they aggregate, or the proportion of protein sample at a set concentration that aggregates when incubated at a set temperature.

In some embodiments, libraries may be filtered for low immunogenicity. The immunogenicity of a protein can be predicted computationally by breaking down the protein into a series of overlapping peptides, then evaluating the fit of each resulting peptide to the peptide-binding site of an MHC type II molecule (Chirino et al, Drug Discovery Today (2004), 83; e.g., Jones et al (2004), J. Interferon Cytokine Res. 24, 560). In certain embodiments, peptide sequences can be compared to databases of peptide sequences known to bind such MHC II molecules, or known to stimulate T-cells (Novozymes).

Representative members of libraries and selected proteins can be evaluated for immunogenicity by expressing and purifying each protein in a microbial system, then testing their ability to stimulate T-cells from diverse human donors. Individual peptides that make up the protein or pools of such peptides can also be tested for their ability to stimulate T-cells. In some embodiments, proteins can be evaluated by injecting them into transgenic mice that express the human version of the scaffold the proteins are based on.

In some embodiments, libraries may be filtered for high stability. In some embodiments, in order to predict the stability of each protein, its three-dimensional structure can be simulated computationally and evaluated for favorable and unfavorable interactions (Chirino et al, Drug Discovery Today (2004), 83; e.g., Luo et al (2002) Protein Sci. 11, 1218). In certain embodiments, the simulated structure could be compared to the known structure of the scaffold it is based on, or to known structures of proteins that are homologous to the scaffold. In some embodiments, structures that are more similar to existing protein structures are predicted to be more stable. In some embodiments, the effect of a mutation on scaffold stability can be studied experimentally before embarking on library construction. For example, each position in the scaffold can be separately mutated to all possible amino acids (or subsets thereof), and the resulting mutant proteins can be expressed and evaluated for stability, solubility, or both. Libraries based on that scaffold can then be designed to avoid mutations that have been shown to destabilize the scaffold.

Representative members of libraries and selected proteins can be evaluated for stability by comparing their expression level, melting temperature, concentration of urea or guanidine required to denature them, or the proportion of each protein sample at a set concentration that aggregates when incubated at an elevated temperature.

In act 1030, a library of filtered sequences may be obtained (e.g., assembled as described herein). The library may be cloned into any suitable vector (e.g., any suitable expression vector) in any suitable organism. Any suitable vector may be used, as the invention is not so limited. For example, a vector may be a plasmid, a bacterial vector, a viral vector, a phage vector, an insect vector, a yeast vector, a mammalian vector, a BAC, a YAC, or any other suitable vector. In some embodiments, a vector may be a vector that replicates in only one type of organism (e.g., bacterial, yeast, insect, mammalian, etc.) or in only one species of organism. Some vectors may have a broad host range. Some vectors may have different functional sequences (e.g., origins or replication, selectable markers, etc.) that are functional in different organisms. These may be used to shuttle the vector (and any nucleic acid fragment(s) that are cloned into the vector) between two different types of organism (e.g., between bacteria and mammals, yeast and mammals, etc.). In some embodiments, the type of vector that is used may be determined by the type of host cell that is chosen.

It should be appreciated that a vector may encode a detectable marker such as a selectable marker (e.g., antibiotic resistance, etc.) so that transformed cells can be selectively grown and the vector can be isolated and any insert can be characterized to determine whether it contains the desired assembled nucleic acid. The insert may be characterized using any suitable technique (e.g., size analysis, restriction fragment analysis, sequencing, etc.). In some embodiments, the presence of a correctly assembly nucleic acid in a vector may be assayed by determining whether a function predicted to be encoded by the correctly assembled nucleic acid is expressed in the host cell.

In some embodiments, host cells that harbor a vector containing a nucleic acid insert may be selected for or enriched by using one or more additional detectable or selectable markers that are only functional if a correct (e.g., designed) terminal nucleic acid fragments is cloned into the vector.

Accordingly, a host cell should have an appropriate phenotype to allow selection for one or more drug resistance markers encoded on a vector (or to allow detection of one or more detectable markers encoded on a vector). However, any suitable host cell type may be used (e.g., prokaryotic, eukaryotic, bacterial, yeast, insect, mammalian, etc.). In some embodiments, the type of host cell may be determined by the type of vector that is chosen. A host cell may be modified to have increased activity of one or more ligation and/or recombination functions. In some embodiments, a host cell may be selected on the basis of a high ligation and/or recombination activity. In some embodiments, a host cell may be modified to express (e.g., from the genome or a plasmid expression system) one or more ligase and/or recombinase enzymes.

In act 1040, proteins expressed by the filtered library may be screened or selected for one or more functions or structures of interest. It should be appreciated that expression libraries of the invention may be nucleic-acid/polypeptide libraries in which each nucleic acid molecule is physically associated with the polypeptide it encodes. In some embodiments, an expression library may be a screening library. An example of a screening library may be one where the physical association between the nucleic acid and the encoded polypeptide is provided by a well (e.g., in a 96-well plate). In some embodiments, an expression library may be a display library. Examples of display libraries include those generated by phage, bacterial, yeast, mRNA, or ribosome display, where each nucleic acid and corresponding polypeptide are part of the same physical particle (e.g., a bacteriophage, a bacterium, a yeast cell, covalent mRNA-polypeptide fusion, or non-covalent mRNA/ribosome/polypeptide complex).

Aspects of the invention may be used in conjunction with any suitable multiplex nucleic acid assembly procedure (e.g., any multiplex nucleic acid assembly procedure involving at least two nucleic acids with complementary regions (e.g., at least one pair of nucleic acids that have complementary 3′ regions). Aspects of the invention may be used in conjunction with in vitro and/or in vivo nucleic acid assembly procedures. Non-limiting examples of extension-based and ligation-based assembly reactions are described herein and known in the art.

In some embodiments, a recombinase (e.g., RecA) or nucleic acid binding protein may be used to increase the fidelity of one or more assembly reactions. In some embodiments, a heat stable RecA protein may be included in one or more reagents or steps of a multiplex nucleic acid assembly reaction. A heat stable RecA protein is disclosed, for example, in Shigemori et al., 2005, Nucleic Acids Research, Vol. 33, No. 14, e126. Heat stable RecA proteins may be from one or more thermophilic organisms (e.g., Thermus thermophilus or other thermophilic organisms). Heat stable RecA proteins also may be isolated as sequence variants of one or more heat sensitive RecA proteins.

Aspects of the invention may include automating one or more acts described herein. For example, an analysis may be automated in order to generate an output automatically. Acts of the invention may be automated using, for example, a computer system.

Synthetic Oligonucleotides

Oligonucleotides (e.g., having a predetermined sequence) may be synthesized using any suitable technique. Oligonucleotides may be isolated from a natural source or purchased from commercial sources (Integrated DNA Technologies, Illumina, Agilent, Affymetrix, Combimatrix, etc.). For example, oligonucleotides may be synthesized on a column or other support (e.g., a chip). Examples of chip-based synthesis techniques include techniques used in synthesis devices or methods available from Combimatrix, Agilent, Affymetrix, or other sources. A synthetic oligonucleotide may be of any suitable size, for example between 10 and 1,000 nucleotides long (e.g., between 10 and 200, 200 and 500, 500 and 1,000 nucleotides long, or any combination thereof). An assembly reaction may include a plurality of oligonucleotides, each of which independently may be between 10 and 200 nucleotides in length (e.g., between 20 and 150, between 30 and 100, 30 to 90, 30-80, 30-70, 30-60, 35-55, 40-50, or any intermediate number of nucleotides). However, one or more shorter or longer oligonucleotides may be used in certain embodiments.

Preferably, oligonucleotides are synthesized using methods that permit high-throughput, parallel synthesis so as to reduce the cost and production time and increase the flexibility. In an exemplary embodiment, the oligonucleotides are synthesized on a solid support array format. Examples of methods for synthesizing oligonucleotides include for example, light directed methods, methods utilizing masks, flow channel methods, maskless methods, spotting methods, pin-based methods, and methods utilizing multiple supports. Exemplary solid supports include, for example, slides, beads, chips, particles, strands, rods, gels, sheets, tubing, spheres, capillaries, pads, slices, films or plates. In one embodiment, an oligonucleotides synthesized on a solid support may be used as a template for the production of oligonucleotides for assembly into longer polynucleotides. In some other embodiments, the oligonucleotides are released from the solid support prior to assembly into longer polynucleotides. The oligonucleotides may be removed from the solid support by exposure to conditions such as acid, base, oxidation, reduction, heat, light, metal ion catalysis, displacement or elimination chemistry or by enzymatic cleavage. In some embodiments, oligonucleotides may be attached to a solid support by its 5′ or 3′ end through a cleavable linkage moiety (see for example, U.S. Patent Applications 5,739,386; 5,700,642 and 5,830,655). The cleavable moiety may be removed under conditions that do not degrade oligonucleotides.

Oligonucleotides may be provided as single stranded synthetic products. However, in some embodiments, oligonucleotides may be provided as double-stranded preparations including an annealed complementary strand. Oligonucleotides may be molecules of DNA, RNA, PNA, or any combination thereof. A double-stranded oligonucleotide may be produced by amplifying a single-stranded synthetic oligonucleotide or other suitable template (e.g., a sequence in a nucleic acid preparation such as a nucleic acid vector or genomic nucleic acid). Accordingly, a plurality of oligonucleotides designed to have the sequence features described herein may be provided as a plurality of single-stranded oligonucleotides having those feature, or also may be provided along with complementary oligonucleotides.

In some embodiments, an oligonucleotide may be amplified using an appropriate primer pair with one primer corresponding to each end of the oligonucleotide (e.g., one that is complementary to the 3′ end of the oligonucleotide and one that is identical to the 5′ end of the oligonucleotide). In some embodiments, an oligonucleotide may be designed to contain a central assembly sequence (designed to be incorporated into the target nucleic acid) flanked by a 5′ amplification sequence (e.g., a 5′ universal sequence) and a 3′ amplification sequence (e.g., a 3′ universal sequence). Amplification primers (e.g., between 10 and 50 nucleotides long, between 15 and 45 nucleotides long, about 25 nucleotides long, etc.) corresponding to the flanking amplification sequences may be used to amplify the oligonucleotide (e.g., one primer may be complementary to the 3′ amplification sequence and one primer may have the same sequence as the 5′ amplification sequence). The amplification sequences then may be removed from the amplified oligonucleotide using any suitable technique to produce an oligonucleotide that contains only the assembly sequence.

In some embodiments, a plurality of different oligonucleotides (e.g., about 5, 10, 50, 100, or more) with different central assembly sequences may have identical 5′ amplification sequences and identical 3′ amplification sequences. These oligonucleotides can all be amplified in the same reaction using the same amplification primers.

A preparation of an oligonucleotide designed to have a certain sequence may include oligonucleotide molecules having the designed sequence in addition to oligonucleotide molecules that contain errors (e.g., that differ from the designed sequence at least at one position). A sequence error may include one or more nucleotide deletions, additions, substitutions (e.g., transversion or transition), inversions, duplications, or any combination of two or more thereof. Oligonucleotide errors may be generated during oligonucleotide synthesis. Different synthetic techniques may be prone to different error profiles and frequencies. In some embodiments, error rates may vary from 1/10 to 1/200 errors per base depending on the synthesis protocol that is used. However, in some embodiments lower error rates may be achieved. Also, the types of errors may depend on the synthetic techniques that are used. For example, in some embodiments chip-based oligonucleotide synthesis may result in relatively more deletions than column-based synthetic techniques.

In some embodiments, one or more oligonucleotide preparations may be processed to remove (or reduce the frequency of) error-containing oligonucleotides. In some embodiments, a hybridization technique may be used wherein an oligonucleotide preparation is hybridized under stringent conditions one or more times to an immobilized oligonucleotide preparation designed to have a complementary sequence. Oligonucleotides that do not bind may be removed in order to selectively or specifically remove oligonucleotides that contain errors that would destabilize hybridization under the conditions used. It should be appreciated that this processing may not remove all error-containing oligonucleotides since many have only one or two sequence errors and may still bind to the immobilized oligonucleotides with sufficient affinity for a fraction of them to remain bound through this selection processing procedure.

In some embodiments of the invention, a sliding clamp technique may be used for enriching error-free oligonucleotides after hybridization of oligonucleotides that are designed to be complementary, provided that the ends are “blocked” to inhibit dissociation of the clamped form of MutS from any heteroduplexes that are present.

In some embodiments, a nucleic acid binding protein or recombinase (e.g., RecA) may be included in one or more of the oligonucleotide processing steps to improve the selection of error free oligonucleotides. For example, by preferentially promoting the hybridization of oligonucleotides that are completely complementary with the immobilized oligonucleotides, the amount of error containing oligonucleotides that are bound may be reduced. As a result, this oligonucleotide processing procedure may remove more error-containing oligonucleotides and generate an oligonucleotide preparation that has a lower error frequency (e.g., with an error rate of less than 1/50, less than 1/100, less than 1/200, less than 1/300, less than 1/400, less than 1/500, less than 1/1,000, or less than 1/2,000 errors per base.

A plurality of oligonucleotides used in an assembly reaction may contain preparations of synthetic oligonucleotides, single-stranded oligonucleotides, double-stranded oligonucleotides, amplification products, oligonucleotides that are processed to remove (or reduce the frequency of) error-containing variants, etc., or any combination of two or more thereof.

In some aspects, synthetic oligonucleotides synthesized on an array (e.g., a chip) are not amplified prior to assembly. In some embodiments, a polymerase-based or ligase-based assembly using non-amplified oligonucleotides may be performed in a microfluidic device. Oligonucleotides synthesized on an array may be cleaved and added to any suitable assembly reaction without amplification. These oligonucleotides can be synthesized without a 5′ and/or 3′ amplification sequence (e.g., without one or more sequences that correspond to a universal primer sequence). Accordingly, these oligonucleotides can be used directly in an assembly reaction without removing one or more flanking amplification sequences. In some embodiments, about 3, 4, 5, 6, 7, 8, 9, 10, or more non-amplified oligonucleotides can be assembled (if they have appropriate overlapping regions as described herein) in a single reaction. The assembled nucleic acid then may be amplified using 5′ and 3′ primers. In some embodiments, the 5′ and 3′ primers correspond to target nucleic acid sequences at the 5′ and 3′ end of the assembled nucleic acid. However, in some embodiments, each of the 5′ most and 3′-most oligonucleotides that were used in the assembly reaction contain a flanking universal primer sequence that can be used to amplify the assembled nucleic acid.

In some aspects, a synthetic oligonucleotide may be amplified prior to use. Either strand of a double-stranded amplification product may be used as an assembly oligonucleotide and added to an assembly reaction as described herein. A synthetic oligonucleotide may be amplified using a pair of amplification primers (e.g., a first primer that hybridizes to the 3′ region of the oligonucleotide and a second primer that hybridizes to the 3′ region of the complement of the oligonucleotide). The oligonucleotide may be synthesized on a support such as a chip (e.g., using an ink-jet-based synthesis technology). In some embodiments, the oligonucleotide may be amplified while it is still attached to the support. In some embodiments, the oligonucleotide may be removed or cleaved from the support prior to amplification. The two strands of a double-stranded amplification product may be separated and isolated using any suitable technique. In some embodiments, the two strands may be differentially labeled (e.g., using one or more different molecular weight, affinity, fluorescent, electrostatic, magnetic, and/or other suitable tags). The different labels may be used to purify and/or isolate one or both strands. In some embodiments, biotin may be used as a purification tag. In some embodiments, the strand that is to be used for assembly may be directly purified (e.g., using an affinity or other suitable tag). In some embodiments, the complementary strand is removed (e.g., using an affinity or other suitable tag) and the remaining strand is used for assembly.

In some embodiments, a synthetic oligonucleotide may include a central assembly sequence flanked by 5′ and 3′ amplification sequences. The central assembly sequence is designed for incorporation into an assembled nucleic acid. The flanking sequences are designed for amplification and are not intended to be incorporated into the assembled nucleic acid. The flanking amplification sequences may be used as universal primer sequences to amplify a plurality of different assembly oligonucleotides that share the same amplification sequences but have different central assembly sequences. In some embodiments, the flanking sequences are removed after amplification to produce an oligonucleotide that contains only the assembly sequence.

In some embodiments, one of the two amplification primers may be biotinylated. The nucleic acid strand that incorporates this biotinylated primer during amplification can be affinity purified using streptavidin (e.g., bound to a bead, column, or other surface). In some embodiments, the amplification primers also may be designed to include certain sequence features that can be used to remove the primer regions after amplification in order to produce a single-stranded assembly oligonucleotide that includes the assembly sequence without the flanking amplification sequences.

In some embodiments, the non-biotinylated strand may be used for assembly. The assembly oligonucleotide may be purified by removing the biotinylated complementary strand. In some embodiments, the amplification sequences may be removed if the non-biotinylated primer includes a dU at its 3′ end, and if the amplification sequence recognized by (i.e., complementary to) the biotinylated primer includes at most three of the four nucleotides and the fourth nucleotide is present in the assembly sequence at (or adjacent to) the junction between the amplification sequence and the assembly sequence. After amplification, the double-stranded product is incubated with T4 DNA polymerase (or other polymerase having a suitable editing activity) in the presence of the fourth nucleotide (without any of the nucleotides that are present in the amplification sequence recognized by the biotinylated primer) under appropriate reaction conditions. Under these conditions, the 3′ nucleotides are progressively removed through to the nucleotide that is not present in the amplification sequence (referred to as the fourth nucleotide above). As a result, the amplification sequence that is recognized by the biotinylated primer is removed. The biotinylated strand is then removed. The remaining non-biotinylated strand is then treated with uracil-DNA glycosylase (UDG) to remove the non-biotinylated primer sequence. This technique generates a single-stranded assembly oligonucleotide without the flanking amplification sequences. It should be appreciated that this technique may be used to process a single amplified oligonucleotide preparation or a plurality of different amplified oligonucleotides in a single reaction if they share the same amplification sequence features described above.

In some embodiments, the biotinylated strand may be used for assembly. The assembly oligonucleotide may be obtained directly by isolating the biotinylated strand. In some embodiments, the amplification sequences may be removed if the biotinylated primer includes a dU at its 3′ end, and if the amplification sequence recognized by (i.e., complementary to) the non-biotinylated primer includes at most three of the four nucleotides and the fourth nucleotide is present in the assembly sequence at (or adjacent to) the junction between the amplification sequence and the assembly sequence. After amplification, the double-stranded product is incubated with T4 DNA polymerase (or other polymerase having a suitable editing activity) in the presence of the fourth nucleotide (without any of the nucleotides that are present in the amplification sequence recognized by the non-biotinylated primer) under appropriate reaction conditions. Under these conditions, the 3′ nucleotides are progressively removed through to the nucleotide that is not present in the amplification sequence (referred to as the fourth nucleotide above). As a result, the amplification sequence that is recognized by the non-biotinylated primer is removed. The biotinylated strand is then isolated (and the non-biotinylated strand is removed). The isolated biotinylated strand is then treated with UDG to remove the biotinylated primer sequence. This technique generates a single-stranded assembly oligonucleotide without the flanking amplification sequences. It should be appreciated that this technique may be used to process a single amplified oligonucleotide preparation or a plurality of different amplified oligonucleotides in a single reaction if they share the same amplification sequence features described above.

It should be appreciated that the biotinylated primer may be designed to anneal to either the synthetic oligonucleotide or to its complement for the amplification and purification reactions described above. Similarly, the non-biotinylated primer may be designed to anneal to either strand provided it anneals to the strand that is complementary to the strand recognized by the biotinylated primer.

In certain embodiments, it may be helpful to include one or more modified oligonucleotides in an assembly reaction. An oligonucleotide may be modified by incorporating a modified-base (e.g., a nucleotide analog) during synthesis, by modifying the oligonucleotide after synthesis, or any combination thereof. Examples of modifications include, but are not limited to, one or more of the following: universal bases such as nitroindoles, dP and dK, inosine, uracil; halogenated bases such as BrdU; fluorescent labeled bases; non-radioactive labels such as biotin (as a derivative of dT) and digoxigenin (DIG); 2,4-Dinitrophenyl (DNP); radioactive nucleotides; post-coupling modification such as dR-NH₂ (deoxyribose-NH₂); Acridine (6-chloro-2-methoxiacridine); and spacer phosphoramides which are used during synthesis to add a spacer ‘arm’ into the sequence, such as C3, C8 (octanediol), C9, C12, HEG (hexaethlene glycol) and C18.

Applications

Aspects of the invention may be useful for a range of applications involving the production and/or use of synthetic nucleic acid libraries. As described herein, the invention provides methods for producing synthetic nucleic acid libraries with increased fidelity and/or for reducing the cost and/or time of synthetic assembly reactions. The resulting assembled nucleic acids may be amplified in vitro (e.g., using PCR, LCR, or any suitable amplification technique), amplified in vivo (e.g., via cloning into a suitable vector), isolated and/or purified. An assembled nucleic acid library (alone or cloned into a vector) may be transformed into a host cell (e.g., a prokaryotic, eukaryotic, insect, mammalian, or other host cell). In some embodiments, the host cell may be used to propagate the nucleic acid. In certain embodiments, individual nucleic acids may be integrated into the genome of the host cell. In some embodiments, the nucleic acid may replace a corresponding nucleic acid region on the genome of the cell (e.g., via homologous recombination). Accordingly, nucleic acid libraries may be used to produce recombinant organisms. In some embodiments, a nucleic acid library may include entire genomes or large fragments of a genome that are used to replace all or part of the genome of a host organism. Recombinant organisms also may be used for a variety of research, industrial, agricultural, and/or medical applications.

Many of the techniques described herein can be used together, applying enrichment steps at one or more points to produce libraries containing long nucleic acid molecules having defined predetermined sequences. Correct sequence enrichment techniques of the invention can be applied to double-stranded nucleic acids of any size. For example, enrichment techniques using sliding clamp configurations of mismatch binding proteins may be used with oligonucleotide duplexes, nucleic acid fragments of less than 100 to more than 10,000 base pairs in length (e.g., 100 mers to 500 mers, 500 mers to 1,000 mers, 1,000 mers to 5,000 mers, 5,000 mers to 10,000 mers, etc.). In some embodiments, methods described herein may be used during the assembly of large nucleic acid molecules (for example, larger than 5,000 nucleotides in length, e.g., longer than about 10,000, longer than about 25,000, longer than about 50,000, longer than about 75,000, longer than about 100,000 nucleotides, etc.). In an exemplary embodiment, methods described herein may be used during the assembly of an entire genome (or a large fragment thereof, e.g., about 10%, 20%, 30%, 40%, 50%, 60%, 70%, 80%, 90%, or more) of an organism (e.g., of a viral, bacterial, yeast, or other prokaryotic or eukaryotic organism), optionally incorporating specific modifications into the sequence at one or more desired locations.

Any of the nucleic acid products (e.g., including individual nucleic acids and nucleic acid libraries that are amplified, cloned, purified, isolated, etc.) may be packaged in any suitable format (e.g., in a stable buffer, lyophilized, etc.) for storage and/or shipping (e.g., for shipping to a distribution center or to a customer). Similarly, any of the host cells (e.g., cells transformed with a vector or having a modified genome) may be prepared in a suitable buffer for storage and or transport (e.g., for distribution to a customer). In some embodiments, cells may be frozen. However, other stable cell preparations also may be used.

Host cells may be grown and expanded in culture. Host cells may be used for expressing one or more RNAs or polypeptides of interest (e.g., therapeutic, industrial, agricultural, and/or medical proteins). The expressed polypeptides may be natural polypeptides or non-natural polypeptides. The polypeptides may be isolated or purified for subsequent use.

Accordingly, nucleic acid molecules generated using methods of the invention can be incorporated into a vector. The vector may be a cloning vector or an expression vector. In some embodiments, the vector may be a viral vector. A viral vector may comprise nucleic acid sequences capable of infecting target cells. Similarly, in some embodiments, a prokaryotic expression vector operably linked to an appropriate promoter system can be used to transform target cells. In other embodiments, a eukaryotic vector operably linked to an appropriate promoter system can be used to transfect target cells or tissues.

Transcription and/or translation of the constructs described herein may be carried out in vitro (i.e., using cell-free systems) or in vivo (i.e., expressed in cells). In some embodiments, cell lysates may be prepared. In certain embodiments, expressed RNAs or polypeptides may be isolated or purified. Nucleic acids of the invention also may be used to add detection and/or purification tags to expressed polypeptides or fragments thereof. Examples of polypeptide-based fusion/tag include, but are not limited to, hexa-histidine (His⁶) Myc and HA, and other polypeptides with utility, such as GFP, GST, MBP, chitin and the like. In some embodiments, polypeptides may comprise one or more unnatural amino acid residue(s).

In some embodiments, antibodies can be made against polypeptides or fragment(s) thereof encoded by one or more synthetic nucleic acids.

In certain embodiments, synthetic nucleic acids may be provided as libraries for screening in research and development (e.g., to identify potential therapeutic proteins or peptides, to identify potential protein targets for drug development, etc.)

In some embodiments, a synthetic nucleic acid may be used as a therapeutic (e.g., for gene therapy, or for gene regulation). For example, a synthetic nucleic acid may be administered to a patient in an amount sufficient to express a therapeutic amount of a protein. In other embodiments, a synthetic nucleic acid may be administered to a patient in an amount sufficient to regulate (e.g., down-regulate) the expression of a gene.

It should be appreciated that different acts or embodiments described herein may be performed independently and may be performed at different locations in the United States or outside the United States. For example, each of the acts of receiving an order for a target nucleic acid, analyzing a target nucleic acid sequence, designing one or more starting nucleic acids (e.g., oligonucleotides), synthesizing starting nucleic acid(s), purifying starting nucleic acid(s), assembling starting nucleic acid(s), isolating assembled nucleic acid(s), confirming the sequence of assembled nucleic acid(s), manipulating assembled nucleic acid(s) (e.g., amplifying, cloning, inserting into a host genome, etc.), and any other acts or any parts of these acts may be performed independently either at one location or at different sites within the United States or outside the United States. In some embodiments, an assembly procedure may involve a combination of acts that are performed at one site (in the United States or outside the United States) and acts that are performed at one or more remote sites (within the United States or outside the United States).

Automated Applications

Aspects of the invention may include automating one or more acts described herein. For example, a sequence analysis may be automated in order to generate a synthesis strategy automatically. The synthesis strategy may include i) the design of the starting nucleic acids that are to be assembled into the target nucleic acid, ii) the choice of the assembly technique(s) to be used, iii) the number of rounds of assembly and error screening or sequencing steps to include, and/or decisions relating to subsequent processing of an assembled target nucleic acid. Similarly, one or more steps of an assembly reaction may be automated using one or more automated sample handling devices (e.g., one or more automated liquid or fluid handling devices). For example, the synthesis and optional selection of starting nucleic acids (e.g., oligonucleotides) may be automated using a nucleic acid synthesizer and automated procedures. Automated devices and procedures may be used to mix reaction reagents, including one or more of the following: starting nucleic acids, buffers, enzymes (e.g., one or more ligases and/or polymerases), nucleotides, nucleic acid binding proteins or recombinases, salts, and any other suitable agents such as stabilizing agents. Automated devices and procedures also may be used to control the reaction conditions. For example, an automated thermal cycler may be used to control reaction temperatures and any temperature cycles that may be used. Similarly, subsequent purification and analysis of assembled nucleic acid products may be automated. For example, fidelity optimization steps (e.g., a MutS error screening procedure) may be automated using appropriate sample processing devices and associated protocols. Sequencing also may be automated using a sequencing device and automated sequencing protocols. Additional steps (e.g., amplification, cloning, etc.) also may be automated using one or more appropriate devices and related protocols. It should be appreciated that one or more of the device or device components described herein may be combined in a system (e.g. a robotic system). Assembly reaction mixtures (e.g., liquid reaction samples) may be transferred from one component of the system to another using automated devices and procedures (e.g., robotic manipulation and/or transfer of samples and/or sample containers, including automated pipetting devices, etc.). The system and any components thereof may be controlled by a control system.

Accordingly, acts of the invention may be automated using, for example, a computer system (e.g., a computer controlled system). A computer system on which aspects of the invention can be implemented may include a computer for any type of processing (e.g., sequence analysis and/or automated device control as described herein). However, it should be appreciated that certain processing steps may be provided by one or more of the automated devices that are part of the assembly system. In some embodiments, a computer system may include two or more computers. For example, one computer may be coupled, via a network, to a second computer. One computer may perform sequence analysis. The second computer may control one or more of the automated synthesis and assembly devices in the system. In other aspects, additional computers may be included in the network to control one or more of the analysis or processing acts. Each computer may include a memory and processor. The computers can take any form, as the aspects of the present invention are not limited to being implemented on any particular computer platform. Similarly, the network can take any form, including a private network or a public network (e.g., the Internet). Display devices can be associated with one or more of the devices and computers. Alternatively, or in addition, a display device may be located at a remote site and connected for displaying the output of an analysis in accordance with the invention. Connections between the different components of the system may be via wire, wireless transmission, satellite transmission, any other suitable transmission, or any combination of two or more of the above.

In accordance with one embodiment of the present invention for use on a computer system it is contemplated that sequence information (e.g., a target sequence, a processed analysis of the target sequence, etc.) can be obtained and then sent over a public network, such as the Internet, to a remote location to be processed by computer to produce any of the various types of outputs discussed herein (e.g., in connection with oligonucleotide design). However, it should be appreciated that the aspects of the present invention described herein are not limited in that respect, and that numerous other configurations are possible. For example, all of the analysis and processing described herein can alternatively be implemented on a computer that is attached locally to a device, an assembly system, or one or more components of an assembly system. As a further alternative, as opposed to transmitting sequence information (e.g., a target sequence, a processed analysis of the target sequence, etc.) over a communication medium (e.g., the network), the information can be loaded onto a computer readable medium that can then be physically transported to another computer for processing in the manners described herein. In another embodiment, a combination of two or more transmission/delivery techniques may be used. It also should be appreciated that computer implementable programs for performing a sequence analysis or controlling one or more of the devices, systems, or system components described herein also may be transmitted via a network or loaded onto a computer readable medium as described herein. Accordingly, aspects of the invention may involve performing one or more steps within the United States and additional steps outside the United States. In some embodiments, sequence information (e.g., a customer order) may be received at one location (e.g., in one country) and sent to a remote location for processing (e.g., in the same country or in a different country (e.g., for sequence analysis to determine a synthesis strategy and/or design oligonucleotides). In certain embodiments, a portion of the sequence analysis may be performed at one site (e.g., in one country) and another portion at another site (e.g., in the same country or in another country). In some embodiments, different steps in the sequence analysis may be performed at multiple sites (e.g., all in one country or in several different countries). The results of a sequence analysis then may be sent to a further site for synthesis. However, in some embodiments, different synthesis and quality control steps may be performed at more than one site (e.g., within one county or in two or more countries). An assembled nucleic acid then may be shipped to a further site (e.g., either to a central shipping center or directly to a client).

Each of the different aspects, embodiments, or acts of the present invention described herein can be independently automated and implemented in any of numerous ways. For example, each aspect, embodiment, or act can be independently implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs one or more of the above-discussed functions of the present invention. The computer-readable medium can be transportable such that the program stored thereon can be loaded onto any computer system resource to implement one or more functions of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

Accordingly, overall system-level control of the assembly devices or components described herein may be performed by a system controller which may provide control signals to the associated nucleic acid synthesizers, liquid handling devices, thermal cyclers, sequencing devices, associated robotic components, as well as other suitable systems for performing the desired input/output or other control functions. Thus, the system controller along with any device controllers together form a controller that controls the operation of a nucleic acid assembly system. The controller may include a general purpose data processing system, which can be a general purpose computer, or network of general purpose computers, and other associated devices, including communications devices, modems, and/or other circuitry or components necessary to perform the desired input/output or other functions. The controller can also be implemented, at least in part, as a single special purpose integrated circuit (e.g., ASIC) or an array of ASICs, each having a main or central processor section for overall, system-level control, and separate sections dedicated to performing various different specific computations, functions and other processes under the control of the central processor section. The controller can also be implemented using a plurality of separate dedicated programmable integrated or other electronic circuits or devices, e.g., hard wired electronic or logic circuits such as discrete element circuits or programmable logic devices. The controller can also include any other components or devices, such as user input/output devices (monitors, displays, printers, a keyboard, a user pointing device, touch screen, or other user interface, etc.), data storage devices, drive motors, linkages, valve controllers, robotic devices, vacuum and other pumps, pressure sensors, detectors, power supplies, pulse sources, communication devices or other electronic circuitry or components, and so on. The controller also may control operation of other portions of a system, such as automated client order processing, quality control, packaging, shipping, billing, etc., to perform other suitable functions known in the art but not described in detail herein.

Business Applications

Aspects of the invention may be useful to streamline nucleic acid library assembly reactions. Accordingly, aspects of the invention relate to marketing methods, compositions, kits, devices, and systems related to nucleic acid libraries using assembly techniques described herein.

Aspects of the invention may be useful for reducing the time and/or cost of production, commercialization, and/or development of synthetic nucleic acid libraries, and/or related compositions. Accordingly, aspects of the invention relate to business methods that involve collaboratively (e.g., with a partner) or independently marketing one or more methods, kits, compositions, devices, or systems for analyzing and/or assembling synthetic nucleic acid libraries as described herein. For example, certain embodiments of the invention may involve marketing a procedure and/or associated devices or systems involving nucleic acid libraries (e.g., libraries that encode filtered polypeptide sequences). In some embodiments, synthetic nucleic acids, libraries of synthetic nucleic acids, host cells containing synthetic nucleic acids, expressed polypeptides or proteins, etc., also may be marketed.

Marketing may involve providing information and/or samples relating to methods, kits, compositions, devices, and/or systems described herein. Potential customers or partners may be, for example, companies in the pharmaceutical, biotechnology and agricultural industries, as well as academic centers and government research organizations or institutes. Business applications also may involve generating revenue through sales and/or licenses of methods, kits, compositions, devices, and/or systems of the invention. Business applications may involve providing product information (e.g., in the form of printed brochures, electronic product information, instructions in printed and/or electronic form, e.g., computer-readable form).

### EXAMPLES

As will be clear to one of ordinary skill in the art, it should be appreciated that the examples provided below illustrate embodiments of the invention and thus are not intended to be limiting to the scope of the claimed invention.

### Example 1

### Design and Construction of Library for Four-Fragment Peptide Variants

In this example, a target nucleic acid encodes a peptide that contains four variable regions separated by intervening constant or invariable sequences. Accordingly, the full length target sequence is conceptually divided into four corresponding fragments, each of which consists of a variable region, flanked by an invariable intervening sequence. In the instant example, the intervening invariable sequence is a constant residue (‘const.’) flanking each of the variable fragment on both sides. Thus, the objective is to generate a library that represents substantially all combinations of desired variants by combining nucleic acids for each of the four variable fragments.

In the instant example, the four variable fragments are referred to as fragment A, fragment B, fragment C and fragment D, in the amino→carboxyl direction. In the instant example, a constant residue is present (as an invariable sequence) between each of the fragments, such that the overall configuration of the target peptide can be expressed as:

const.-[Fragment A]-const.-[Fragment B]-const.-[Fragment C]-const.-[Fragment D]-const.

Within each of the variable fragments, there is a set of desired variants of interest to be synthesized. For Fragment A, based on the number of positions that were to be varied and the number of desired residues for each of the positions, 2,880 variants of interest were identified were possible. Similarly, desired selections of amino acid residues at various positions within Fragment B, Fragment C and Fragment D were identified to yield 1,000 variants, 192 variants and 24 variants, respectively. Collectively, these possible variants within each of the four fragments would yield:

2,880×1,000×192×24=1.33×10¹⁰

Thus, the total size of the resulting library (e.g., the minimal representation) derived from the above calculations is 1.33×10¹⁰ variants or combinations.

Based on the desired peptide variants outlined above, oligonucleotides corresponding to each of the fragments were designed. Oligonucleotides corresponding to the four peptide fragments, Fragment A, Fragment B, Fragment C and Fragment D, are referred to as Fragment A′, Fragment B′, Fragment C′ and Fragment D′, respectively. All of the oligonucleotides were designed to share the following structural features that facilitate subsequent assembly of target sequences.

Each oligonucleotide was configured to have a middle variable region, flanked on both sides by a Type IIS restriction enzyme recognition site, and a primer binding site for amplification (‘amplification sequence’). Each set of variants based on a variable fragment contained a pair of unique amplification sequences, which allows amplification of the pool of fragment variants out of mixed pools of oligonucleotides. This allows selective amplification of a subset of oligonucleotides (particularly useful, for example, for highly parallel de novo synthesis methods, such as one using a chip-based platform). The oligonucleotides were also designed to include cloning tags for cloning any fragment variants into a Puc19-EcoR1/BamH1-digested linear product.

All oligonucleotides in this experiment were synthesized on a solid substrate, namely, a microchip using Agilent or CombiMatrix technology.

To evaluate the yield of oligonucleotide synthesis and to assess the diversity of each of the pools (e.g., variants of Fragment A′, Fragment B′, Fragment C′, or Fragment D′), variants from each pool were separately amplified using specific amplification sequences and were cloned into a pUC19 vector. Each product was then sequenced to verify its representation in the library.

Results showed that of the total oligonucleotides synthesized for Fragment A′ variants, which is referred to here as “Pool A′”, >70% of the products accounted for variants of desired sequences (e.g., oligonucleotides that correspond to selected variants of the amino acids of Fragment A), while the remaining <30% of oligonucleotides synthesized in Pool A′ contained errors, including substitutions and or deletions (e.g., sequences outside of selected variants). Similarly, Pool B′ contained >70% desired variants in the resulting oligonucleotides. Pool C′ yielded approximately 85% of variants that were selected, while about 15% represented products containing errors. Finally, Pool D′ contained about 70% correct (selected) oligonucleotides in the pool, and about 30% oligonucleotides with errors.

Further analysis was carried out to determine the distribution/diversity of variant species represented in the synthesized oligonucleotides within each pool (e.g., Pool A′, B′, C′, or D′). Approximately 70 inserts were randomly chosen from each pool of synthesized oligonucleotides and were sequenced to characterize the population. Sequencing data indicated that each of the selected or desired sequence variants was represented relatively evenly. For example, at an amino acid position of Fragment A where four different amino acid residues were initially selected as desired variants, between 15 and 20 inserts. (out of ˜70 inserts sequenced) accounted for each of these variants. For the other variable residues of the fragment, qualitatively similar results were obtained. Similarly, for the other fragments, too, each of the selected variant was well represented in the pool of oligonucleotides, indicating that the de novo synthesis of oligonucleotides as described herein provides a valid tool to generate a non-random pool of oligonucleotides.

Using these oligonucleotides as provided above as starting material, the overall strategy for constructing this particular library was as follows. Variants of the first two oligonucleotide fragments (oligonucleotide pools A′ and B′) were to be combined and assembled in a reaction to generate a library representing different combinations of the selected variants for Fragments A and B. Similarly, variants of the next two oligonucleotide fragments (oligonucleotide pools C′ and D′) were to be combined and assembled in a separate reaction to generate a library representing different combinations of the selected variants for Fragments C and D. Subsequently, variant combinations from these two sub-pools were to be further combined and assembled to generate full length target variants representing different combinations of the selected variants from oligonucleotide pools A′, B′, C′, and D′ in a library of assembled fragments configured in the order A′-B′-C′-D′. Finally, the full-length target sequence can be inserted into a vector as described above. Adaptor sequences were designed to introduce a restriction enzyme recognition site for BbsI in the vector to insert an array of the final target sequences (Fragments A′-B′-C′-D′), or the target variants.

Accordingly, oligonucleotides representing Fragment A′ variants and Fragment B′ variants were first digested separately with SapI enzyme. The rationale of using SapI restriction enzyme is that it is a type IIS enzyme which generates a 3′ overhang and is useful for the assembly step of the construction. Next, pools of Fragment A′ oligonucleotide variants and Fragment B′ oligonucleotide variants were combined and ligated together using T4 ligase, yielding intermediate products that consist of Fragment A′ and Fragment B′, conserving Type IIS recognition sites on the ends of the assembled nucleic acids. The reaction can be schematically summarized as follow:

[BbsI·Fragment A′·SapI]+[SapI·Fragment B′·EarI]→[BbsI·Fragment A′·Fragment B′·EarI]

Thus, the intermediate oligonucleotide contains an internal target sequence corresponding to the two oligonucleotide fragments flanked by a BbsI site on its 5′ end, and an EarI site on its 3′ end.

The ligated products were then run on a 3% agarose gel for evaluation. The correct length of the intermediate fragments was verified by electrophoresis on an agarose gel by detecting a fragment of the expected size. The ligated products are PCR amplified using amplification primers that bind to the ends of Fragment A′ and Fragment B′ oligonucleotide variants.

A commercially available kit (Qiagen gel extraction kit) was used to extract DNA from the gel according to the manufacturer's instructions. For the particular kit, the smallest length it can extract is 100 bp. In some cases, the gel extraction step was carried out prior to the PCR amplification step described above. The resulting pool of intermediates (variants of Fragment A′-Fragment B′) was cloned into a pUC19 vector and sequenced to test the diversity of the Fragment A′-Fragment B′ variants.

In a parallel set of experiments, Fragment C′ and Fragment D′ variants were digested separately with SapI, using the same strategy described above, except that Fragment C′ contained an EarI recognition site on its 5′ side, and a BbsI site on its 3′ side. Digestion of Fragment C′ and Fragment D′ variants with SapI, followed by ligation with T4 ligase, yielded a pool of intermediate oligonucleotides consisting of Fragments C′ and D′, flanked by an EarI site and a BbsI site.

[EarI·Fragment C′·SapI]+[SapI·Fragment D′·BbsI]→[EarI·Fragment C′·Fragment D′·BbsI]

The ligated products were analyzed on a 3% agarose gel, which yielded a fragment of the expected length. The ligated products are PCR amplified using amplification oligonucleotides that bind to the ends of Fragment C′ and Fragment D′ variants. A Qiagen gel extraction kit was used to extract DNA. The resultant pool of intermediates was cloned into a pUC19 vector and sequenced to test the diversity of the variants.

To generate full length target nucleic acid variants (A′-B′-C′-D′), the two intermediate segments generated as described above (A′-B′ and C′-D′) were separately digested with the type II restriction enzyme EarI. Subsequently, the segments were assembled by ligation using T4 ligase. The overall reaction is summarized below:

[BbsI·Fragment A′·Fragment B′·EarI]+[EarI·Fragment C′·Fragment D′·BbsI]→[BbsI·Fragment A′·Fragment B′·Fragment C′·Fragment D′·BbsI]

The resulting ligation products were analyzed by gel electrophoresis.

A fragment of an expected length was obtained. The ligated products were PCR amplified using amplification oligonucleotides that bind to the ends of Fragment A′ and Fragment D′, which allowed amplification of a pool of full length target sequences. As described above, a Qiagen gel extraction kit was used to extract DNA. The resulting oligonucleotide variants were cloned into a pUC19 vector and sequenced to test the diversity of the A′-B′-C′-D′ library.

A pUC19 vector was used as a plasmid in the above steps. To make the vector compatible with the various inserts described herein (e.g., inserts resulting from type II restriction enzyme digestions), adapter sequences were designed such that each contained a 15 base segment sharing the vector sequence. With an In-fusion cloning method, using a commercially available kit (Clontech), the adapter sequences were integrated into the plasmid that was cut with BamHI and EcoRI restriction endonucleases.

Subsequently, full length target sequences (Fragment A′-Fragment B′-Fragment C′-Fragment D′) from the library obtained above were inserted into the vector plasmid containing the adapter sequences. To achieve this, full length fragments (A′-B′-C′-D′) were digested with the type II restriction enzyme, BbsI. The modified pUC19 vector plasmid was also cut with BbsI, and the linearized vector product was dephosphorylated to prevent it from self-ligating. The A′-B′-C′-D′ inserts (i.e., variants) were then ligated into the vector. Thus, a library of predetermined variants corresponding to a pool of desired peptides, was generated.

### Example 2

### Reduction of Number of Construction Oligonucleotides Involving Two Adjacent Variable Positions: Comparison of Conventional and Improved Methods

An example of variant library construction involving adjacent variable positions is illustrated in FIG. 3C and FIG. 3D. A 2.5 kb fragment of nucleic acid contains five positions sought to be varied. These are at positions 120, 123, 1497, 1500 and 1611. Two pairs of variable sites are closely positioned with each other (positions 120 and 123; and positions 1497 and 1500), whereas the fifth variable position (position 1611) is sufficiently distant. For each of the five variant positions, there is a possibility of 40 different variants, totaling a library size of 40⁵=1.0×10⁸. According to a conventional method of variant library construction (FIG. 3C), for the variant positions that are next to each other (positions 120 and 123; positions 1497 and 1500), it would be necessary to synthesize 1,600 variant oligonucleotides for each region to generate all the possible combinations of 40 variants at each position. Total number of oligonucleotides needed to synthesize all the variants would be:

1,600+1,600+40=3,240

When a method of the present invention is applied to the same example of library construction (as illustrated in FIG. 3D), the same combination yielding the 1,600 variants can be synthesized with an exponentially reduced total number of oligonucleotides:

2(40+1)+40=122

Such a reduction in the number of oligonucleotides results in a significantly reduced cost.

### Example 3

### Error-Corrected Library Construction

A library of mutant variants for a 759 bp nucleic acid was generated. Target nucleic acid sequences contained up to 12 point mutations at defined amino acid residues. For each of the point mutation sites, two variants were considered (i.e., wild type and mutant). Thus, the total number of variants having a discrete combination of mutations at various residues of the 12 mutation sites can be calculated as follows:

(2)¹²=4,096

In this experiment, each of the target nucleic acids containing various mutations was assembled from a plurality of oligonucleotides. The oligonucleotides were synthesized on a chip-based platform and eluted for assembly. All variants were constructed in a single reaction pool.

Two parallel experiments were carried out to assess the effect of errors contained in the assembly oligonucleotides on the representation in the resulting library.

In the first experiment, errors introduced during oligonucleotide synthesis were not corrected, and the total mixture of oligonucleotides, including correct and error-containing species, was subsequently used to construct variants by oligonucleotide assembly. It should be noted that error rates depend predominantly on the length of the oligonucleotide to be synthesized. The longer the oligonucleotide, the more likely an error is introduced during the chemical synthesis.

In comparison, in the second experiment, errors that occurred during chemical synthesis were corrected by removing oligonucleotides that contained a mismatch (i.e., error), then the remaining pool of oligonucleotides, containing substantially correct sequences, was used to assemble variants. The following procedure was used for the mismatch removal step.

Each assembly oligonucleotide with or without point mutation(s) at the twelve defined loci was chemically synthesized on a microchip. Moreover, a complementary oligonucleotide for each was also simultaneously synthesized. Both strands of oligonucleotides (a target fragment and its complementary sequence) were eluted then were allowed to hybridize. Oligonucleotides containing correct sequence (no errors) hybridized completely to their complementary oligonucleotides. In contrast, oligonucleotides containing an error would create a gap at the site of mismatched base upon hybridization. The pool of double-stranded oligonucleotides were then passed through a column comprised of recombinant MutS, which specifically binds to a mismatch on a double-stranded DNA thereby removing mismatch-containing species from the mixture of double-stranded oligonucleotides. Oligonucleotides with no mismatch would pass through and be eluted. The eluted pool of oligonucleotides was collected and used for further assembly reactions to generate desired variants.

Following assembly, the resulting full-length target sequence of 759 bp, with or without mutations at up to 12 defined loci, were cloned into an appropriate vector. From each of the two libraries generated according to the experimental methods described above, 80-90 clones were randomly selected and were subjected to sequence analysis.

To compare the two libraries, error frequencies were determined. For the error-corrected library, one error (deletion, insertion or substitution) occurred at approximately every 1,080 bp. In contrast, for the library that was not filtered for errors, one error occurred at approximately 250 bp. In terms of the fraction of clones that had correct sequence as opposed to clones containing an error, the data showed that approximately 67% of clones tested from the error-corrected library had a correct sequence, while only about 15% of clones from the unscreened library were correct. Taken together, the comparison of the two libraries demonstrates that the quality of the resulting library (in the context of errors) is improved by a factor of 4-5, depending upon the analytical parameter being used, by correcting errors in the assembly oligonucleotides.

### Example 4

### Library Design for the Selection of Therapeutic Antibody Mimics

Certain embodiments of the invention may be exemplified by the design of a library for selecting therapeutic antibody mimics based on the tenth human fibronection type II domain (10Fn3), using pre-filtering for high solubility and low immunogenicity.

One possible library can be generated by randomizing twelve of the 94 amino-acid residues of 10Fn3, with the variability occurring in seven positions in loop BC (residues 23-29) and in five positions in loop DE (residues 52-56). The library will be made from two overlapping DNA fragments (“sub-libraries”), one encoding residues 1-47, and the other encoding residues 34-94. The library design and assembly may involve one or more of the following steps.

1. An initial list of sequences will be generated for each sub-library by enumerating every possible permutation of the randomized positions. The resulting starting sub-libraries will contain 20⁷=10⁹ sequences (the N-terminal sub-library, “SL-N”) and 20⁵=10⁶ sequences (the C-terminal sub-library, “SL-C”).

2. A filtering step will be applied to each sub-library list that will remove all sequences that contain more than one tryptophan in the randomized region.

3. A filtering step will be applied to each sub-library list that will remove all sequences that contain one or more cysteines.

4. pI values will be calculated for each sequence on each list. All sequences with pI values between 6 and 9 will be removed from both lists.

5. Each sub-library list will be divided into two sublists. One list will contain the 1,000 sequences with the highest pI values (“SL-Nh” and “SL-Ch”); the other list will contain the 1,000 sequences with the lowest pI values (“SL-NI” and “SL-Cl”).

6. The randomized region and the adjacent fixed positions for each of the 4,000 remaining sequences will be represented by a series of 9-mer, overlapping oligopeptides. Each of the peptides will be modeled into the peptide-binding site of all available MHC II structures. Each sequence that gave rise to an MHC-II-binding peptide will be removed from each list.

7. The remaining sequences on each list (SL-Nh, SL-Ch, SL-NI, and SL-Cl) will be back-translated into DNA, optimized for codon usage and secondary-structure formation, and synthesized.

8. The physical DNA clones on each list (SL-Nh, SL-Ch, SL-NI, and SL-Cl) will be combined to generate the four corresponding DNA pools, and will be PCR-amplified to 30 ug of DNA.

9. Pools will be combined pairwise: Pool H will result from combining pools SL-Nh and SL-Ch; pool L will result from combining pools SL-NI and SL-Cl.

10. Pool H will be transformed into yeast strain EBY100 and recombined into a gapped plasmid used for yeast-surface display following standard protocol. Pool L will undergo the same procedure separately.

11. Transformed yeast cultures H and L will be grown separately and will have their complexity determined. Then the two cultures will be combined at same representation of each clone.

12. The resulting yeast library will be subjected to selection for binding to TNF-alpha using yeast-surface display, following standard protocols.

13. The selection is expected to yield a high proportion TNF-alpha-binding 10Fn3-like antibody mimics with high solubility and low immunogenicity.

### Example 5

### Silent Mutation Library

A method for constructing a silent mutation library is described. The term “silent mutation” refers to a mutation in a codon that does not generate a change in the encoded amino acid residue. For example, the amino acid Alanine (Ala or A) can be encoded by four different codons, namely, gca, gcc, gcg or gcu. Likewise, Tyrosine (Tyr or Y) is encoded by either uac or uau. Leucine (Leu or L) can be encoded by six alternate codons: uua, uug, cua, cuc, cug and cuu. In contrast, Methionine (Met or M) and Tryprophan (Trp or W) each has a single codon. Across the 21 naturally occurring amino acids, there are ˜3 codons on average that can encode an amino acid. Accordingly, changes (mutations) at certain positions of a codon do not always translate to a change in a corresponding amino acid. Such a “silent mutation” occurs more often but not always at the third nucleotide of a triplet. For example, Glycine (Gly or G) is encoded by the triplets, gga, ggc, ggg or ggu. Therefore, an “a→c” mutation at the third position of gga, which results in ggc, would still encode Gly.

In this example, a library of silent mutations is contemplated for the reporter protein Green Fluorescent Protein (GFP). GFP consists of 330 amino acids, or 999 nucleotides. A silent mutation library is constructed by first defining all possible 33-mers that begin at three nucleotide intervals across the entire sequence and on both strands such as to conserve the correct reading frame but to introduce a silent mutation. The mutated codon that preserves the amino acid (i.e., a silent mutation) is placed in a triplet codon located in the center of each oligonucleotide. These oligonucleotides containing a silent mutation are synthesized and amplified by PCR to make a library. This method would require about ˜1,000 oligonucleotides in the case of GFP, provided that there are on average three codons for each amino acid. The resulting library can then be used to transfect or transform one or more hosts, such as bacterial (e.g., E. coli), yeast, or plant hosts. The effects of silent mutations are determined by assaying for the reporter gene expression. If desired, screening may be carried out sequentially. For example, a first screening identifies a set of clones that exhibit differential expression due to a mutation. Based on this information, a second round of screening may be carried out in which significant changes identified in the first round can be expanded upon in a subsequent library design, which may focus on all possible combinations of the significant changes. Accordingly, optimal codons for expressing GFP in the particular host are determined.

FIG. 9 further illustrates a non-limiting embodiment of a technique for screening the effect of one or more silent mutations on the functionality of a protein. In FIG. 9, each “X” in the illustration represents a codon (triplet) encoding an amino acid residue, and “XX” represent a contiguous six-base unit (e.g., a dicodon) encoding two adjacent amino acid residues. To assess local effects of silent mutations, variants containing silent mutations at two adjacent sites were synthesized as illustrated, and the overall effect on protein function was assayed by measuring GFP fluorescence. As shown in FIG. 9, dicodon variants at different positions were prepared by preparing a library of different assembly nucleic acids each containing a single dicodon variant, but wherein the library contains dicodon variants at different positions. By assembling the variant assembly nucleic acids into a full length GFP encoding sequence, the effect of the dicodons at different positions could be evaluated, thereby identifying regions that are sensitive (either negatively or positively) to one or more silent mutations. The example shown in FIG. 9 represents a silent dicodon scan of the GFP encoding sequence. By varying the ratio of variant containing assembly nucleic acids to wild-type assembly nucleic acids, the number of variants in each GFP encoding construct in a library can be varied. In some embodiments, the variant containing assembly nucleic acids are included as 10% of the assembly nucleic acids relative to 90% of non-variant assembly nucleic acids. However, it should be appreciated that different ratios of variant to non-variant assembly nucleic acids may be used (e.g., about 10/90; about 20/80; about 30/70; about 40/60; about 50/50; about 60/40; about 70/30; about 80/20; about 90/10; or higher or lower ratios). In this example, a library of GFP encoding variants containing one or a few silent dicodon variants was prepared and levels of functional GFP were assayed by measuring fluorescence intensity in E. coli cells. Cells that expressed higher levels of functional GFP than codon optimized GFP constructs (one codon optimized for E. coli, and one codon optimized for mammalian cells using conventional codon optimization) were selected by FACS cell sorting (using BD FACS Aria). Results showed that after two rounds of cell sorting, silent mutant clones were isolated that showed markedly enhanced (˜5 fold improvement on average) GFP functional levels compared to the reference codon-optimised GFP. By isolating a retransforming the expression constructs used for the library clones that were isolated by FACS sorting it was shown that the increased expression was due to the silent mutations and not due to host mutations or other factors. It should be appreciated that factors and techniques described in the context of this example (including the ratios of different silent mutation variants used for library construction) may be applied generally to any silent mutation library described herein.

### Example 6

### Multiplex Nucleic Acid Assembly

Aspects of the invention may involve one or more nucleic acid assembly reactions to assemble pools of variant nucleic acids with or without additional constant nucleic acids. The variant nucleic acids in each pool preferably have at least one terminal nucleotide (e.g., the 5′ or the 3′ terminal nucleotide) that is identical and that is complementary to a terminal nucleotide of an adjacent nucleic acid or pool of nucleic acids in an assembly reaction. Nucleic acids of the invention may be assembled using any suitable method including a combination of one or more ligation, recombination, or extension reactions. Multiplex nucleic acid assembly reactions may be used to assemble one or more nucleic acid components. Multiplex nucleic acid assembly relates to the assembly of a plurality of nucleic acids to generate a longer nucleic acid product. In one aspect, multiplex oligonucleotide assembly relates to the assembly of a plurality of oligonucleotides to generate a longer nucleic acid molecule. However, it should be appreciated that other nucleic acids (e.g., single or double-stranded nucleic acid degradation products, restriction fragments, amplification products, naturally occurring small nucleic acids, other polynucleotides, etc.) may be assembled or included in a multiplex assembly reaction (e.g., along with one or more oligonucleotides) in order to generate an assembled nucleic acid molecule that is longer than any of the single starting nucleic acids (e.g., oligonucleotides) that were added to the assembly reaction. In certain embodiments, one or more nucleic acid fragments that each were assembled in separate multiplex assembly reactions (e.g., separate multiplex oligonucleotide assembly reactions) may be combined and assembled to form a further nucleic acid that is longer than any of the input nucleic acid fragments. In certain embodiments, one or more nucleic acid fragments that each were assembled in separate multiplex assembly reactions (e.g., separate multiplex oligonucleotide assembly reactions) may be combined with one or more additional nucleic acids (e.g., single or double-stranded nucleic acid degradation products, restriction fragments, amplification products, naturally occurring small nucleic acids, other polynucleotides, etc.) and assembled to form a further nucleic acid that is longer than any of the input nucleic acids.

In aspects of the invention, one or more multiplex assembly reactions may be used to generate target nucleic acids having predetermined sequences. In one aspect, a target nucleic acid may have a sequence of a naturally occurring gene and/or other naturally occurring nucleic acid (e.g., a naturally occurring coding sequence, regulatory sequence, non-coding sequence, chromosomal structural sequence such as a telomere or centromere sequence, etc., any fragment thereof or any combination of two or more thereof). In another aspect, a target nucleic acid may have a sequence that is not naturally-occurring. In one embodiment, a target nucleic acid may be designed to have a sequence that differs from a natural sequence at one or more positions. In other embodiments, a target nucleic acid may be designed to have an entirely novel sequence. However, it should be appreciated that target nucleic acids may include one or more naturally occurring sequences, non-naturally occurring sequences, or combinations thereof.

In one aspect of the invention, multiplex assembly may be used to generate libraries of nucleic acids having different sequences. In some embodiments, a library may contain nucleic acids having random sequences. In certain embodiments, a predetermined target nucleic acid may be designed and assembled to include one or more random sequences at one or more predetermined positions.

In certain embodiments, a target nucleic acid may include a functional sequence (e.g., a protein binding sequence, a regulatory sequence, a sequence encoding a functional protein, etc., or any combination thereof). However, some embodiments of a target nucleic acid may lack a specific functional sequence (e.g., a target nucleic acid may include only non-functional fragments or variants of a protein binding sequence, regulatory sequence, or protein encoding sequence, or any other non-functional naturally-occurring or synthetic sequence, or any non-functional combination thereof). Certain target nucleic acids may include both functional and non-functional sequences. These and other aspects of target nucleic acids and their uses are described in more detail herein.

A target nucleic acid may be assembled in a single multiplex assembly reaction (e.g., a single oligonucleotide assembly reaction). However, a target nucleic acid also may be assembled from a plurality of nucleic acid fragments, each of which may have been generated in a separate multiplex oligonucleotide assembly reaction. It should be appreciated that one or more nucleic acid fragments generated via multiplex oligonucleotide assembly also may be combined with one or more nucleic acid molecules obtained from another source (e.g., a restriction fragment, a nucleic acid amplification product, etc.) to form a target nucleic acid. In some embodiments, a target nucleic acid that is assembled in a first reaction may be used as an input nucleic acid fragment for a subsequent assembly reaction to produce a larger target nucleic acid.

Accordingly, different strategies may be used to produce a target nucleic acid having a predetermined sequence. For example, different starting nucleic acids (e.g., different sets of predetermined nucleic acids) may be assembled to produce the same predetermined target nucleic acid sequence. Also, predetermined nucleic acid fragments may be assembled using one or more different in vitro and/or in vivo techniques. For example, nucleic acids (e.g., overlapping nucleic acid fragments) may be assembled in an in vitro reaction using an enzyme (e.g., a ligase and/or a polymerase) or a chemical reaction (e.g., a chemical ligation) or in vivo (e.g., assembled in a host cell after transfection into the host cell), or a combination thereof. Similarly, each nucleic acid fragment that is used to make a target nucleic acid may be assembled from different sets of oligonucleotides. Also, a nucleic acid fragment may be assembled using an in vitro or an in vivo technique (e.g., an in vitro or in vivo polymerase, recombinase, and/or ligase based assembly process). In addition, different in vitro assembly reactions may be used to produce a nucleic acid fragment. For example, an in vitro oligonucleotide assembly reaction may involve one or more polymerases, ligases, other suitable enzymes, chemical reactions, or any combination thereof.

### EQUIVALENTS

The present invention provides among other things methods for assembling large polynucleotide constructs and organisms having increased genomic stability. While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

### INCORPORATION BY REFERENCE

All publications, patents and sequence database entries mentioned herein, including those items listed below, are hereby incorporated by reference in their entirety as if each individual publication or patent was specifically and individually indicated to be incorporated by reference. In case of conflict, the present application, including any definitions herein, will control.

1. A library of predetermined nucleic acid variants, said library comprising:
at least 100 different nucleic acid variants, wherein said nucleic acid variants represent at least 50% of a plurality of non-random sequence variants.

2. The library of claim 1, comprising at least 1,000 different non-random nucleic acid variants.

3-9. (canceled)

10. The library of claim 1, wherein said nucleic acid variants represent at least 75% of a plurality of predetermined non-random sequence variants.

11-14. (canceled)

15. A library of predetermined nucleic acid variants, said library comprising:
at least 100 different nucleic acid variants, wherein at least 50% of said nucleic acid variants represent members of a predetermined plurality of non-random sequence variants.

16. The library of claim 15, comprising at least 10⁶ different non-random nucleic acid variants.

17-23. (canceled)

24. The library of claim 15, wherein at least 75% of said nucleic acid variants represent members of a predetermined plurality of non-random sequence variants.

25-28. (canceled)

29. A library of predetermined nucleic acid variants, said library comprising:
at least 100 different nucleic acid variants, wherein at least 50% of said nucleic acid variants represent members of a predetermined plurality of non-random sequence variants, and wherein said nucleic acid variants represent at least 50% of the plurality of predetermined non-random sequence variants.

30. The library of claim 29, comprising at least 1,000 different nucleic acid variants.

31-37. (canceled)

38. The library of claim 29, wherein at least 75% of said nucleic acid variants represent members of a predetermined plurality of non-random sequence variants, and wherein said nucleic acid variants represent at least 75% of the plurality of predetermined non-random sequence variants.

39-42. (canceled)

43. The library of claim 1, wherein said nucleic acid variants are silent mutation variants that encode the same polypeptide sequence.

44. The library of claim 1, wherein said library is an expression library.

45. A method of preparing a nucleic acid library comprising a plurality of predetermined silent nucleic acid variants, the method comprising:
obtaining a first pool of nucleic acids having predetermined silent variant sequences of a first nucleic acid region,
obtaining a second pool of nucleic acids having predetermined silent variant sequences of a second nucleic acid region,
assembling a library of silent variant nucleic acids by mixing the first pool of nucleic acids with the second pool of nucleic acids under condition to form a plurality of different variant nucleic acids each comprising a variant sequence of the first nucleic acid region and a variant sequence of the second nucleic acid region.

46. A method of designing a strategy for assembling a nucleic acid library comprising a plurality of predetermined silent variant nucleic acids, the method comprising:
identifying in a target nucleic acid a first silent variant region comprising a first plurality of different target sequences;
identifying in the target nucleic acid a first constant region comprising a first invariant sequence;
designing an assembly strategy comprising obtaining a first plurality of silent variant nucleic acids each having a sequence corresponding to each of the first plurality of different target sequences, wherein the first plurality of variant nucleic acids are designed to be assembled with a constant nucleic acid having the first invariant sequence.

47. The method of claim 46, further comprising identifying a second silent variant region comprising a second plurality of different target sequences, wherein the second variant region is separated from the first variant region by the constant region, wherein the assembly strategy further comprises obtaining a second plurality of variant nucleic acids each having a sequence corresponding to each of the second plurality of different target sequences, and wherein the second plurality of silent variant nucleic acids are intended to be assembled with the first plurality of variant nucleic acids and the constant nucleic acid having the first invariant sequence.

48-73. (canceled)
